(19) United States
(12) Patent Application Publication
(10) Pub. No.: US 2026/0180387 A1
(43) Pub. Date: Jun. 25, 2026

(54) STATOR STRUCTURE, STATOR, STATOR MOUNTING APPARATUS, AND RELEASABLE ATTACHMENT OF COVER TO STATOR FOR DISPLACEMENT SYSTEM

(71) Applicant: PLANAR MOTOR INCORPORATED, Vancouver (CA)

(72) Inventors: Graham WILLIAMSON, Vancouver (CA); Sander KEIL, Vancouver (CA)

(21) Appl. No.: 19/539,825

(22) Filed: Feb. 13, 2026

Related U.S. Application Data
(63) Continuation-in-part of application No. PCT/CA2024/051062, filed on Aug. 14, 2024.
(63) Continuation-in-part of application No. PCT/CA2025/050192, filed on Feb. 13, 2025.
(60) Provisional application No. 63/532,624, filed on Aug. 14, 2023.
(60) Provisional application No. 63/555,821, filed on Feb. 20, 2024.
(60) Provisional application No. 63/564,947, filed on Mar. 13, 2024.
(60) Provisional application No. 63/564,947, filed on Mar. 13, 2024.

(51) Int. Cl. H02K 3/12; H02K 1/16; H02K 1/18; H02K 1/20

(52) U.S. Cl. CPC H02K 3/12; H02K 1/165; H02K 1/185; H02K 1/20

(57) ABSTRACT

Aspects of the present disclosure provide a stator mounting apparatus for a magnetic displacement system. The stator mounting apparatus may include a main support defining a primary opening dimensioned to receive stators therethrough. Adjacent the primary opening, the main support may include a support portion for supporting stators. A stator may be received through the primary opening from an external side of the main support and may be moved, in a mounting direction, to a mounting position on the support portion. The external side of the main support may face away from a working surface of the displacement system where movers are controllable. The mounting direction may be parallel to the working surface. From the mounting position, the stator may be moved, in a dismounting direction opposite to the mounting direction, to the primary opening for removal through the primary opening to the external side of the main support.

### CROSS-REFERENCE TO RELATED APPLICATIONS

This application claims the benefit of and priority from U.S. provisional patent application No. 63/532,624, filed Aug. 14, 2023, the entire contents of which are incorporated by reference herein. This application also claims the benefit of and priority from U.S. provisional patent application No. 63/555,821, filed Feb. 20, 2024, the entire contents of which are incorporated by reference herein. This application also claims the benefit of and priority from U.S. provisional patent application No. 63/564,947, filed Mar. 13, 2024, the entire contents of which are also incorporated by reference herein. This application is also a continuation-in-part of International patent application no. PCT/CA2024/051062, filed Aug. 14, 2024, the entire contents of which are also incorporated by reference herein. This application is also a continuation-in-part of International patent application no. PCT/CA2025/050192, filed Feb. 13, 2025, the entire contents of which are also incorporated by reference herein.

### FIELD

This disclosure relates generally to displacement systems, stators for such systems, and isolation of such stators from external environments.

### BACKGROUND

Displacement systems, or conveyors, such as XY tables and rotary tables may be used in various manufacturing, inspection, and assembling processes. XY motion may be achieved by stacking two linear stages (e.g., a X-stage and a Y-stage) together via connecting bearings. Alternatively, a single moving stage capable of XY motion may be used, eliminating additional bearings. It may also be desirable for such a moving stage to be able to provide at least some Z motion.

Attempts have been made to design displacement systems using the interaction between current-carrying coils and permanent magnets. Such displacement systems may also be referred to as magnetic displacement systems. Such systems generally include a stator and a mover. The mover, also referred to as a robotic device, mover device, or moveable stage, includes one or more permanent magnets and holds a component to be moved. The stator includes one or more current-carrying coils, and employs these coils to control and actuate the mover.

Examples of magnetic displacement systems include: U.S. Pat. Nos. 6,003,230; 6,097,114; 6,208,045; 6,441,514; 6,847,134; 6,987,335; 7,436,135; 7,948,122; US patent publication No. 2008/0203828; W. J. Kim and D. L. Trumper, High-precision magnetic levitation stage for photolithography. Precision Eng. 22 2 (1998), pp. 66-77; D. L. Trumper, et al, “Magnet arrays for synchronous machines”, IEEE Industry Applications Society Annual Meeting, vol. 1, pp. 9-18, 1993; and J. W. Jansen, C. M. M. van Lierop, E. A. Lomonova, A. J. A. Vandenput, “Magnetically Levitated Planar Actuator with Moving Magnets”, IEEE Tran. Ind. App., Vol 44, No 4, 2008.

More recent techniques for implementing displacement systems having a mover and a stator are described in: PCT application No. PCT/CA2012/050751 (published under WO/2013/059934) entitled DISPLACEMENT DEVICES AND METHODS FOR FABRICATION, USE AND CONTROL OF SAME; PCT application No. PCT/CA2014/050739 (published under WO/2015/017933) entitled DISPLACEMENT DEVICES AND METHODS AND APPARATUS FOR DETECTING AND ESTIMATING MOTION ASSOCIATED WITH SAME; PCT application No. PCT/CA2015/050549 (published under WO/2015/188281) entitled DISPLACEMENT DEVICES, MOVEABLE STAGES FOR DISPLACEMENT DEVICES AND METHODS FOR FABRICATION, USE AND CONTROL OF SAME; PCT application No. PCT/CA2015/050523 (published under WO/2015/184553) entitled METHODS AND SYSTEMS FOR CONTROLLABLY MOVING MULTIPLE MOVEABLE STAGES IN A DISPLACEMENT DEVICE; and PCT application No. PCT/CA2015/050157 (published under WO/2015/179962) entitled DISPLACEMENT DEVICES AND METHODS FOR FABRICATION, USE AND CONTROL OF SAME.

However, existing displacement systems may lack certain functionality and performance. For example, stators of existing systems may not be adequately protected from adverse environmental conditions. Also, in some displacement systems, it may be necessary during operation to maintain separate environments for the stator wiring and for the working movers, but stators of existing systems may not be serviceable while maintaining such separate environments. Additionally, existing displacement systems may need to operate with closely spaced stator modules to create uniform sensor and coil patterns, as movers of existing systems may not be able to easily cross a large gap between modules. In such systems, access to a stator work surface from below may be limited. As further example, in some applications, the stator or stators may be isolated from an environment above them by an impermeable barrier. In such configurations, removal of the stators from above may be disadvantageous, as it may, for example, risk disrupting the impermeable barrier. One solution may be to allow the stators to be installed from below by placing ribs between adjacent stators. However, this approach requires that adjacent stators operate with gaps between them to accommodate the ribs, and the performance of the magnetic displacement system may be compromised if these gaps are large.

### SUMMARY

Embodiments of the present disclosure may provide methods and kits for releasably attaching a cover to a stator, and stator devices resulting from such attachment. Embodiments of the present disclosure may also provide stator structures which allow serviceability of a stator while maintaining separation between a mover working environment and a stator wiring environment, and stators incorporating such stator structures. Embodiments of the present disclosure may also provide apparatuses and systems for mounting stators in a magnetic displacement system such that the stators are isolated from external environments, and methods and kits incorporating such apparatuses and systems.

According to at least one embodiment, there is disclosed a stator structure for a displacement system, the stator structure comprising: at least one conductor positioned to generate at least one external magnetic field operable to move at least one mover in a working environment of the displacement system; and a support structure supporting the at least one conductor and defining a stator environment separated from the working environment, the stator environment for receiving at least one stator electronics sub-assembly operable to drive at least one electrical current in the at least one conductor to cause the at least one conductor to generate the at least one external magnetic field, the support structure configured to maintain separation between the stator environment and the working environment when one or more of the at least one stator electronics sub-assembly is inserted into or removed from the stator environment.

According to at least another embodiment, there is disclosed a method of releasably attaching a cover to a stator of a displacement system, the stator comprising at least one conductor positioned to generate at least one external magnetic field operable to move at least one mover of the displacement system, the method comprising: causing a bonding layer to adhere to the stator; and causing the bonding layer to adhere to the cover.

According to at least another embodiment, there is disclosed a method of detaching a cover from a stator of a displacement system, the stator comprising at least one conductor positioned to generate at least one external magnetic field operable to move at least one mover of the displacement system, the cover attached to the stator by a bonding layer adhered to the stator and to the cover, the method comprising: drawing a releasing body through the bonding layer.

According to at least another embodiment, there is disclosed a stator device for a displacement system, the stator device comprising: a stator comprising at least one conductor positioned to generate at least one external magnetic field operable to move at least one mover of the displacement system; a cover; and a bonding layer between the stator and the cover, the bonding layer adhered to the stator and to the cover.

According to at least another embodiment, there is disclosed a kit comprising: a stator comprising at least one conductor positioned to generate at least one external magnetic field operable to move at least one mover of a displacement system; a cover; and a bonding layer adherable to the stator and to the cover when the bonding layer is between the stator and the cover.

According to at least another embodiment, there is disclosed a stator mounting apparatus for a magnetic displacement system, the stator mounting apparatus comprising: a main support defining a primary opening dimensioned to receive one or more stators therethrough, the main support comprising a support portion adjacent the primary opening, the support portion for supporting at least one of the one or more stators received through the primary opening, wherein: the at least one of the one or more stators is received through the primary opening from an external side of the main support and can be moved, in a mounting direction, to a mounting position on the support portion in which the at least one of the one or more stators is supported by the support portion, the external side of the main support facing away from a working surface of the displacement system upon which one or more movers of the displacement system are controllable, the mounting direction being parallel to the working surface; and from the mounting position, the at least one of the one or more stators can be moved, in a dismounting direction opposite to the mounting direction, to the primary opening for removal through the primary opening to the external side of the main support.

According to at least another embodiment, there is disclosed a stator kit for a magnetic displacement system, the stator kit comprising: the stator mounting system as described above; and one or more of said stators operable to generate magnetic fields operable to move the one or more movers of the displacement system.

According to at least another embodiment, there is a method of installing a stator on a stator mounting apparatus of a magnetic displacement system, the method comprising: inserting the stator through a primary opening in a main support of the stator mounting apparatus, the primary opening being accessed from an external side of the main support facing away from a working surface of the displacement system upon which one or more movers of the displacement system are controllable; moving the stator, in a mounting direction, from the primary opening to a mounting position on a support portion of the main support, the mounting direction being parallel to the working surface; and supporting the stator by the support portion.

According to at least another embodiment, there is disclosed a method of removing a stator from a stator mounting apparatus of a magnetic displacement system, the method comprising: accessing the stator from an external side of a main support of the stator mounting apparatus to move the stator in a dismounting direction from a mounting position on the main support to a primary opening in the main support, the external side of the main support facing away from a working surface of the displacement system upon which one or more movers of the displacement system are controllable, the dismounting direction being parallel to the working surface; and passing the stator through the primary opening to the external side of the main support.

Other aspects and features will become apparent to those ordinarily skilled in the art upon review of the following description of illustrative embodiments in conjunction with the accompanying figures.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a front section view of a displacement system according to one embodiment.

FIG. 2 is a partial front section view of a stator device of the displacement system of FIG. 1.

FIG. 3 is a partial front section view of an alternate stator device usable with the displacement system of FIG. 1.

FIG. 4 is another partial front section view of the stator device of the displacement system of FIG. 1.

FIG. 5 is a front section view of a displacement system according to another embodiment.

FIG. 6 is a front section view of the displacement system of FIG. 5 with multiple stators and an isolation barrier.

FIG. 7 is a front section view of the displacement system of FIG. 5 with a motor support structure cutout.

FIG. 8 is a plan view of the displacement system of FIG. 5 with multiple stators in a planar arrangement and having a single common stator support structure.

FIG. 9 is a plan view of the displacement system of FIG. 5 with two stators having grid sensor arrangements.

FIG. 10 is a front section view of the displacement system of FIG. 5 with a stator electronics sub-assembly having no overhang mounting structures.

FIG. 11 is a front section view of the displacement system of FIG. 10 with multiple stators and a temporary stiffener.

FIG. 12 is a front section view of the displacement system of FIG. 5 with an integrated stator electronics cooling channel.

FIG. 13 is a front section view of the displacement system of FIG. 5 with an integrated motor support structure cooling channel.

FIG. 14 is another front section view of the displacement system of FIG. 5 with an alternative integrated motor support structure cooling channel.

FIG. 15 is a bottom view of the displacement system of FIG. 5 with multiple stators in a planar arrangement and having localized overhang mounting features 209 arranged in an alternating pattern.

FIG. 16 is another bottom view of the displacement system of FIG. 5 with multiple stators in a planar arrangement and having localized overhang mounting features 209 arranged in an asymmetric pattern.

FIG. 17 is a front sectional view of a displacement system according to one embodiment.

FIG. 18 is a partly cut-away perspective view of a displacement system according to another embodiment.

FIG. 19 is a partly exploded and partly cut-away perspective view of the displacement system of FIG. 18.

FIG. 20 is a bottom view of the displacement system of FIG. 18, with a stator of the displacement system positioned in a primary opening of a main support of the displacement system.

FIG. 21 is another bottom view of the displacement system of FIG. 18, with two stators of the displacement system positioned in a stator chamber of the displacement system.

FIG. 22 is another bottom view of the displacement system of FIG. 18, with a stator support of the displacement system attached to the main support.

FIG. 23 is a sectional view of the displacement system of FIG. 18 taken along the line labelled FIG. 23 in FIGS. 18 and 22.

FIG. 24 is a partly cut-away perspective view of a displacement system according to another embodiment.

FIG. 25 is a partly exploded and partly cut-away perspective view of the displacement system of FIG. 24.

FIG. 26 is a sectional view of the partly exploded and partly cut-away perspective view of FIG. 25, taken along the line labelled FIG. 26 in FIG. 25.

FIG. 27 is another partly exploded and perspective view of the displacement system of FIG. 24

FIG. 28 is a bottom view of the displacement system of FIG. 24, with stators of the displacement system positioned in primary openings of a unitary main support of the displacement system.

FIG. 29 is another bottom view of the displacement system of FIG. 24, with four stators of the displacement system positioned in a stator chamber of the displacement system.

FIG. 30 is another bottom view of the displacement system of FIG. 24, with stator supports of the displacement system attached to the unitary main support.

FIG. 31 is a sectional view of the displacement system of FIG. 24 taken along the line labelled FIG. 31 in FIGS. 24 and 30.

FIG. 32 is a sectional view of a displacement system according to another embodiment.

### DETAILED DESCRIPTION

Manufacturing, assembly, and inspection systems may use displacement systems, or conveyors, to transport components to be processed, combined, and packaged. Electromagnetic planar motors may be used as magnetic displacement systems in such applications. An electromagnetic planar motor generally includes one or more movers for holding components and one or more stators for supporting and driving/actuating the movers. Stator devices which maintain separation between a mover working environment and a stator wiring environment are described herein, along with methods of assembling such stators. Also described herein are stator mounting apparatuses and stator mounting systems for supporting stators of a magnetic displacement system during operation while maintaining separation between the stators and a mover working environment of the magnetic displacement system.

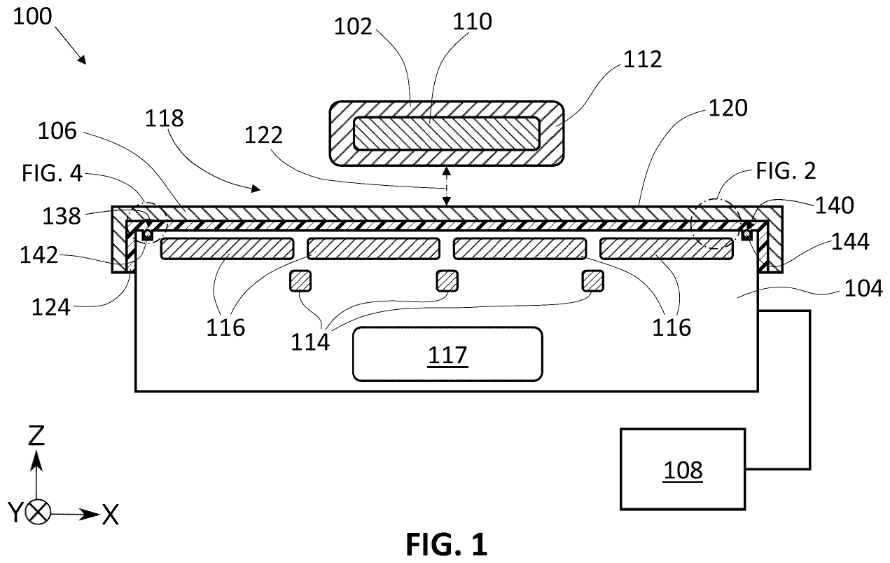

Referring to FIG. 1, a displacement system according to one embodiment is shown generally at 100 and includes a mover 102, a stator 104, a stator cover 106, and a controller 108. The mover 102 may be configured to carry one or more components (not shown). The mover 102 may also be referred to as a “mover device”, a “robotic device”, a “moveable stage”, a “motion stage”, or a “moveable motion stage”. Further, as used herein, the term “component” is a general term and non-limiting examples of components that may be carried by the mover 102 may include workpieces, products being assembled, raw parts, materials, samples, biological samples, drugs, containers, payloads, devices, and assemblies. In the embodiment shown, the displacement system 100 includes only one mover 102. However, alternative embodiments may include multiple movers, and in some alternative embodiments, a plurality of movers may carry a holder which may hold one or more components. In some systems, all movers are substantially similar or nearly identical. However, other systems may include movers of varying sizes and configurations.

The stator 104 supports and actuates the mover 102, such that the mover 102 travels across the stator 104 to another location in displacement system 100. In the embodiment shown, the displacement system 100 includes only one stator 104. However, alternative embodiments may include multiple stators, and in some alternative embodiments, the multiple stators may be of different types—for example, in some alternative embodiments, some stators may have large work areas, while other stators may function as flyways between the work areas for rapid movement of movers and components in narrow spaces. This may be achieved by arranging a stator made from multiple electromagnetic driving regions, arranged in a single row in the direction of movement of the mover.

The controller 108 controls the stator 104 and the mover 102. The controller 108 may be directly connected to the stator 104 using a wired or wireless connection, and may control the mover 102 indirectly through the stator 104. Alternatively, the controller 108 may also be connected to the mover 102 using a wired or wireless connection, such that the controller 108 may communicate with the mover 102 directly. For example, a high speed data cable may be used, such as an ethernet cable, a HDMI cable, or any cable of sufficient data rate bandwidth. In some embodiments, the controller 108 may be completely integrated with the stator 104. In embodiments where the controller 108 is completely integrated within the stator 104, any method of electrical connection may be used, such as ribbon cables, edge board connectors, wire connectors, headers and pins, etc. A wireless connection may include Bluetooth®, WiFi, Zigbee®, Cellular, NFC, etc. In some embodiments, more than one controller may be used within the displacement system 100. For example, the controller 108 may only control the stator 104 or a group of stators including the stator 104, while another controller may control another stator or group of stators.

Generally, the mover 102 and the stator 104 may interact with each other via one or more magnetic fields, so that the stator 104 can provide forces and torques to the mover 102 to controllably move the mover 102. The controller 108 may determine and provide commands to the stator 104 to generate specific forces and torques to move the mover 102.

A pair of coordinate systems may be defined to help explain the movement of the mover 102 relative to the stator 104. In particular, a stator coordinate system may be defined, which is fixed to the stator 104. A mover coordinate system may also be defined, which is fixed to the mover 102 and moves with the mover 102 relative to the stator 104 and the stator coordinate system. Conventional Cartesian coordinates (x, y, z) may be used to describe these coordinate systems, although it will be appreciated that other coordinate systems could be used. For convenience and brevity, in the present description and the associated drawings, the directions (e.g., x, y, z directions) in the stator coordinate system and the directions in the mover coordinate system may be shown and described as being coincident with one another—i.e., the stator-x (or Xs), stator-y (or Ys), and stator-z (or Zs) directions may be shown as coincident with mover-x (or Xm), mover-y (Ym), and mover-z (or Zm) directions, respectively. Accordingly, reference to directions x, y, and/or z may refer to directions in both or either of the stator and mover coordinate systems. However, it will be appreciated from the context herein that in some embodiments and/or circumstances, the mover 102 may move relative to the stator 104 such that these stator and mover coordinate systems are no longer coincident with one another. In such cases, the following convention may be adopted: the terms stator-x, stator-y and stator-z may be used to refer to directions and/or coordinates in the stator coordinate system and the terms mover-x, mover-y and mover-z may be used to refer to directions and/or coordinates in the mover coordinate system. The symbols Xm, Ym, and Zm may be used to refer respectively to the mover-x, mover-y and mover-z directions, the symbols Xs, Ys, and Zs may be used to refer respectively to the stator-x, stator-y and stator-z directions and the symbols X, Y, and Z may be used to refer respectively to either or both of the mover-x, mover-y, and mover-z and/or stator-x, stator-y, and stator-z directions. In some embodiments, during normal operation, the mover-z and stator-z directions are approximately in the same direction (e.g. within +30° in some embodiments; within +10° in some embodiments; and within +2° in some embodiments).

The mover 102 includes a structural frame 112 and one or more actuation magnets 110 fixed to the structural frame 112. The structural frame 112 may be used to provide support to the magnets, facilitate bonding, and/or provide an interface for a part, fixture, or tooling. In some embodiments, the structural frame 112 may optionally be used to mount additional mounting or locating features (not shown). The one or more actuation magnets 110 may also be referred to as an “actuation magnet assembly” or, more generally, a “magnet assembly”. The one or more actuation magnets 110 may be, for example, permanent magnets. In some embodiments, the one or more actuation magnet 110 may include a plurality of magnetization regions, each magnetization region having a respective magnetization direction. In FIG. 1, the mover 102 is shown as including a single actuation magnet 110. However, in some embodiments, the mover 102 may include more than one actuation magnet 110, that is, the mover 102 may include a plurality of actuation magnets 110. In such embodiments, one, some, or all of the plurality of actuation magnets 110 may be fixed to the structural frame 112. The one or more actuation magnets 110 are configured to respond to one or more external magnetic fields, and in particular are configured to generate forces for moving the mover 102 in response to one or more external magnetic fields. Examples of such actuation magnets are described and illustrated in United States patent no. U.S. Pat. No. 10,222,237 (incorporated herein by reference) as arrays of permanent magnets 112A, 112B, 112C, 112D (or collectively, magnet arrays 112).

Still referring to FIG. 1, the stator 104 includes sensors 114, electrical conductors 116, and an amplifier 117. Each of the sensors 114 is configured to measure at least one magnetic field. Each of the sensors 114 may only accurately measure a magnetic field within a certain range of that sensor 202. Examples of such sensors are described and illustrated in United States patent no. U.S. Pat. No. 10,222,237 as magnetic field sensors 501. The sensors 114 may include, for example, Hall-effect magnetic field sensors, magneto-resistive sensors, and/or other suitable types of magnetic field sensors that can measure magnetic flux density. In FIG. 1, the stator 104 is shown as including three sensors 114; however, it will be appreciated that in some embodiments, the stator 104 may include only one sensor 114, or two sensors 114, or more than three sensors 114. These sensors 114 may also be arranged at positions extending along the Y direction in addition to different X positions that are shown in FIG. 1.

Each of the electrical conductors 116 is configured to generate at least one external magnetic field. The electrical conductors 116 may be, for example, coils. Examples of such coils are described and illustrated in United States patent no. U.S. Pat. No. 10,222,237 as coil traces 126. In FIG. 1, the stator 104 is shown as including four electrical conductors 116; however, it will be appreciated that in some embodiments, the stator 104 may include only one electrical conductor 116, two electrical conductors 116, three electrical conductors 116, or more than four electrical conductors 116. In some embodiments, the stator 104 may include a plurality of electrical conductors distributed in one or more planar layers. In some embodiments, the layout of the electrical conductors 116 may include a first group of coils that are linearly oriented and/or elongated in a first direction (e.g., the X-direction as shown in FIG. 1). The first group of coils may also include a second coil pitch or spacing in a second direction (e.g., the Y-direction as shown in FIG. 1). The electrical conductors 116 may also include a second group of coils that are linearly elongated in the second direction. The second group of coils may also include a first coil pitch or spacing in the first direction. The first and second coil pitch/spacing may be equal. In some embodiments, the electrical conductors 116 may be linearly elongated in different directions (e.g., linearly elongated in the X-direction or linearly elongated in the Y-direction) and may vertically overlap with other electrical conductors.

The sensors 114 and electrical conductors 116 may be arranged in a pattern on the stator 104, for example as described and illustrated in United States patent no. U.S. Pat. No. 10,222,237. Patterns may include one or more sensors 114 configured around each of the electrical conductors 116, such as one of the sensors 114 at each edge of one of the electrical conductors 116. Other patterns may also be possible. It will be appreciated that the sensors 114 may be arranged in patterns near or around the electrical conductors 116 to provide proper feedback to the controller 108 for position sensing and control of the mover 102, for example. In some embodiments, the stator 104 may further include a plurality of iron teeth (not shown).

The amplifier 117 is connected to the electrical conductors 116. The amplifier may drive one or more electrical currents in the electrical conductors 116, generating one or more external magnetic fields. The controller 108 may be connected to deliver control signals to the amplifier. The control signals may be used to control current driven by the amplifier into the electrical conductors 116. In the embodiment shown in FIG. 1, the stator 104 includes one amplifier 117. However, in alternative embodiments, a stator may include more than one amplifier.

The current controllably driven into each of the electrical conductors 116 may cause that electrical conductors 116 to create or generate at least one external magnetic field. The at least one external magnetic field thus generated causes corresponding magnetic forces to act on the mover 102. The one or more external magnetic fields may act on the actuation magnet 110, thereby moving the mover 102 relative to the stator 104. The mover 102 may be controllable in at least two degrees-of-freedom (2-DOF) motions, including but not limited to three in-plane degrees-of-freedom (3-DOF) controllable motions and six degrees-of-freedom (6-DOF) controllable motions. In general, embodiments such as those described herein may involve one or more movers that are controllably movable relative to a stator in at least 2 in-plane DOF motions, in 3 in-plane DOF motions, in 4 in-plane DOF motions, in 5 in-plane DOF motions, or in 6-DOF controllable motions, for example.

The stator cover 106 overlays and may be attached to the stator 104, functioning as a barrier between the stator 104 and an operating environment of the mover 102, shown generally at 118. The operating environment 118 is generally a space in which the mover moves during operation—that is, when being controlled by the stator 104, e.g., when carrying a component. In some embodiments, the stator cover 106 may protect the stator 104 from adverse conditions in the operating environment 118, such as humidity, liquids, and/or corrosive environments. In some embodiments, the stator cover 106 may protect the operating environment 118 from contamination. The stator cover 106 is made up of a rigid, non-magnetic material such as but not limited to an austenitic stainless steel, aluminum, or an aluminum alloy. In some embodiments, the stator cover may be at least 0.2 mm thick. In some embodiments, the stator cover may be at most 2 mm thick. In some embodiments, the stator cover may be about 0.5 mm thick.

The stator cover 106 includes a working surface 120 for the mover 102 to move upon. Generally, the working surface 120 describes a continuous area of the stator cover 106 upon which the mover 102 may be controlled by the stator 104. That is, when the stator cover 106 overlays and/or is attached to the stator 104, the working surface 120 is between the stator 104 and the operating environment 118, and is thus between the stator 104 and the mover 102 when the mover 102 is being controlled by the stator 104 (i.e., when the mover 102 is moving in response to external magnetic fields generated by the stator 104). Suitable feedback control algorithms executed by the controller 108 and suitable position feedback from the sensors 114 allow the controller 108 and the stator 104 to move and control the mover 102 along the working surface 120. The working surface 120 may be flat, curved, cylindrical, spherical or some other shape that allows the mover 102 to move along the working surface 120. In some embodiments, a combined working surface may be defined by a plurality of stators each having a respective stator cover, such that each working surface of each stator cover may be combined into a larger combined working surface. In other embodiments, a single stator cover may overlay a plurality of stators, forming a single continuous working surface. While the working surface 120 is depicted horizontally in FIG. 1, it should be understood that the working surface 120 may be mounted vertically or at an angle to gravity.

The mover 102 may move along the working surface 120 in a “contact mode” or a “non-contact mode”. The contact mode (also known as “sitting mode”) may involve contact media such as sliding and/or rolling bearings between the mover 102 and the working surface 120. The non-contact mode (also known as “levitation mode”) may require maintaining a controllable gap 122 between the mover 102 and the working surface 120 of the stator cover 106 in a normal direction Z. The gap 122 may be an air gap. The mover 102 may also rest upon the working surface 120 without moving, which may be in a contact mode or a non-contact mode. In the non-contact mode, the mover 102 may have 6-DOF controllable motion (known as “active levitation mode”). Alternatively, the mover 102 may maintain the gap 122 by passive levitation means (known as “passive levitation mode”). In the passive levitation mode, the mover 102 may rest above the working surface 120 in the non-contact mode.

In some embodiments, the magnetic forces associated with the interactions between the magnetic fields created by the currents in the electrical conductors 116 and the magnetic fields associated with the actuation magnet 110 may attract the mover 102 toward the stator 104, and thus the working surface 120, at all times when the controller 108 is controlling the currents driven by the amplifier 117. In other embodiments, the magnetic forces associated with the interactions between the magnetic fields created by the currents in the electrical conductors 116 and the magnetic fields associated with the actuation magnet 110 may force the mover 102 away from the stator 104, and thus the working surface 120, in order to balance gravitational forces with the gap 122 at all times.

In some embodiments, the gap 122 between the mover 102 and the working surface 120 of the stator cover 106 may be maintained by air bearings or compressed-fluid bearings. It will be appreciated that in some embodiments, the gap 122 may be zero, such as when the mover 102 operates in contact mode.

As described above, the mover 102 may work in “levitation mode”, being levitated near the working surface 120 of the stator cover 106 without contacting the stator cover 106. In levitation mode, the mover 102 may move along the working surface 120 in X and Y directions, where X and Y are two non-parallel (e.g., orthogonal) directions inside the working surface 120. It will be appreciated that the gap 122 between the working surface 120 and a bottom surface of the mover 102 is generally much smaller than the mover's lateral dimensions (i.e., dimensions in the X and Y directions).

Although the mover 102 may be capable of 6-DOF controllable motion, such functionality may not be necessary in all situations. In certain embodiments, levitation of the mover 102 may not be needed and heavy load carrying capability of the mover 102 may be desirable. In such embodiments, the mover 102 may sit on the working surface 120 supported with mechanical bearings (for example, planar sliding bearings and/or ball transfer units), and may be capable of in-plane 3-DOF controllable motion: translation in X and Y and rotation around Z, where X and Y are two non-parallel (e.g., orthogonal) directions in working surface 120 and Z is a direction normal to the working surface 120. When the mover 102 relies on sliding and/or rolling bearings for support on the working surface 120 and the mover 102 is capable of 3-DOF controllable motion, it may be referred to as working in “3-DOF controlled sitting mode”.

In some embodiments, the mover 102 may be capable of in-plane 3-DOF controllable motions (translations in X and Y and rotation around Z) working in levitation mode without contact with working surface 120. In this mode, the translation in Z, rotation around X, and rotation around Y (and thus the associated degrees-of-freedom) of the mover 102 may be open-loop controlled without feedback, using suitable passive levitation technology. When the mover 102 is capable of 3-DOF controllable motion without contact with the stator 104, it may be referred to as working in “3-DOF controlled levitation mode”.

During operation of the displacement system 100, temperatures in the displacement system 100 may change over time due to, for example, changes in the operating environment 118 and/or heat generated in the stator 104 by current being driven through the conductors 116. Such temperature changes may cause buckling of the stator cover 106 and separation of the stator cover 106 from the stator 104 if the stator 104 and the stator cover 106 have different coefficients of thermal expansion (i.e., due to thermally-induced stresses). To prevent such thermally-induced buckling and separation, in some embodiments the stator cover 106 may be attached to the stator 104 throughout an interface between the stator 104 and the stator cover 106. In such embodiments, it may also be desirable to subsequently remove or detach the stator cover 106 from the stator 104 without damaging either the stator 104 or the stator cover 106.

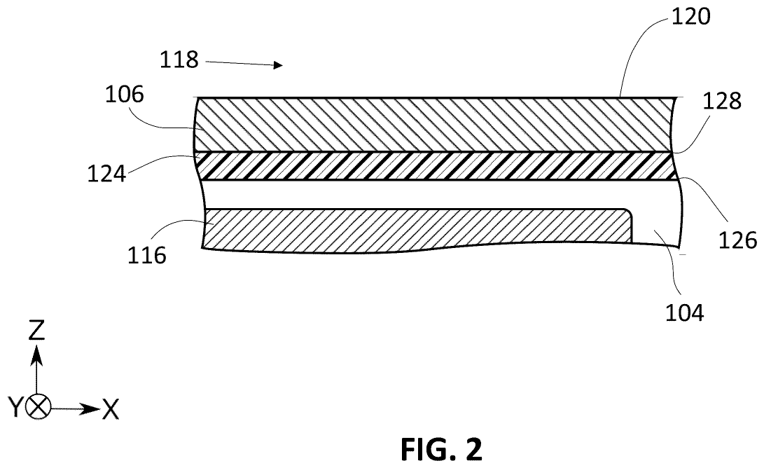

Referring now to FIGS. 1 and 2, in the embodiment shown, the stator cover 106 is releasably attached to the stator 104 by a bonding layer 124 between the stator 104 and the stator cover 106. More specifically, the bonding layer 124 is releasably adhered to a cover-facing surface 126 of the stator 104, and is also releasably adhered to a stator-facing surface 128 of the stator cover 106, such that the cover-facing surface 126 of the stator 104 is across the bonding layer 124 from the stator cover 106 and the stator-facing surface 128 of the stator cover 106 is across the bonding layer 124 from the stator 104. Thus, the bonding layer 124 fixes the stator cover 106 to the stator 104 and prevents buckling and separation of the stator cover 106 from the stator 104 due to, for example, thermally-induced stresses. In general, when the stator cover 106 is attached to the stator 104 by the bonding layer 124, the stator 104, the stator cover 106, and the bonding layer 124 may collectively be referred to as a “stator device”.

In the embodiment shown, substantially all of the stator-facing surface 128 of the stator cover 106 generally conforms to substantially all of the cover-facing surface 126 of the stator 104. That is, the stator-facing surface 128 generally has a shape that matches a shape of the cover-facing surface 126, such that the stator-facing surface 128 and the cover-facing surface 126 may fit closely together when the stator cover 106 overlays and/or is attached to the stator 104. However, in alternative embodiments, only a portion of the stator-facing surface 128 may generally conform to only a portion of the cover-facing surface 126.

In the embodiment shown, the bonding layer 124 adheres to substantially all of the cover-facing surface 126 of the stator 104 and substantially all of the stator-facing surface 128 of the stator cover 106. However, in alternative embodiments, the bonding layer 124 may adhere to less than all of the cover-facing surface 126 and/or to less than all of the stator-facing surface 128. For example, in some alternative embodiments, the bonding layer 124 may adhere to at least 50 percent of the cover-facing surface 126 and at least 50 percent of the stator-facing surface 128.

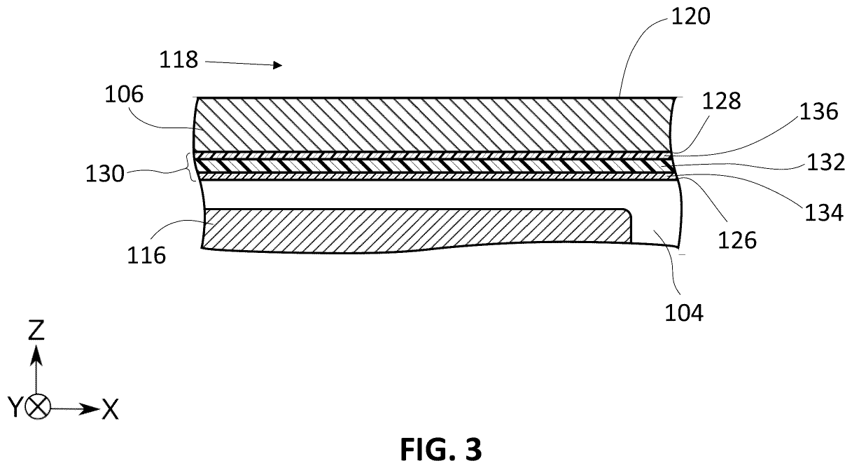

In the embodiment shown in FIGS. 1 and 2, the bonding layer 124 is made up of a single layer and is generally homogeneous. In such embodiments, the bonding layer 124 may be or may include, for example, a thermoplastic material such as a hot-melt adhesive or a wax, or a lubricant such as a grease. More specifically, the bonding layer may include a hot-melt adhesive such as a low-temperature hot glue, a wax such as a microcrystalline wax or a museum wax, or a grease such as a silicone grease. However, alternative embodiments may differ. For example, in some alternative embodiments, such as the embodiment of FIG. 3, the bonding layer may include a plurality of constituent layers or may otherwise be heterogeneous.

Referring now to FIG. 3, a particular non-limiting embodiment of the stator device of the displacement system 100 of FIG. 1 is shown, and, as described above, includes the stator 104 and the stator cover 106. In the embodiment shown in FIG. 3, the stator cover 106 is releasably attached to the stator 104 by a bonding layer 130. The bonding layer 130 includes a solid film 132, a first adhesive 134 adhered to the solid film 132 and to the stator 104, and a second adhesive 136 adhered to the solid film 132 and to the stator cover 106. The solid film 132 may be, for example, a polymer such as polyethylene terephthalate or thermoplastic polyurethane. The first adhesive 134 may be, for example, a silicone. The second adhesive 136 may be, for example, an epoxy or a cyanoacrylate. Generally, the first adhesive 134 may be a weaker adhesive than the second adhesive 136. Thus, adhesion between the second adhesive 136 and the stator cover 106 and/or between the second adhesive 136 and the solid film 132 may be stronger than adhesion between the first adhesive 134 and the stator 104 and/or between the first adhesive 134 and the solid film 132. Further, in some embodiments, adhesion between the first adhesive 134 and the solid film 132 may be stronger than adhesion between the first adhesive 134 and the stator 104.

In some embodiments, the solid film 132 may be or may include a microsuction tape, which can attach to a surface via a vacuum force created by deforming the microsuction tape (e.g., by pressing or forcing the microsuction tape against the surface). In such embodiments, the microsuction tape may attach directly to the stator 104, the stator cover 106, or both the stator 104 and the stator cover 106, such that one or both of the first and second adhesives 134 and 136 may not be required.

Attachment of the stator cover 106 to the stator 104 generally involves placing the stator cover 106 over the stator 104 with a bonding layer, such as the bonding layer 124 or the bonding layer 130, between the stator cover 106 and the stator 104, and causing the bonding layer 124 or 130 to adhere to the stator 104 and to the stator cover 106. In some embodiments, the bonding layer 124 or 130 may be adhered to the stator 104 or to the stator cover 106 before the stator cover 106 is placed over the stator 104. That is, in such embodiments, the bonding layer 124 or 130 may not be between the stator cover 106 and the stator 104 when it is adhered to the stator 104 or to the stator cover 106.

In embodiments where the bonding layer includes a thermoplastic material such as a hot-melt adhesive or a wax, causing the bonding layer to adhere to the stator 104 and/or to the stator cover 106 may involve heating the thermoplastic material to at least a melting temperature of the thermoplastic material. In some such embodiments, heating the thermoplastic material may involve driving current through the conductors 116 of the stator 104 to generate heat for heating the thermoplastic material. In some such embodiments, the stator 104 may also control the mover 102 to move toward the stator 104 and push against the working surface 120 to force the stator cover 106 toward the stator 104 in order to accelerate spreading of the melted thermoplastic material out along the the cover-facing surface 126 of the stator 104 and the stator-facing surface 128 of the stator cover 106.

Generally, in embodiments where the bonding layer includes a thermoplastic material, in order to prevent the thermoplastic material from detaching from the stator 104 and/or the stator cover 106 during operation, the thermoplastic material may have a melting temperature that is higher than an operating temperature of the stator 104. For example, the thermoplastic material may have a melting temperature of at least 40° C., at least 60° C., at least 80° C., or at least 100° C. To avoid excessive heating requirements during attachment of the stator cover 106 to the stator 104, the melting temperature of the thermoplastic material may be at most 100° C., at most 80° C. or at most 60° C., for example.

In embodiments where the bonding layer includes a solid film and first and second adhesives, such as the solid film 132, the first adhesive 134, and the second adhesive 136, causing the bonding layer to adhere to the stator 104 may involve causing the first adhesive to adhere to the solid film and to the stator 104. Similarly, in such embodiments, causing the bonding layer to adhere to the stator cover 106 may involve causing the second adhesive to adhere to the solid film and to the stator cover 106.

In embodiments where the bonding layer includes a microsuction tape, causing the bonding layer to adhere to the stator 104 may involve pressing the microsuction tape and the stator 104 together. Similarly, in such embodiments, causing the bonding layer to adhere to the stator cover 106 may involve pressing the microsuction tape and the stator cover 106 together.

When the stator cover 106 is attached to the stator 104, removal or detachment of the stator cover 106 from the stator 104 generally involves breaking the bonding layer 124 or 130, disrupting adhesion between the bonding layer 124 or 130 and the stator 104, and/or disrupting adhesion between the bonding layer 124 or 130 and the stator cover 106.

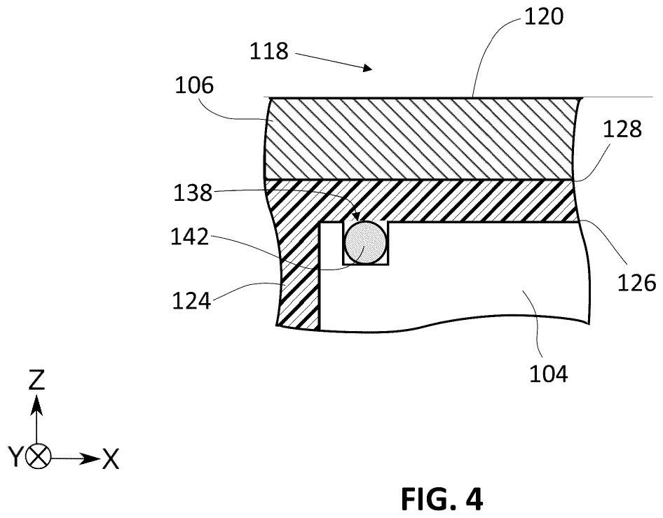

Referring now to FIGS. 1 and 4, the stator 104 of the embodiment shown includes channels, shown generally at 138 and 140, which are configured to receive and releasably hold releasing bodies 142 and 144, respectively, when the stator cover 106 is attached to the stator 104 by the bonding layer 124. Each of the releasing bodies 142 and 144 may be or may include, for example, a wire. In the embodiment shown, the stator 104 includes two channels, 138 and 140, each configured to receive a respective one of the releasing bodies 142 and 144. However, alternative embodiments may vary. For example, in some alternative embodiments, the stator 014 may only include one channel configured to receive a releasing body. In other alternative embodiments, the stator 104 may include three or more channels configured to receive respective releasing bodies.

In some embodiments, one or both of the releasing bodies 142 and 144 may be inserted into the channels 138 and 140 prior to attachment of the stator cover 106 to the stator 104. In some embodiments, one or both of the releasing bodies 142 and 144 may be inserted into the channels 138 and 140 after attachment of the stator cover 106 to the stator 104. In some embodiments, only one of the releasing bodies 142 and 144 may be inserted into its respective one of the channels 138 and 140, while the other one of the channels 138 and 140 remains empty. In some embodiments, both releasing bodies 142 and 144 may be inserted into their respective channels 138 and 140.

Once one or both of the releasing bodies 142 and 144 have been inserted into their respective channels 138 and 140, they may be used to detach the stator cover 106 from the stator 104. Considering, as an example, the releasing body 142 inserted in the channel 138, the stator cover 106 may be detached from the stator 104 by withdrawing the releasing body 142 from the channel 138, and then drawing the releasing body 142 through the bonding layer 124 to break the bonding layer 124, to separate the bonding layer 124 from the stator 104, and/or to separate the bonding layer 124 from the stator cover 106.

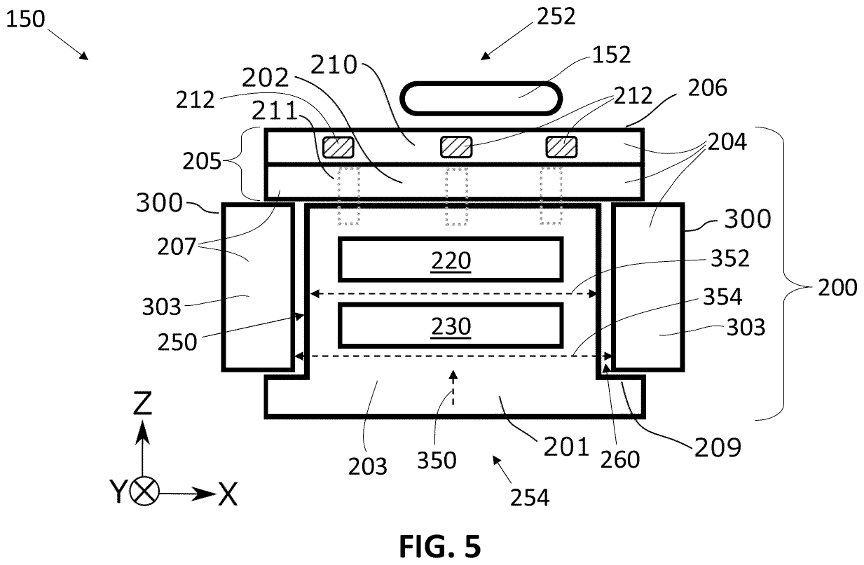

Referring now to FIG. 5, a displacement system according to another embodiment is shown generally at 150 and includes a mover 152, a stator 200, and a controller (not shown). The mover 152 includes one or more magnets (not shown) and may be similar to the mover 102 of the embodiment of FIG. 1. The stator 200 includes a stator structure 204 and an stator electronics sub-assembly 203. In general, the stator electronics sub-assembly 203 may be inserted into and removed from a stator environment, shown generally at 250, which is defined by the stator structure 204. When the stator electronics sub-assembly 203 is installed in the stator environment 250, the stator 200 is operable to provide forces and torques to the mover 152 to controllably move the mover 152 in a working environment, shown generally at 252, which is generally separated from the stator environment 250.

The stator structure 204 includes a motor sub-module 210, electrical connectors 211, a motor support structure 202, a stator support structure 300, and a working surface 206 for the mover 152 to move along. The motor support structure 202 and the stator support structure 300 may generally be referred to as a support structure 207 of the stator structure 204. Additionally, the motor support structure 202, the motor sub-module 210, the electrical connectors 211, and the working surface 206 may generally be referred to as a motor structural sub-assembly 205 of the stator structure 204.

The motor sub-module 210 includes electrical conductors 212, which may be similar to the electrical conductors 116 of the embodiment of FIG. 1. That is, when an electrical current is driven in the electrical conductors 212, the electrical conductors 212 are positioned and configured to generate one or more external magnetic fields operable to move the mover 152 in the working environment 252 along the working surface 206.

The stator electronics sub-assembly 203 includes a position-sensor sub-module 220 and an amplifier sub-module 230. The amplifier sub-module 230 includes one or more amplifiers (not shown), which may be similar to the amplifier 117 of the embodiment of FIG. 1. When the one or more amplifiers of the amplifier sub-module 230 are electrically connected to the electrical conductors 212 of the motor sub-module 210, the one or more amplifiers—and thus the amplifier sub-module 230 and, more generally, the stator electronics sub-assembly 203—may drive one or more electrical currents in the electrical conductors 212, generating one or more external magnetic fields which may move the mover 152.

The electrical connectors 211 of the stator structure 204 are electrically connected to the electrical conductors 212 of the motor sub-module 210 and are electrically connectable to the stator electronics sub-assembly 203 when the stator electronics sub-assembly 203 is in the stator environment 250. As such, when the stator electronics sub-assembly 203 is installed in the stator environment 250 and electrically connected to the electrical connectors 211, the stator electronics sub-assembly 203, and therefore the amplifier sub-module 230, is electrically connected to the electrical conductors 212 and may thus drive one or more electrical currents in the electrical conductors 212.

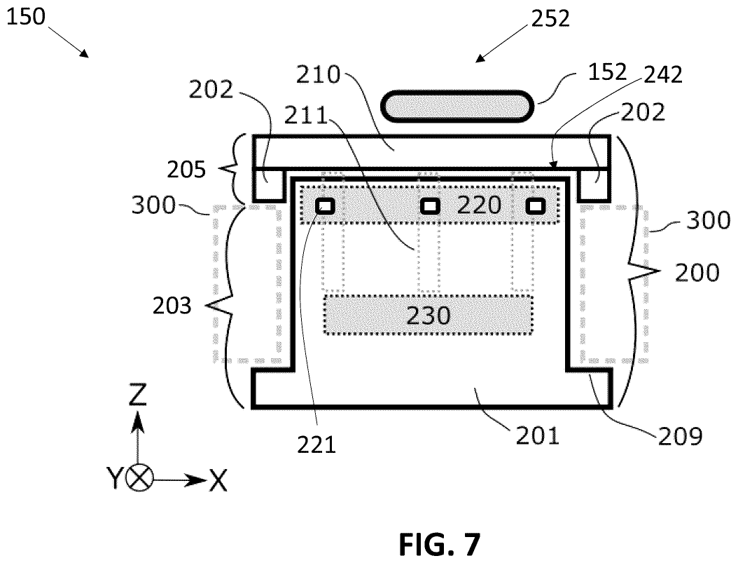

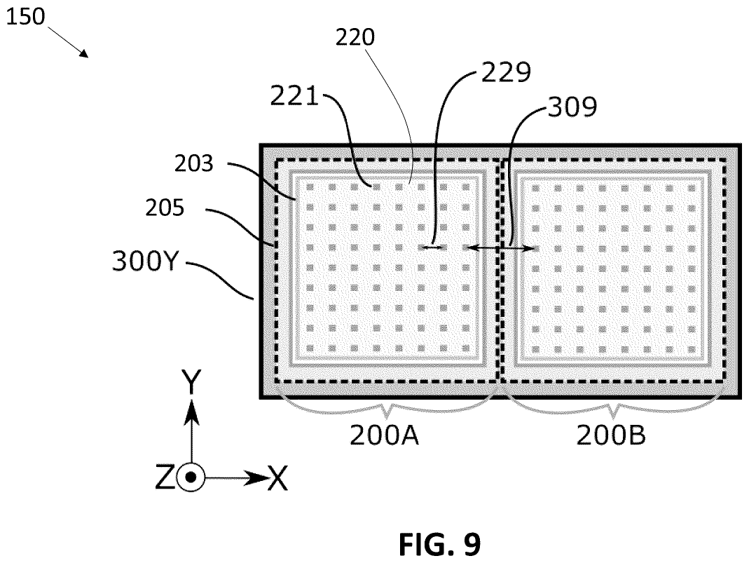

The position-sensor sub-module 220 includes one or more sensors (not shown in FIG. 5; see sensors 221 in FIGS. 7 and 9) which are positioned to measure or detect a position of the mover 152 when the mover 152 is moving in the working environment 252. The one or more sensors of the position-sensor sub-module 220 may be similar, for example to the sensors 114 of the embodiment of FIG. 1.

As noted above, the support structure 207 of the stator structure 204 includes the motor support structure 202 and the stator support structure 300. The motor support structure 202 supports the motor sub-module 210 and thus the electrical conductors 212. The stator support structure 300 in turn supports the motor support structure 202. Together, the motor support structure 202 and the stator support structure 300—and thus, more generally, the support structure 207—define the stator environment 250. In the embodiment shown, this support structure 207 separates the stator environment 250 from the working environment 252 of the mover 152. More specifically, the support structure 207 seals the stator environment 250 from the working environment 252. Notably, the support structure 207 is configured to maintain this separation between the stator environment 250 and the working environment 252 even when the stator electronics sub-assembly 204 is inserted into or removed from the stator environment 250.

In some embodiments, the motor support structure 202—and thus the motor structural sub-assembly 205—may be attached or mounted to the stator support structure 300. For example, the motor support structure 202 may be mounted to the stator support structure 300 via attachment means such as fasteners or adhesives. In some embodiments, the motor support structure 202 may be mounted to the stator support structure 300 around a perimeter of the motor support structure 202. In some embodiments, attachment between the motor support structure 202 and the stator support structure 300 may seal the stator environment 250 from the working environment 252. For example, the motor support structure 202 may be sealed to the stator support structure 300 using a sealant or a gasket at an interface between the motor support structure 202 and the stator support structure 300. More specifically, in some embodiments, the motor support structure 202 may define threaded holes through which fasteners may be inserted along a-Z direction to the stator support structure 300 (or its close proximity) to pull the motor support structure 202 against the stator support structure 300 and secure the support structure 207 together. When the motor support structure 202 is pulled in the −Z direction towards the stator support structure 300, a compressible seal such as a gasket may be engaged along the perimeter of the motor support structure 202, thereby separating the stator environment 250 and the working environment 252 and preventing fluid exchange (e.g., air, water, chemicals etc.) between the two environments. Similarly, the fasteners may be used to pull the motor support structure 202 towards the stator support structure 300 to compress an adhesive or sealant to the correct height before it sets, thereby separating the two environments.

In some embodiments, a vacuum may be utilized in the working environment above the working surface 206. Under such conditions and where there is a higher pressure below the motor structural sub-assembly (such as regular atmospheric pressure), there may be a corresponding load (in the +Z direction) acting on the motor structural sub-assembly 205. In such situations, mounting the motor support structure 202 and thus the motor structural sub-assembly 205 to the stator support structure 300 may be utilized for both physically securing the motor structural sub-assembly 205 (against the large upwards force generated by the pressure differential) and for sealing (e.g., against any fluid, pressure, or contaminant exchanges between the working environment 252 and the stator environment 250).

In general practice, electrical conductors in stator construction-such as the electrical conductors 212 of the motor sub-module 210—may typically be simple metal conductors without any moving parts lacking delicate features that are likely to break or degrade over time (e.g., via thermal degradation, vibration, corrosion, fatigue failure, etc.). Thus, the frequency of expected servicing for stator conductors may be substantially less than other electronic or electrical components of the stator, such as the position-sensor sub-module 220 and amplifier sub-module 230 of the stator electronics sub-assembly 203. It may therefore be advantageous to leave the stator conductors and other non-electronic components of the stator installed when replacing such electronic components. As explained above, in the embodiment shown in FIG. 5, the stator structure 204—including the motor sub-module 210 and thus the electrical conductors 212—may remain installed and thereby maintain environmental separation between the stator environment 250 and the working environment 252 while the stator electronics sub-assembly 203 is removed, for example, for servicing or replacement. In some applications, cleaning of the working environment to the degree required to permit running the overall displacement system may be very time and labor intensive. Therefore, leaving the working environment isolated when replacing or servicing the stator electronics may prevent considerable additional cleaning time during servicing and the possibility of a long and costly shutdown.

In the embodiment shown, the relative positions of the stator environment 250 and the working environment 252 may be described with respect to the working surface 206, the motor sub-module 210 and its electrical conductors 212, and the motor support structure 202. That is, the working surface 206 is generally adjacent to the working environment 252 and positioned between the electrical conductors 212 and the working environment 252. The motor support structure 202 is positioned between the electrical conductors 212 and the stator environment 250. The working environment 252 is across the working surface 206 from the stator environment 250, and is also across the motor sub-module 210 and the electrical conductors 212 from the stator environment 250.

While the motor support structure 202 may be constructed of metal, it should be understood that due to the relative proximity of the motor support structure 202 to the magnets of the mover 152 there may be an eddy current interaction between the two. Additionally, if the motor support structure 202 is constructed with magnetic material, the close proximity of the magnetic portion of the mover 152 may cause a large attraction force towards the working surface 206 which may negatively affect performance. To account for this, in some embodiments, features may be cut into parts of the motor support structure 202 close to where the mover 152 moves (i.e., where the magnetic field of the mover is strongest) to reduce the area of the motor support structure 202 at these features and thereby limit eddy current generation. For example, the motor support structure 202 may define one or more motor support structure cutouts extending through the motor support structure 202 along a thickness direction of the at least one motor support structure 202 between the electrical conductors 212 and the stator environment 250 (e.g., see FIG. 7). Alternatively or additionally, in some embodiments generally non-conductive materials may be used for the motor support structure (such as ceramics, composites, plastics etc.) to limit potential eddy current effects during operation. In some embodiments, the motor structure support 202 may include a laminated structure where conductive and non-conductive materials are laminated in some areas to limit the effective connected area of metal sections overlapping vertically with the magnets of the mover 152.

In some embodiments where the loading on the motor structural sub-assembly 205 may be large, such as for pressing or vacuum applications, the motor support structure 202 may exceed 10 mm in thickness. If the motor structural sub-assembly 205 is sufficiently stiff, the stator electronics sub-assembly 203 may experience only a small effect from the expected loading of a particular application. For example, in some embodiments a large force along the Z direction could generate large deformation and bending for the stator electronics sub-assembly 203, which may negatively affect the internal electronics components. Bending stresses could also alter the performance of some components (i.e., sensors) and/or induce electrical shorts (i.e., from solder/pad separation or electrical contact separation in a connector), immediately or over an extended number of cycles from fatigue. In some embodiments, the mounting of the stator electronics sub-assembly 203 may be de-coupled from a bottom side of the motor support structure 202 (for load-bearing purposes) to reduce the effects experienced on the stator electronics sub-assembly 203 during loading. In other embodiments, the bottom side of the motor support structure 202 may be in contact with and supported by the stator electronics sub-assembly 203 in a central region of the motor support structure 202. In some embodiments, the motor support structure 202 may be attached to the stator electronics sub-assembly 203 (e.g., via fasteners or other temporary mounting connections) in the central region to reduce loading on the motor support structure 202, thereby potentially allowing a reduction in a load bearing capacity of the motor support structure 202 (and a corresponding reduction in material used or thickness of the motor support structure 202).

Because the motor support structure 202 is positioned between the electrical conductors 212 of the motor sub-module 210 and the stator electronics sub-assembly 203 in the stator environment 250, access paths (i.e., motor support structure cutouts) may be provided for the electrical connectors 211 to pass through the motor support structure 202 to facilitate the connection between the motor sub-module 210 and the stator electronics sub-assembly 203. That is, the electrical connectors 211 may extend through one or more of the motor support structure cutouts. In some embodiments, the electrical connectors 211 may connect to the amplifier sub-module 230 through features cut in the sensor sub-module 220. In other embodiments, the electrical connectors 211 may connect to the sensor sub-module 220 and thereby connect to the amplifier sub-module 230 with additional connectors.

As shown in FIG. 5, the stator support structure 300 defines an opening, shown generally at 260, between the stator environment 250 and an outside environment, shown generally at 254. The stator electronics sub-assembly 203 may be inserted into and removed from the stator environment 250 through this opening 260, while the support structure 207 continues to maintain the separation between the stator environment 250 and the working environment 252. Generally, the stator structure may include one or more stator support structure members 303 which extend between the motor support structure 202 and the opening 260. More specifically, in the embodiment shown, the stator support structure members 303 extend between the motor support structure 202 and the opening 260 in an installation direction 350 which is generally perpendicular to the working surface 206. Therefore, in the embodiment shown, the stator electronics sub-assembly 203 may be inserted into and removed from the stator environment 250 through the opening 260 along the installation direction 350. In some embodiments, the electrical connectors 211 may be positioned to be connected to the stator electronics sub-assembly 203 with an insertion motion of the stator electronics sub-assembly 203 into the stator environment 205 along the installation direction 350. More specifically, the electrical connectors 211 may be positioned to mate with corresponding components in the stator electronics sub-assembly 203 during insertion. In some embodiments, the electrical connectors 211 may be configured to flexibly accommodate a mismatch in position between the stator electronics sub-assembly 203 and the motor support structure 202.

In the embodiment shown, the stator electronics sub-assembly 203 also includes a sub-assembly body 201 and one or more overhanging mounting features 209. The sub-assembly body 201 is generally insertable into and removable from the stator environment 250 through the opening 260 along the installation direction 350. More specifically, the sub-assembly body 201 has a body width 352 in a width direction perpendicular to the installation direction 350, while the opening 260 has an opening width 354 in the width direction which is greater than or equal to the body width 352. Thus, the sub-assembly body 201 of the stator electronics sub-assembly 203 may pass through the opening 260 without conflict. The overhanging mounting features 209 protrude from the sub-assembly body 201 a protrusion distance 240 in the width direction such that, where the overhanging mounting features 209 protrude from the sub-assembly body 201, the stator electronics sub-assembly 203 may not be able to fit through the opening 260. For example, a sum of the protrusion distance 240 and half of the body width 352 may be greater than half of the opening width 354. In some embodiments, as part of the installation, the stator electronic sub-assembly 203 may additionally be positioned using locating features relative to either the stator support structure 300 or the motor structural sub-assembly 205.

As described above, the stator electronics sub-assembly 203 may be mounted or attached to the motor-support structure 202 when installed into the stator environment 250. Additionally or alternatively, the stator electronics sub-assembly 203 may be mounted or attached to the stator support structure 300. For example, the stator electronics sub-assembly 203 may be attached to the stator support structure 300 at the opening 206. More specifically, one or more of the overhanging mounting features 209 of the sub-assembly body 201 of the stator electronics sub-assembly 203 may be attached to the stator support structure 300 at the opening 206. As another example, the stator electronics sub-assembly 203 may be attached to one or more of the stator support structure members 303. In some embodiments, the stator electronics sub-assembly 203 may be mounted to the stator support structure 300 with fasteners that attach the sub-assembly body 201 in a fixed location relative to the stator support structure 300. Locating of the stator electronics sub-assembly 203 may be done with suitable locating features between the sub-assembly body 201 and the stator support structure 300 or between the sub-assembly body 201 and the motor support structure 202.

Generally, the stator electronics sub-assembly 203 may be installed in the stator structure 204 by inserting the stator electronics sub-assembly 203 into the stator environment 250 through the opening 260 along the installation direction 350, and electrically connecting the stator electronics sub-assembly 203 to the electrical conductors 212 by electrically connecting the stator electronics sub-assembly 203 to the electrical connectors 211. Similarly, the stator electronics sub-assembly 203 may be uninstalled from the stator 200 by removing the stator electronics sub-assembly 203 from the stator environment 250 through the opening 260 along the installation direction 350, and electrically disconnecting the stator electronics sub-assembly 203 from the electrical connectors 211.

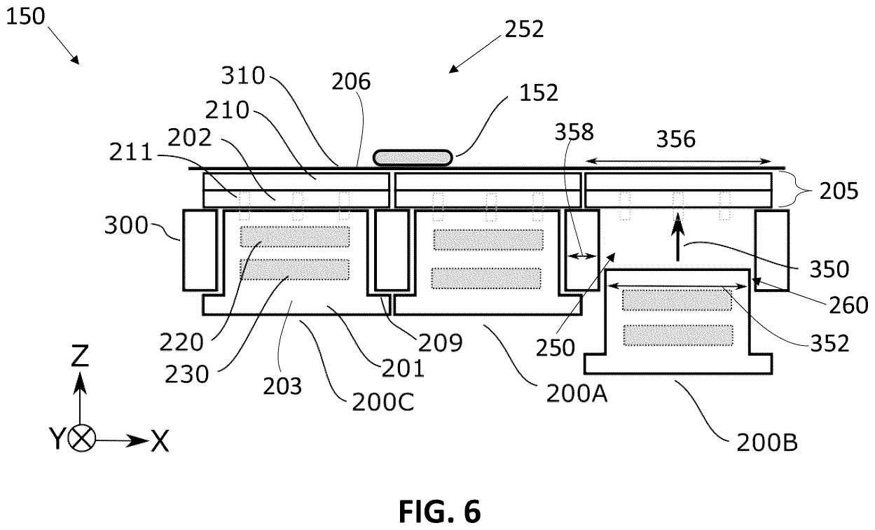

FIG. 6 shows a particular multi-stator embodiment of the displacement system 150 of FIG. 5, which includes the mover 152 and a plurality of stators 200A, 200B, and 200C. Each of the stators 200A, 200B, and 200C is generally similar to the stator 200 of FIG. 5, and includes, for example, respective ones of a motor structural sub-assembly 205, stator electronics sub-assembly 203, and stator support structure 300. In the embodiment shown, each of the stator electronics sub-assemblies 203 is removable from the stator environment 250 through a corresponding one of the openings 260. The displacement system 150 of FIG. 6 also includes an isolation barrier 310 defining the working surface 206 and generally separating the mover 152 from stators 200A, 200B, and 200C. The isolation barrier 310 may include, for example, a metal. In some embodiments, the isolation barrier 310 may be similar to the stator cover 106 of the embodiment of FIGS. 1 to 4. In the embodiment shown, the motor structural sub-assemblies 205 have a motor width 356 which is greater than the body width 352 of the stator electronics sub-assemblies 203. In the embodiment shown, a difference between the motor width 356 and the body width 352 is sized to create a corresponding clearance for a divider width 358 of the stator support structure 300. As in the embodiment of FIG. 5, the stator electronics sub-assemblies 203 can be inserted or removed along the installation direction 350 (i.e., generally along a Z direction), whereby this portion of the stator may be serviced or replaced in a system.

In the embodiment shown in FIG. 6, the plurality of stators 200A, 200B, and 200C include a plurality of the motor structural sub-assemblies 205 mounted to the stator support structure 300 in a permanent manner. With such mounted motor structural sub-assemblies 205 it may possible to affix the isolation barrier 310 to the motor structural sub-assemblies 205 (e.g., with an adhesive, by generating a vacuum on the underside of the isolation barrier, etc.) to create a continuous impervious working surface 206 free of inter-stator crevices that might fill with contaminants over time. To fully separate the stators 200A, 200B, and 200C from the working environment 252, the isolation barrier 310 should additionally be sealed (e.g., with a gasket) or joined (e.g., welded) around its perimeter to create a distinctly separate working environment 252 from the one where the stators operate (i.e., such that fluid such as air or water is not easily able to pass between the two environments).

FIG. 7 shows a particular embodiment of the displacement system 150 of FIG. 5 where the motor support structure 202 includes a cutout, shown generally at 242, which allows the stator electronics sub-assembly 203 to protrude beyond a top side of the stator support structure 300. By providing improved access for the stator electronics sub-assembly 203, some components like the sensor sub-module 220—and its position sensing sensors 221—can be positioned in closer proximity to the working environment 252, potentially improving overall position detection (e.g., if the sensors 221 measurement of a mover is affected by distance). A more direct interface with the motor sub-module 210 may also enable better temperature/heat exchange between the motor sub-module 210 and body 201 and reduce heat generated via the electrical connectors 211 between the motor sub-module 210 and the amplifier sub-module 230.

Additionally, it should be understood that the top surface of the stator electronics sub-assembly 203 could protrude past the bottom plane of the motor structural sub-assembly 205 for many particular embodiments in local areas or across the entire width 352 of the sub-assembly body 201 of the stator electronics sub-assembly 203. When the stator electronics sub-assembly 203 is allowed to protrude slightly into the motor structural assembly 205 (e.g., via pocketing or cutouts in the motor support structure 202), such as for the purposes of allowing the sensor sub-module 220 (and its sensors 221) to be located closer to the mover 152, there may be a corresponding reduction in material for the motor support structure 202. Cutouts and pocket features in the motor support structure 202 may thus potentially reduce a stiffness of the motor support structure 202. Due to this potential for compromising the structural performance of the motor structural sub-assembly 205, these embodiments may be better suited to applications with reduced loading, or the use of cutouts/pockets in the motor structural support may need to be limited. In some embodiments, a closer sensor proximity to the mover 152 may improve the sensitivity of the sensor solution for position sensing. Cutouts or pockets in the motor structural support 202 may also be used to increase mechanical engagement between the motor structural sub-assembly 205 and the stator electronics sub-assembly 203.

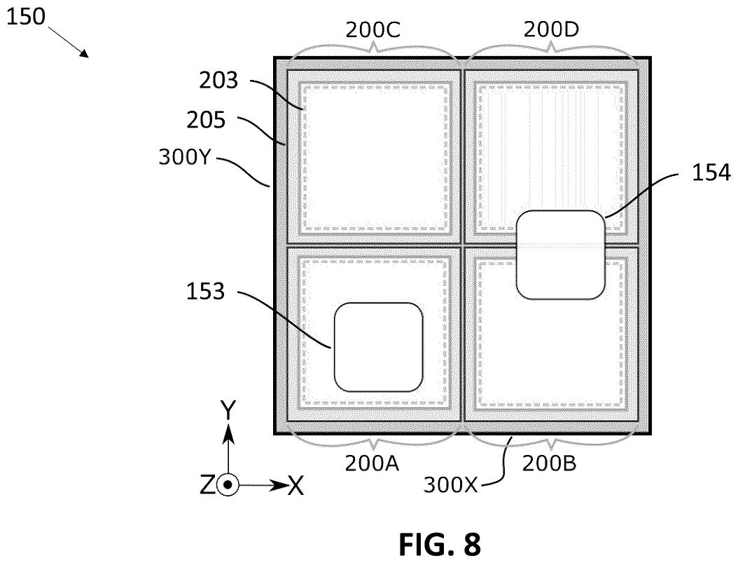

FIG. 8 shows a particular multi-stator embodiment of the displacement system 150 of FIG. 5, which includes a plurality of stators 200A, 200B, 200C, and 200D arranged in a layout extending in both Y and X directions in-plane, a single common stator support structure 300 with Y-direction oriented members 300Y and X-direction oriented members 300X, movers 153 and 154, and an isolation barrier 310 (not shown). Each of the stators 200A, 200B, 200C, and 200D is generally similar to the stator 200 of FIG. 5, and each of the movers 153 and 154 may generally be similar to the mover 152 of FIG. 5. The stator support structure 300 provides a structural frame extendable in both X and Y directions for a particular layout which can support the weight of the stators 200A, 200B, 200C, and 200D and movers 153 and 154 for the displacement system 150. Of course, the embodiment shown is an example only, and alternative embodiments may differ. For example, alternative embodiments may include more, fewer, or different stators, and alternative embodiments may include more, fewer, or different movers. For example, some embodiments may include only one stator module or more than one stator module.

Although the stator support structure 300 is shown in FIG. 8 as a single part, it should be understood that multiple parts may be utilized to construct the stator structure. For example, the various members 300X and 300Y extending in X and Y directions, respectively, and making up the overall stator support structure 300 may be separate pieces assembled together to create the overall stator support structure 300. Generally, the cost for a single thick part with large sections cutout may be very expensive. To reduce the cost of the stator support structure 300, it may be desirable to use multiple small and simple parts for the X and Y members 300X/300Y which may be welded, fastened, or bonded together or the like at their intersecting locations to create the overall stator support structure 300. Similarly, it is possible to create the overall stator support structure 300 with a plate extending in X and Y for the chosen stator layout comprising cutouts and mounting features that is reinforced with X and Y members fastened to one side of the plate (thereby reinforcing the overall stator support structure 300).

FIG. 9 shows a particular multi-stator embodiment of the displacement system 150 of FIG. 5, which includes stators 200A and 200B positioned adjacent to each other. Each of the stators 200A and 200B is generally similar to the stator 200 of FIG. 5, and includes a respective stator electronics sub-assembly 203 with a corresponding sensor sub-module 220. The sensor sub-modules 220 in this embodiment include grid-like arrangements of sensors 221. Within each sensor sub-module 220, the sensors 221 (which are used to determine mover position) have a typical sub-assembly sensor spacing 229 between one another. The respective sensor sub-modules 220 for the two adjacent stators 200A and 200B also have a respective inter-stator sensor spacing 309. More specifically, sensors 221 of the stator 200A adjacent to the stator 200B are spaced apart from corresponding adjacent sensors 221 of the stator 200B adjacent to the stator 200A by the inter-stator sensor spacing 309. Although the embodiment shown in FIG. 9 includes grid layouts of the sensors 221, it should be understood that other distributions of sensors may be used in alternative embodiments.

In some embodiments, the inter-stator sensor spacing 309 may generally be equal to the sub-assembly sensor spacing 229. In such embodiments, a mover may be controlled in a similar fashion whether the mover is at locations substantially overlapping with the boundary of neighboring stators (such as vertically overlapping with the full width 358 of the stator structure 300 between the adjacent stators) or the mover is at locations fully overlapping with the sensor sub-module 220 of a stator 200. In other embodiments, the inter-stator sensor spacing 309 may be close to a multiple of the sub-assembly sensor spacing 229 (e.g., 2× or 3×) to still achieve a generally uniform overall layout and simplify the mover position sensing process or control process. In yet other embodiments, the inter-stator sensor spacing 309 may be greater than the sub-assembly sensor spacing 229. In some such embodiments, the inter-stator sensor spacing 309 may be significantly larger than the sub-assembly sensor spacing 229. In general, for stators 200 with non-uniform multi-stator sensor arrangements (i.e., greater density localized in areas within a given stator electronics sub-assembly 203), the detected portions of mover (i.e., magnets) vertically overlapping with the stator electronics sub-assembly 203 (or in close proximity to the edges thereof) may be used to determine the overall mover position. For example, by measuring with the position sensors a magnet sub-assembly of the mover which has a known size and arrangement of elements, it may be possible to use that portion of the mover's overall magnet assembly to determine a position. With a greater number of magnet assemblies or larger portion of the mover's overall magnet area overlapping vertically with the position sensing elements, a greater number of data points may be used to calculate the position with greater accuracy since the effect of measurement noise can be reduced (i.e., by averaging the position determined from each magnet sub-assembly).

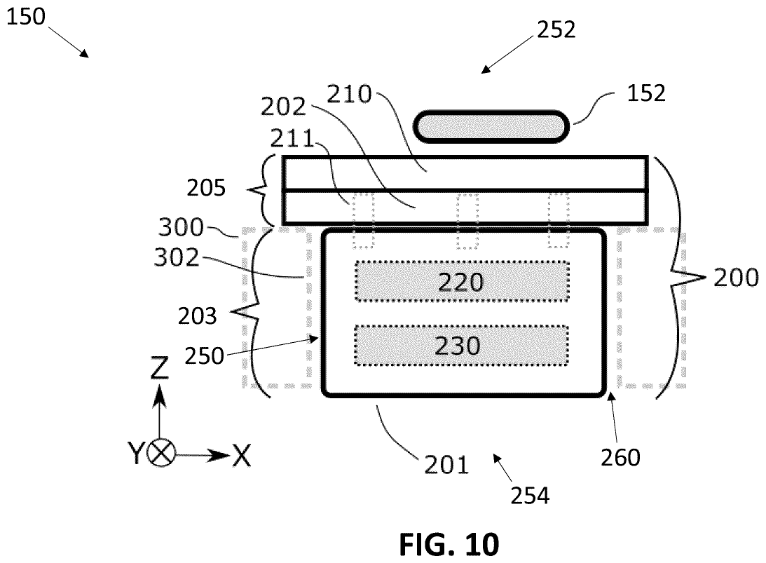

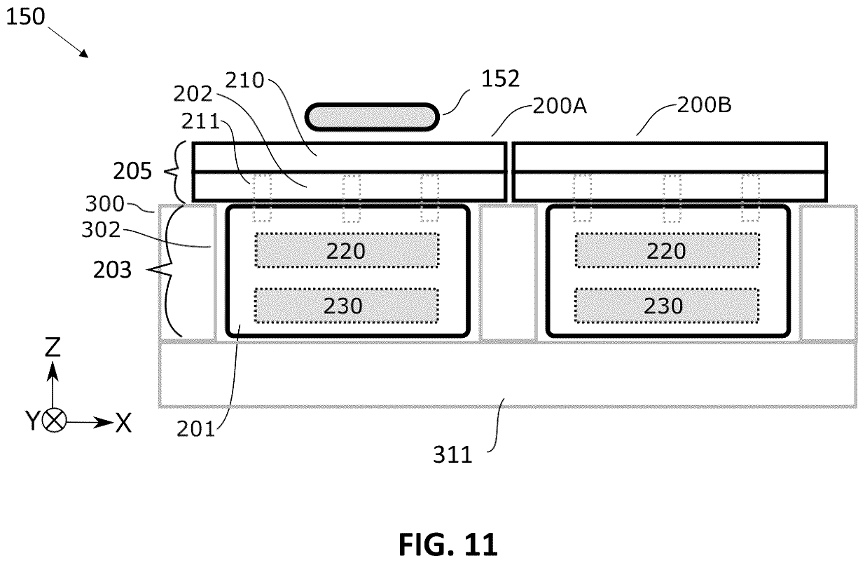

FIG. 10 shows a particular embodiment of the displacement system 150 of FIG. 5 where the sub-assembly body 201 of the stator electronics sub-assembly 203 mounts to the bottom surface of the motor support structure 202 and/or inner faces 302 of the stator support structure 300. Such an embodiment may be particularly useful in applications involving relatively small loading, or if the motor support structure 202 is very strong. By removing the overhang mounting structure 209 from the stator electronics sub-assembly 203, the −Z facing side of the stator support structure 300 may be fully utilized for other purposes. For example, the stator support structure 300 could be used to mount or seal a bottom sealing plate operable to releasably seal the opening 260 to fully enclose the stator environment 250 from the outside environment 254 (in addition to being sealed from the working environment 252). Such a sealing plate may be removable to allow servicing. In some embodiments, the sealing plate may include one or more temporary stiffeners, such as the temporary stiffener 311 of the embodiment of FIG. 11, described below. The −Z facing side of the stator support structure 300 may also be used more comprehensively for mounting the motor structural sub-assembly 205 (e.g., for evenly compressing a gasket).

FIG. 11 shows a particular multi-stator embodiment of the displacement system 150 of FIG. 10, which includes stators 200A and 200B and a stator support structure 300 which includes a temporary stiffener 311 which may provide additional structural support to the stator support structure 300. The temporary stiffener 311 may be, for example, a rib. During operation, the temporary stiffener 311 may be mounted to one or more of stator support structure members of the stator support structure 300 below the stators 200A and 200B. The use of such a temporary stiffener may reduce deflection for applications involving large downward forces (i.e., heavy masses on working surface or pressing operations), heavy upward forces (i.e., a vacuum environment), and/or vibration inducing forces. In some embodiments, the temporary stiffener 311 may also mount to the sub-assembly body 201 of the stator electronics sub-assembly 203 (e.g., with fasteners to the −Z facing side of the body). Where a temporary stiffener vertically overlaps (i.e., along the Z direction) with a stator electronics assembly 203, separate mounting connections may also be utilized connect the two parts and provide structural support. Although the idea of using temporary stiffeners mounted to the stator edge structure will be most readily applicable in displacement systems with stator electronics sub-assemblies 203 lacking overhanging mounting features 209, such as the displacement system of FIG. 10, it should also be understood that such temporary stiffeners may also be used with displacement systems with stator electronics sub-assemblies 203 which have overhanging mounting features 209. In the embodiment shown, the temporary stiffener 311 is a single piece extending across multiple stators (i.e., the stators 200A and 200B). However, in alternative embodiments, the temporary stiffener 311 may include multiple segments connected together or independently mounted to the stators.

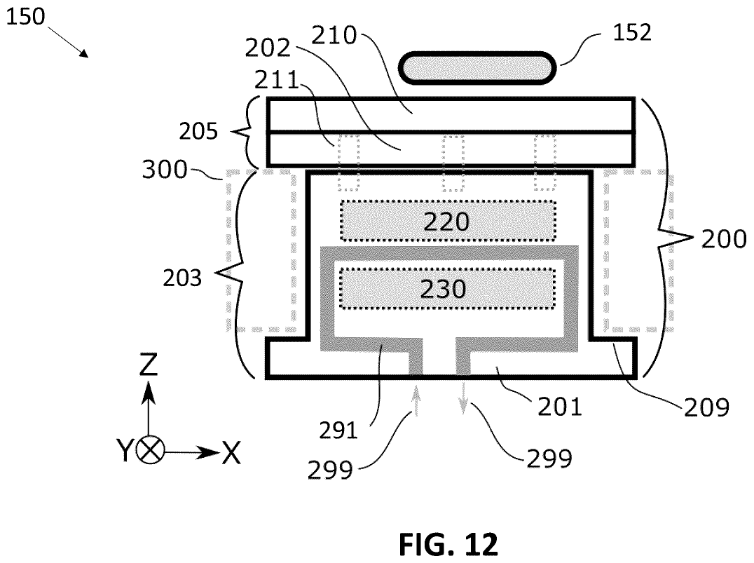

FIG. 12 shows a particular embodiment of the displacement system 150 of FIG. 5 where the sub-assembly body 201 of the stator electronics sub-assembly 203 includes an integrated stator electronics cooling channel 291 flowing through a suitable path integrated into the sub-assembly body 201 and generally configured to convey heat through the stator electronics sub-assembly 203. More specifically, the stator electronics cooling channel 291 may be arranged to remove heat generated internally (e.g., from the amplifiers, sensors, or power electronics), and the sub-assembly body 201 may interface with the motor structural sub-assembly 205 (via the bottom of the motor support structure 202) to transfer heat generated in the motor sub-module 210. Heat transfer between the motor structural sub-assembly 205 and the stator electronics sub-assembly 203 may be facilitated with the use of an additional heat transfer interface material to maintain efficient and even thermal transfer across varying conditions.

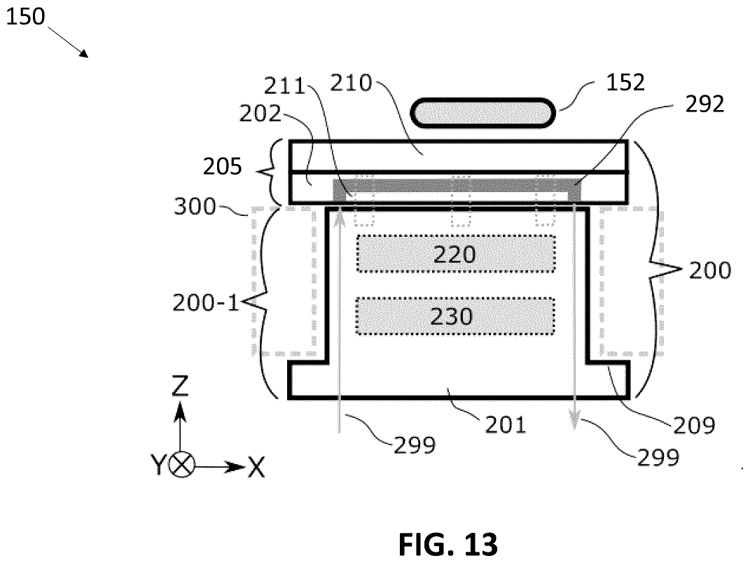

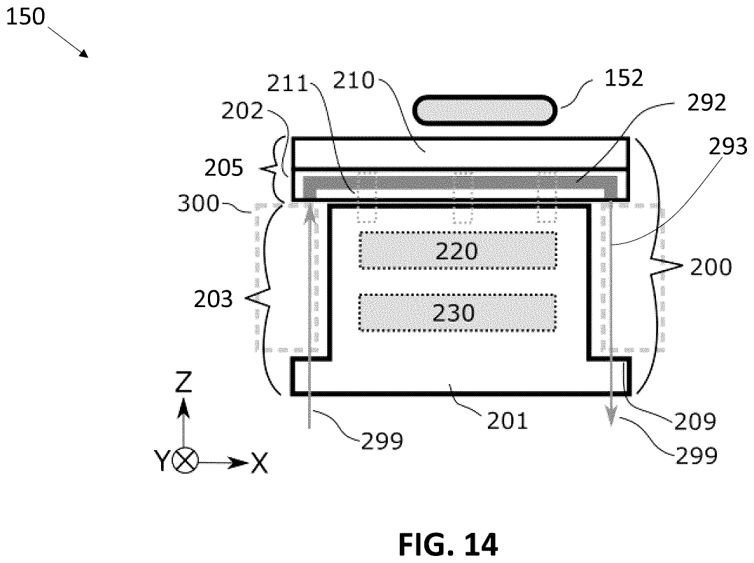

FIGS. 13 and 14 show particular embodiments of the displacement system 150 of FIG. 5 where the motor support structure 202 further includes an integrated motor support structure cooling channel 292, routed through or around the sub-assembly body 201 of the stator electronics sub-assembly 203 with cooling connectors 299 and generally configured to convey heat through the motor support structure 202. For example, the motor support structure cooling channel 292 may be used to remove any heat generated by the motor sub-module 210. Additionally, heat generated by the electronics in the stator electronics sub-assembly 203 can also be dissipated with good contact between the top of the sub-assembly body 201 of the stator electronics sub-assembly 203 and the bottom of the motor support structure 202. This heat transfer can further be facilitated with the use of an intermediate heat transfer interface material to maintain efficient and even thermal transfer across varying conditions. In embodiments where the motor support structure cooling channel 292 is routed around the sub-assembly body 201, it may be connected to and in communication with a stator support structure cooling channel 293 to transfer heat between the stator support structure 300 and the motor support structure 202.

In some embodiments, the integrated stator electronics cooling channel 291 and motor support structure cooling channel 292 may be connected together to create a single cohesive cooling network during operation. That is, the stator electronics cooling channel 291 may be in communication with the motor support structure cooling channel 292 to transfer heat between the at least one stator electronics sub-assembly 203 and the motor support structure 202. In embodiments where the two cooling paths are connected together, they may also support disconnection from each other before, during or after the removal of the stator electronics sub-assembly 203 from the stator environment 250, so that servicing or replacement of the stator electronics sub-assembly 203 is possible.

A cooling channel may generally be considered a path for conveying fluid for the purposes of heat transfer. For a stator a cooling channel would typically facilitate removing heat generated by the stator.

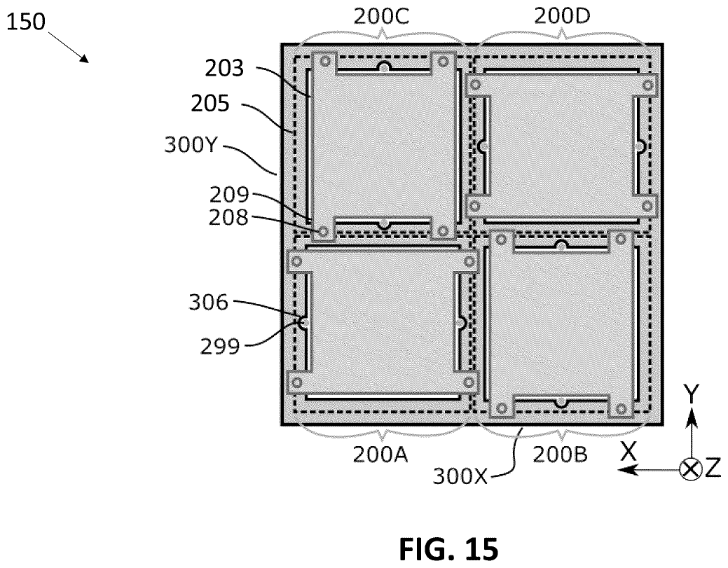

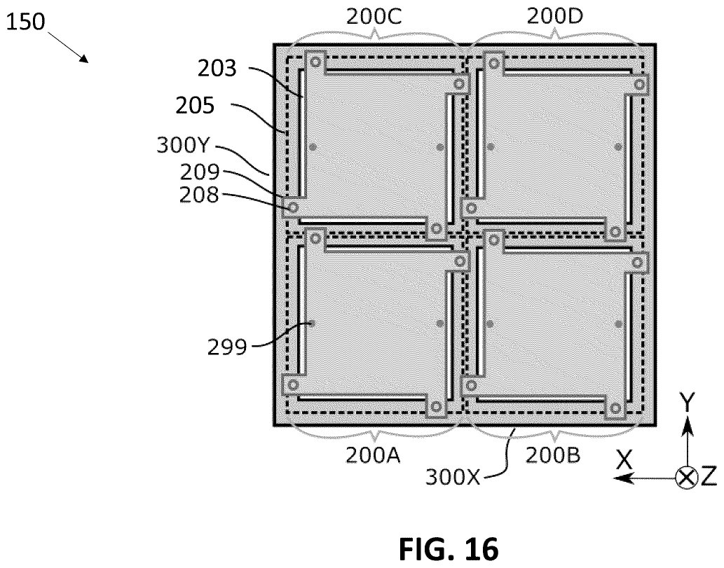

FIGS. 15 and 16 show particular multi-stator embodiments of the displacement system 150 of FIG. 5 which include a plurality of stators 200A, 200B, 200C, and 200D arranged in a layout extending in both Y and X directions in-plane. In the embodiments shown, the stators 200A, 200B, 200C, and 200D have respective stator electronic sub-assemblies 203 with sub-assembly bodies 201 featuring localized overhang mounting features 209 (including fastener features 208 such as holes for screws). The overhanging mounting features 209 may extend beyond the extent of the motor sub-module 210 in the motor structural sub-assembly 205 (and the middle distance between adjacent stators), in which case the arrangement of overhanging mounting features for neighboring stators needs to be positioned to avoid conflicts. Where the overhanging mounting features 209 protrude beyond the motor sub-module 210 edge, these features should generally not protrude more than the divider width 358 of the stator support structure 300 members located between stators, to avoid interfering with the removal of an adjacent stator. In embodiments where the overhanging mounting features 209 extend beyond that stator's the motor sub-module 210 edge, it may be possible to use the greater area or extension to increase mounting strength such as with the use of more or larger diameter fasteners.

In the embodiment shown in FIG. 15, specific regions of the stator support structure 300 (i.e., sections aligning with specific edges of a stator), may be allocated for the mounting of specific stators to avoid conflicts. By alternating the mounting pattern (such as through Rz rotation or discrete opposite side types) the stators can maintain a generally symmetrical mounting if desired and avoid conflict for mounting with their neighbors. In the embodiment of FIG. 15, protrusion directions of the overhanging mounting features 209 of adjacent stators are different and are alternated. Additionally, the embodiment of FIG. 15 shows a similar water-cooling system to that of the embodiment of FIG. 14, where the cooling connectors 299 are routed through the stator support structure 300 (i.e., with a cutout to create a suitable connector path 306).

In the embodiment shown in FIG. 16, the overhang mounting features 209 for each stator have an asymmetric pattern where the mounting locations of adjacent stator patterns are separated to avoid conflicts. Such an interlocking arrangement of mounting features can allow adjacent stators to efficiently share the common mounting area of the bottom. Additionally, the embodiment of FIG. 16 shows a similar water-cooling system to that of FIG. 13, where the cooling connectors 299 are routed through the stator electronics sub-assembly 203 region (i.e., with a cutout to create a suitable connector path 306).

Although the above connector paths 306 for the cooling connectors 299 of FIGS. 15 and 16 are shown in either the stator electronics sub-assembly 203 or stator support structure 300, it should be understand that they could be partially accommodated in a combination of both the stator support structure and stator electronics sub-assembly 203.

Although the one or more cutouts 306 is shown for routing the cooling connector 299 in FIG. 15, it should be understood that for some particular embodiments the cooling connector may be integrated into the stator support structure. For example, the cooling connector may be integrated as a feature of the stator support structure (i.e., drilling one or more holes) and the mounting of the motor structural sub-assembly may be utilized to join and seal the integrated cooling connector 299 to the integrated cooling channel 292 (i.e., with a compressed o-ring/gasket). Similarly, for the embodiment in FIG. 16, the cooling connector may be integrated as a feature of the sub-module body 201. For example, the cooling connector could be integrated as a feature of the sub-module body 201 by drilling one or more holes therein and the mounting of the stator electronics sub-assembly 203 (relative to motor structural sub-assembly 205) could be utilized to join and seal the integrated cooling connector 299 to the integrated motor support structure cooling channel 292 (e.g., with a compressed o-ring/gasket).

Stators and stator structures such as those of the embodiments of FIGS. 5-16 may provide benefits for serviceability via bottom removal of the stator's electronics while maintaining full force generating capabilities of a standard stator motor. The generally uniform layout of electrical conductors for an arrangement of stators as described in these embodiments (and in particular their respective motor sub-modules) may enable uniform force generating performance while vertically overlapping with the stator structure.

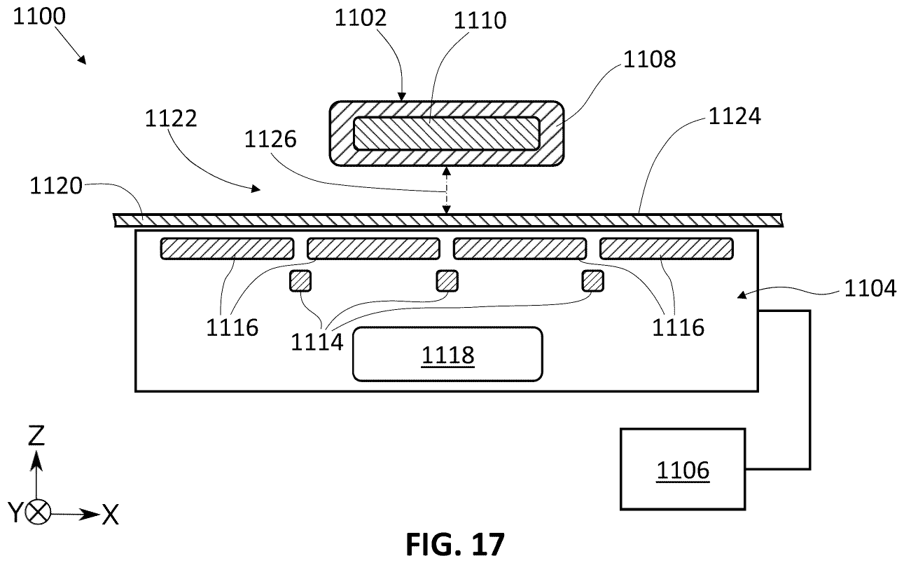

Referring now to FIG. 17, a magnetic displacement system according to another embodiment is shown generally at 1100 and includes a mover 1102, a stator 1104, and a controller 1106. The mover 1102 may be configured to carry one or more components (not shown). The mover 1102 may also be referred to as a “mover device”, a “robotic device”, a “moveable stage”, a “motion stage”, or a “moveable motion stage”. Further, as used herein, the term “component” is a general term and non-limiting examples of components that may be carried by the mover 1102 may include workpieces, products being assembled, raw parts, materials, samples, biological samples, drugs, containers, payloads, devices, and assemblies. In the embodiment shown, the magnetic displacement system 1100 includes only one mover 1102. However, alternative embodiments may include multiple movers, and in some alternative embodiments, a plurality of movers may carry a holder which may hold one or more components. In some systems, all movers are substantially similar or nearly identical. However, other systems may include movers of varying sizes and configurations.

The stator 1104 supports and actuates the mover 1102, such that the mover 1102 travels across the stator 1104 to another location in the magnetic displacement system 1100. In the embodiment shown, the magnetic displacement system 1100 includes only one stator 1104. However, alternative embodiments may include multiple stators, and in some alternative embodiments, the multiple stators may be of different types—for example, in some alternative embodiments, some stators may have large work areas, while other stators may function as flyways between the work areas for rapid movement of movers and components in narrow spaces. This may be achieved by arranging a stator made from multiple electromagnetic driving regions, arranged in a single row in the direction of movement of the mover.

The controller 1106 controls the stator 1104 and the mover 1102. The controller 1106 may be directly connected to the stator 1104 using a wired or wireless connection, and may control the mover 1102 indirectly through the stator 1104. Alternatively, the controller 1106 may also be connected to the mover 1102 using a wired or wireless connection, such that the controller 1106 may communicate with the mover 1102 directly. For example, a high-speed data cable may be used, such as an ethernet cable, a HDMI cable, or any cable of sufficient data rate bandwidth. In some embodiments, the controller 1106 may be completely integrated with the stator 1104. In embodiments where the controller 1106 is completely integrated within the stator 1104, any method of electrical connection may be used, such as ribbon cables, edge board connectors, wire connectors, headers and pins, etc. A wireless connection may include Bluetooth®, WiFi, Zigbee®, Cellular, Near Field Communications (NFC), etc. In some embodiments, more than one controller may be used within the magnetic displacement system 1100. For example, the controller 1106 may only control the stator 1104 or a group of stators including the stator 1104, while another controller may control another stator or group of stators.

Generally, the mover 1102 and the stator 1104 may interact with each other via one or more magnetic fields, so that the stator 1104 can provide forces and torques to the mover 1102 to controllably move the mover 1102. The controller 1106 may determine and provide commands to the stator 1104 to generate specific forces and torques to move the mover 1102.

A pair of coordinate systems may be defined to help explain the movement of the mover 1102 relative to the stator 1104. In particular, a stator coordinate system may be defined, which is fixed to the stator 1104. A mover coordinate system may also be defined, which is fixed to the mover 1102 and moves with the mover 1102 relative to the stator 1104 and the stator coordinate system. Conventional Cartesian coordinates (x, y, z) may be used to describe these coordinate systems, although it will be appreciated that other coordinate systems could be used. For convenience and brevity, in the present description and the associated drawings, the directions (e.g., x, y, z directions) in the stator coordinate system and the directions in the mover coordinate system may be shown and described as being coincident with one another—i.e., the stator-x (or Xs), stator-y (or Ys), and stator-z (or Zs) directions may be shown as coincident with mover-x (or Xm), mover-y (Ym), and mover-z (or Zm) directions, respectively. Accordingly, reference to directions x, y, and/or z may refer to directions in both or either of the stator and mover coordinate systems. However, it will be appreciated from the context herein that in some embodiments and/or circumstances, the mover 1102 may move relative to the stator 1104 such that these stator and mover coordinate systems are no longer coincident with one another. In such cases, the following convention may be adopted: the terms stator-x, stator-y and stator-z may be used to refer to directions and/or coordinates in the stator coordinate system and the terms mover-x, mover-y and mover-z may be used to refer to directions and/or coordinates in the mover coordinate system. The symbols Xm, Ym, and Zm may be used to refer respectively to the mover-x, mover-y and mover-z directions, the symbols Xs, Ys, and Zs may be used to refer respectively to the stator-x, stator-y and stator-z directions and the symbols X, Y, and Z may be used to refer respectively to either or both of the mover-x, mover-y, and mover-z and/or stator-x, stator-y, and stator-z directions. In some embodiments, during normal operation, the mover-z and stator-z directions are approximately in the same direction (e.g. within ±30° in some embodiments; within ±10° in some embodiments; and within ±2° in some embodiments).

The mover 1102 includes a structural frame 1108 and one or more actuation magnets 1110 fixed to the structural frame 1108. The structural frame 1108 may be used to provide support to the magnets, facilitate bonding, and/or provide an interface for a part, fixture, or tooling. In some embodiments, the structural frame 1108 may optionally be used to mount additional mounting or locating features (not shown). The one or more actuation magnets 1110 may also be referred to as an “actuation magnet assembly” or, more generally, a “magnet assembly”. The one or more actuation magnets 1110 may be, for example, permanent magnets. In some embodiments, the one or more actuation magnet 1110 may include a plurality of magnetization regions, each magnetization region having a respective magnetization direction. In FIG. 17, the mover 1102 is shown as including a single actuation magnet 1110. However, in some embodiments, the mover 1102 may include more than one actuation magnet 1110, that is, the mover 1102 may include a plurality of actuation magnets 1110. In such embodiments, one, some, or all of the plurality of actuation magnets 1110 may be fixed to the structural frame 1108. The one or more actuation magnets 1110 are configured to respond to one or more external magnetic fields, and in particular are configured to generate forces for moving the mover 1102 in response to one or more external magnetic fields. Examples of such actuation magnets are described and illustrated in United States patent no. U.S. Pat. No. 10,222,237 (incorporated herein by reference) as arrays of permanent magnets 112A, 112B, 112C, 112D (or collectively, magnet arrays 112).

Still referring to FIG. 17, the stator 1104 includes sensors 1114, electrical conductors 1116, and an amplifier 1118. Each of the sensors 1114 is configured to measure at least one magnetic field. Each of the sensors 1114 may only accurately measure a magnetic field within a certain range of that sensor 1114. Examples of such sensors are described and illustrated in United States patent no. U.S. Pat. No. 10,222,237 as magnetic field sensors 501. The sensors 1114 may include, for example, Hall-effect magnetic field sensors, magneto-resistive sensors, and/or other suitable types of magnetic field sensors that can measure magnetic flux density. In FIG. 17, the stator 1104 is shown as including three sensors 1114; however, it will be appreciated that in some alternative embodiments, the stator 1104 may include a different number of sensors 1114, or may not include any sensors. These sensors 1114 may also be arranged at positions extending along the Y direction in addition to different X positions that are shown in FIG. 17.

Each of the electrical conductors 1116 is configured to generate at least one external magnetic field. The electrical conductors 1116 may be, for example, coils. Examples of such coils are described and illustrated in United States patent no. U.S. Pat. No. 10,222,237 as coil traces 126. In FIG. 17, the stator 1104 is shown as including four electrical conductors 1116; however, it will be appreciated that in some alternative embodiments, the stator 1104 may include only one electrical conductor 1116, two electrical conductors 1116, three electrical conductors 1116, or more than four electrical conductors 1116. In some embodiments, the stator 1104 may include a plurality of electrical conductors distributed in one or more planar layers. In some embodiments, the layout of the electrical conductors 1116 may include a first group of coils that are linearly oriented and/or elongated in a first direction (e.g., the X-direction as shown in FIG. 17). The first group of coils may include a second coil pitch or spacing in a second direction (e.g., the Y-direction as shown in FIG. 17). The electrical conductors 1116 may also include a second group of coils that are linearly elongated in the second direction. The second group of coils may include a first coil pitch or spacing in the first direction. The first and second coil pitch/spacing may be equal. In some embodiments, the electrical conductors 1116 may be linearly elongated in different directions (e.g., linearly elongated in the X-direction or linearly elongated in the Y-direction) and may vertically overlap with other electrical conductors.

The sensors 1114 and electrical conductors 1116 may be arranged in a pattern on the stator 1104, for example as described and illustrated in United States patent no. U.S. Pat. No. 10,222,237. Patterns may include one or more sensors 1114 configured around each of the electrical conductors 1116, such as one of the sensors 1114 at each edge of one of the electrical conductors 1116. Other patterns may also be possible. It will be appreciated that the sensors 1114 may be arranged in patterns near or around the electrical conductors 1116 to provide proper feedback to the controller 1106 for position sensing and control of the mover 1102, for example. In some embodiments, the stator 1104 may further include a plurality of iron teeth (not shown).

The amplifier 1118 is connected to the electrical conductors 1116. In some embodiments, the amplifier 1118 may be referred to as a “driving circuit” or a “stator driving circuit”. In general, the amplifier 1118 may drive one or more electrical currents in the electrical conductors 1116, generating one or more external magnetic fields. The controller 1106 may be connected to deliver control signals to the amplifier 1118. The control signals may be used to control current driven by the amplifier 1118 into the electrical conductors 1116. In the embodiment shown in FIG. 17, the stator 1104 includes one amplifier 1118. However, in alternative embodiments, a stator may include more than one amplifier.

The current controllably driven into each of the electrical conductors 1116 may cause that electrical conductor 1116 to create or generate at least one external magnetic field. The at least one external magnetic field thus generated causes corresponding magnetic forces to act on the mover 1102. The one or more external magnetic fields may act on the actuation magnet 1110, thereby moving the mover 1102 relative to the stator 1104. The mover 1102 may be controllable in at least two degrees-of-freedom (2-DOF) motions, including but not limited to three in-plane degrees-of-freedom (3-DOF) controllable motions and six degrees-of-freedom (6-DOF) controllable motions, which may include three translational degrees of freedom and three rotational degrees of freedom, for example. In general, embodiments such as those described herein may involve one or more movers that are controllably movable relative to a stator in at least 2 in-plane DOF motions, in 3 in-plane DOF motions, in 4 in-plane DOF motions, in 5 in-plane DOF motions, or in 6-DOF controllable motions, for example.

In the embodiment shown, the magnetic displacement system 1100 includes a cover 1120 overlaying the stator 1104. The cover 1120 may overlay an entire top surface of the stator 1104 and may function as a barrier between the stator 1104 and an operating environment of the mover 1102, shown generally at 1122. The operating environment 1122 is generally a space in which the mover 1102 moves during operation—that is, when being controlled by the stator 1104, e.g., when carrying a component. In some embodiments, the cover 1120 may protect the stator 1104 from adverse conditions in the operating environment 1122, such as humidity, liquids, and/or corrosive environments. In some embodiments, the cover 1120 may protect the operating environment 1122 from contamination. The cover 1120 may be made up of one or more materials that minimally interact with magnetic fields, such as non-magnetic steel (i.e., austenitic stainless steel), plastic, ceramic, aluminum, titanium, or other minimally magnetic or non-magnetic materials. In some embodiments, the cover 1120 may be subject to internal stresses (e.g., tensile stresses) when installed.

The cover 1120 includes and thus supports a working surface 1124 for the mover 1102 to move upon. Generally, the working surface 1124 describes a continuous area of the cover 1120 upon which the mover 1102 may be controlled by the stator 1104. That is, when the cover 1120 overlays the stator 1104, the working surface 1124 is between the stator 1104 and the operating environment 1122, and is thus between the stator 1104 and the mover 1102 when the mover 1102 is being controlled by the stator 1104 (i.e., when the mover 1102 is moving in response to external magnetic fields generated by the stator 1104). Suitable feedback control algorithms executed by the controller 1106 and suitable position feedback from the sensors 1114 allow the controller 1106 and the stator 1104 to control the mover 1102 along the working surface 1124. The working surface 1124 may be flat, curved, cylindrical, spherical or some other shape that allows the mover 1102 to move along the working surface 1124. In some embodiments, a combined working surface may be defined by a plurality of stators each having a respective stator cover, such that each working surface of each stator cover may be combined into a larger combined working surface. In other embodiments, a single stator cover or unitary cover may overlay a plurality of stators, forming a single continuous working surface. While the working surface 1124 is depicted horizontally in FIG. 17, it should be understood that the working surface 1124 may be mounted vertically or at an angle to gravity.

The mover 1102 may move along the working surface 1124 in a “contact mode” or a “non-contact mode”. The contact mode (also known as “sitting mode”) may involve contact media such as sliding and/or rolling bearings between the mover 1102 and the working surface 1124. The non-contact mode (also known as “levitation mode”) may require maintaining a controllable gap 1126 between the mover 1102 and the working surface 1124 of the cover 1120 in a normal direction Z. The gap 1126 may be an air gap. The mover 1102 may also rest upon the working surface 1124 without moving, which may be in a contact mode or a non-contact mode. In the non-contact mode, the mover 1102 may have 6-DOF controllable motion (known as “active levitation mode”). Alternatively, the mover 1102 may maintain the gap 1126 by passive levitation means (known as “passive levitation mode”). In the passive levitation mode, the mover 1102 may rest above the working surface 1124 in the non-contact mode.

In some embodiments, the magnetic forces associated with the interactions between the magnetic fields created by the currents in the electrical conductors 1116 and the magnetic fields associated with the actuation magnet 1110 may attract the mover 1102 toward the stator 1104, and thus the working surface 1124, at all times when the controller 1106 is controlling the currents driven by the amplifier 1118. In other embodiments, the magnetic forces associated with the interactions between the magnetic fields created by the currents in the electrical conductors 1116 and the magnetic fields associated with the actuation magnet 1110 may force the mover 1102 away from the stator 1104, and thus the working surface 1124, in order to balance gravitational forces to maintain the gap 1126 at all times.

In some embodiments, the gap 1126 between the mover 1102 and the working surface 1124 of the cover 1120 may be maintained by air bearings or compressed-fluid bearings. It will be appreciated that in some embodiments, the gap 1126 may be zero, such as when the mover 1102 operates in contact mode.

As described above, the mover 1102 may work in “levitation mode”, being levitated near the working surface 1124 of the cover 1120 without contacting the cover 1120. In the levitation mode, the mover 1102 may move along the working surface 1124 in X and Y directions, where X and Y are two non-parallel (e.g., orthogonal) directions inside the working surface 1124. It will be appreciated that the gap 1126 between the working surface 1124 and a bottom surface of the mover 1102 is generally much smaller than the mover's lateral dimensions (i.e., dimensions in the X and Y directions).

Although the mover 1102 may be capable of 6-DOF controllable motion, such functionality may not be necessary in all situations. In certain embodiments, levitation of the mover 1102 may not be needed and heavy load carrying capability of the mover 1102 may be desirable. In such embodiments, the mover 1102 may sit on the working surface 1124 supported with mechanical bearings (for example, planar sliding bearings and/or ball transfer units), and may be capable of in-plane 3-DOF controllable motion: translation in X and Y and rotation around Z, where X and Y are two non-parallel (e.g., orthogonal) directions in working surface 1124 and Z is a direction normal to the working surface 1124. When the mover 1102 relies on sliding and/or rolling bearings for support on the working surface 1124 and the mover 1102 is capable of 3-DOF controllable motion, it may be referred to as working in “3-DOF controlled sitting mode”.

In some embodiments, the mover 1102 may be capable of in-plane 3-DOF controllable motions (translations in X and Y and rotation around Z) working in levitation mode without contact with working surface 1124. In this mode, the translation in Z, rotation around X, and rotation around Y (and thus the associated degrees-of-freedom) of the mover 1102 may be open-loop controlled without feedback, using suitable passive levitation technology. When the mover 1102 is capable of 3-DOF controllable motion without contact with the stator 1104, it may be referred to as working in “3-DOF controlled levitation mode”.

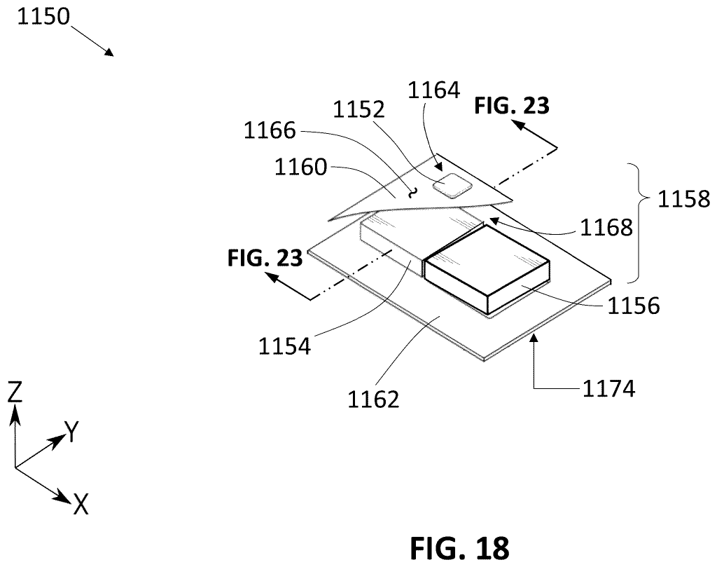

Referring now to FIGS. 18 to 23, a magnetic displacement system according to another embodiment is shown generally at 1150 and includes a mover 1152, stators 1154 and 1156, a stator mounting apparatus 1158, and a controller (not shown). The mover 1152 includes one or more magnets (not shown) and may be similar to the mover 1102 of the embodiment of FIG. 17. Each of the stators 1154 and 1156 includes one or more electrical conductors (not shown) and an amplifier (not shown) and may be similar to the stator 1104 of the embodiment of FIG. 17. Likewise, the controller of the embodiment of FIGS. 18 to 23 may be similar to the controller 1106 of the embodiment of FIG. 17. In the embodiment shown, the stator mounting apparatus 1158 includes a cover 1160 and a main support 1162.

The cover 1160 of the embodiment shown may generally be similar to the cover 1120 of the embodiment of FIG. 17. That is, the cover 1160 overlays the stators 1154 and 1156 and functions as a barrier between the stators 1154 and 1156 and an operating environment of the mover 1152, shown generally at 1164. Further, as in the embodiment of FIG. 17, the cover 1160 includes and thus supports a working surface 1166 for the mover 1152 to move upon and upon which the mover 1152 may be controlled by the stators 1154 and 1156.

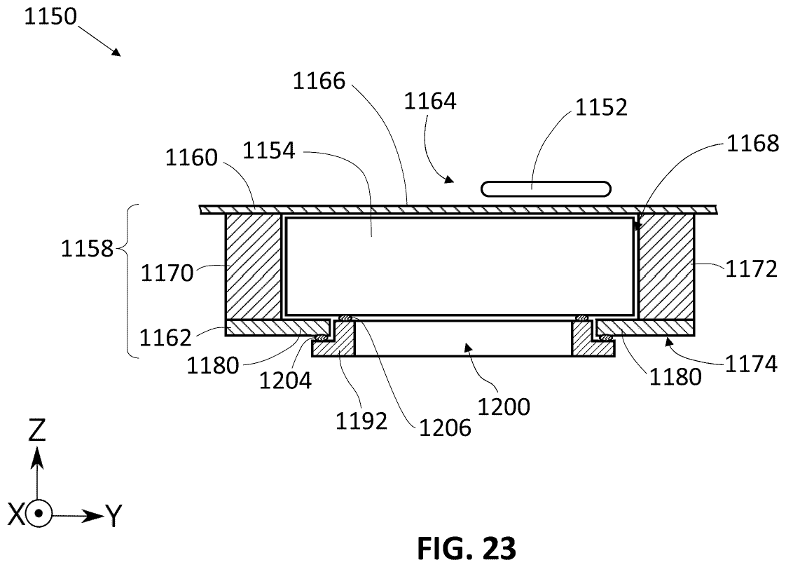

In general, the main support 1162 provides a mounting platform for supporting the stators 1154 and 1156 relative to the cover 1160 and thus the working surface 1166 at least during operation. More specifically, the main support 1162 is spaced apart from the cover 1160 such that the cover 1160 and the main support 1162 define between them a stator chamber, shown generally at 1168. The stator chamber 1168 is dimensioned to accommodate the stators 1154 and 1156, such that the stators 1154 and 1156 may be supported relative to the working surface 1166 in the stator chamber 1168. In the embodiment shown, the cover 1160 and the main support 1162 are supported to be spaced apart from each other by structural members 1170 and 1172 of the stator mounting apparatus 1158 extending between the cover 1160 and the main support 1162 (see FIG. 23). In some embodiments, the cover 1160 and the main support 1162 may be sealed together, directly and/or indirectly. For example, the cover 1160 may be sealed to the structural members 1170 and 1172, which may in turn be sealed to the main support 1162. In such embodiments, sealing between the cover 1160 and the main support 1162 may provide one or more of an airtight seal and a liquid-tight seal between the cover 1160 and the main support 1162. In the embodiment shown, the main support 1162 has the form of a mounting plate, but in alternative embodiments the main support may have a different shape.

An external side 1174 of the main support 1162 faces away from the stator chamber 1168 and thus away from the cover 1160 and thus away from the working surface 1166. Therefore, the external side 1174 of the main support 1162 is accessible from a side of the stator mounting apparatus 1158 which is away from the working surface 1166. As a result, the external side 1174 of the main support 1162 may be accessed without disturbing or disrupting the working surface 1166.

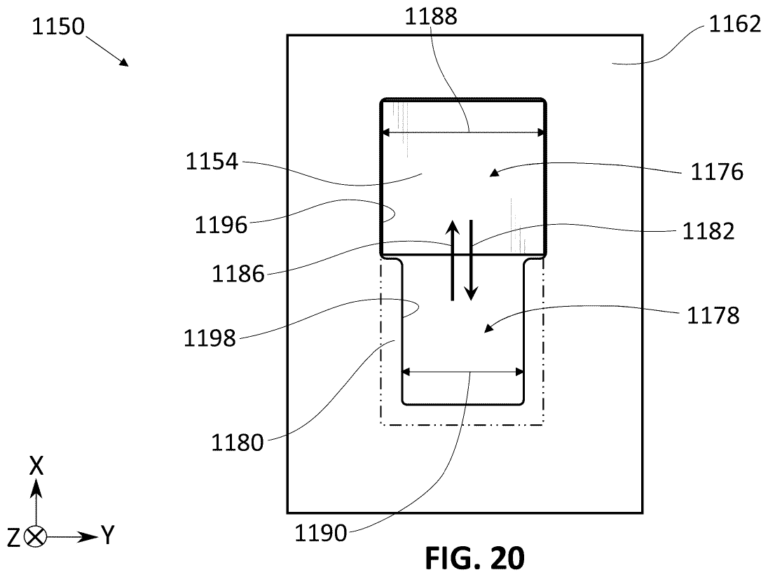

The main support 1162 defines one or more openings which provide access to the stator chamber 1168 from the external side 1174 of the main support 1162. More specifically, in the embodiment shown, the main support 1162 defines a primary opening 1176 and a secondary opening 1178, as shown in FIG. 20 for example.

The primary opening 1176 is dimensioned to receive therethrough one of the stators 1154 and 1156, such that the stators 1154 and 1156 may be inserted into the stator chamber 1168 through the primary opening 1176 from the external side 1174 of the main support 1162, and such that the stators 1154 and 1156 may be removed from the stator chamber 1168 through the primary opening 1176 to the external side 1174 of the main support 1162. More specifically, in the embodiment shown, the primary opening 1176 is dimensioned to receive therethrough one of the stators 1154 and 1156 in a mounting orientation. As used herein, the term “mounting orientation” refers to an orientation of a stator—such as one of the stators 1154 and 1156—when mounted/supported in the stator chamber 1168 to generate magnetic fields operable to move the mover 1152 in the operating environment 1164. For example, in each of FIGS. 18 to 23, the stators 1154 and 1156 are depicted in the mounting orientation. In the embodiment shown, in order to allow the stators 1154 and 1156 to pass through the primary opening 1176 in the mounting orientation, the primary opening 1176 has a shape that is generally corresponds to a shape of one of the stators 1154 and 1156 in the mounting orientation. That is, in the embodiment shown, the primary opening 1176 is complementary to one of the stators 1154 and 1156 in the mounting orientation.

In contrast to the primary opening 1176, the secondary opening 1178 is generally dimensioned to prevent the stators 1154 and 1156 from passing therethrough, at least when the stators 1154 and 1156 are in the mounting orientation. In general, the secondary opening 1178 may provide access, from the external side 1174 of the main support 1162, to stators in the stator chamber 1168 which are positioned away from the primary opening 1176—that is, as shown in FIGS. 18, 19, and 21 to 23, to the stator 1154. In the embodiment shown, the secondary opening 1178 is continuous with the primary opening 1176. However, alternative embodiments may differ. For example, some alternative embodiments may include a main support with more than one primary opening and/or more than one secondary opening. Some alternative embodiments may include a main support defining a primary opening and one or more secondary openings which are separate from the primary opening (i.e., not continuous). Other alternative embodiments may include a main support with only primary openings—that is, without secondary openings. Additionally, some alternative embodiments may include one or more stiffening supports (not shown) removably or permanently installed across one or more secondary openings. In such embodiments, the stiffening supports may be removable to facilitate stator installation and removal, for example.

In the embodiment shown, the working surface 1166 is generally horizontal, the operating environment 1164 (where the mover 1152 moves) is above the working surface 1166, the main support 1162 is under the working surface 1166 such that the stator chamber 1168 is under the working surface 1166, and the external side 1174 of the main support 1162 faces underneath the main support 1162. Thus, in the embodiment shown, the stators 1154 and 1156 may be inserted into and removed from the stator chamber 1168 through the primary opening 1176 from underneath the main support 1162, while the operating environment 1164 remains undisturbed above the working surface 1166. However, alternative embodiments may differ. For example, in some alternative embodiments, the working surface may not be horizontal and may instead be mounted vertically or at an angle to gravity. In some such alternative embodiments, the main support and the stator chamber may not be positioned under the working surface.

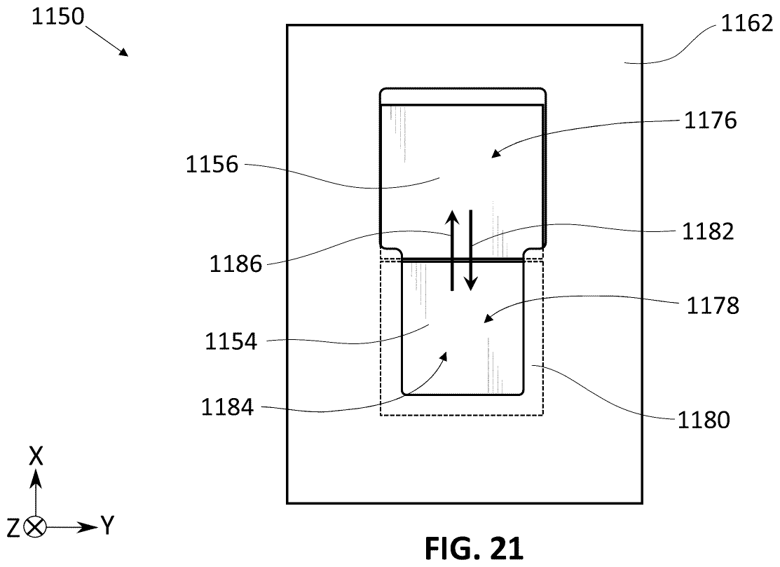

The main support 1162 includes a support portion 1180 adjacent the primary opening 1176 and the secondary opening 1178 (see, in particular, FIG. 20). In general, the support portion 1180 of the main support 1162 serves to support one or more of the stators 1154 and 1156 inside the stator chamber 1168—for example, during operation. In the embodiment shown, the support portion 1180 is depicted as supporting at least the stator 1154. As shown in FIGS. 20 and 21, when the stator 1154 has been inserted into the stator chamber 1168 through the primary opening 1176 from the external side 1174 of the main support 1162, the stator 1154 may be moved in a mounting direction 1182 to a mounting position 1184 on the support portion 1180 in which the stator 1154 is supported by the support portion 1180. In the embodiment shown, the mounting direction 1182 is parallel to the working surface 1166. From the mounting position 1184, the stator 1154 may be moved, in a dismounting direction 1186 opposite to the mounting direction 1182 (and thus also parallel to the working surface 1166), to the primary opening 1176 such that the stator 1156 may be removed from the stator chamber 1168 through the primary opening 1176 to the external side 1174 of the main support 1162.

To facilitate movement of stators in the stator chamber 1168, the stator mounting apparatus 1158 may include guiding means for guiding, for example, the stator 1154 along the mounting direction 1182 and the dismounting direction 1186 between the mounting position 1184 and the primary opening 1176. For example, the structural members 1170 and 1172 may serve as guiding means for guiding the stator 1154 along the mounting direction 1182 and the dismounting direction 1186. Additionally, in some embodiments, particularly those which include main supports having primary openings which are not continuous with their corresponding secondary openings, at least some of the stators may be free—at least during installation—of any features which protrude downward toward the main support 1162 and which may impede stator movement within the stator chamber 1168 along the mounting direction 1182 and the dismounting direction 1186.

As shown in FIG. 20, the primary opening 1176 has a primary width 1188 perpendicular to the mounting direction 1182 (and thus to the dismounting direction 1186), and the secondary opening 1178 has a secondary width 1190 perpendicular to the mounting direction 1182 (and thus to the dismounting direction 1186). In general, the secondary width 1190 is less than the primary width 1188. In some embodiments, the secondary width 1190 may be less than 75% of the primary width 1188. In some embodiments, the secondary width 1190 may be at least 10 mm less than the primary width 1188. In some embodiments, the secondary width 1190 may be at least 25 mm less than the primary width 1188. In some embodiments, the secondary width 1190 may be at least 50 mm less than the primary width 1188. At least because the secondary width 1190 of the secondary opening 1178 is less than the primary width 1188 of the primary opening 1176, the stators 1154 and 1156 may be able to pass through the primary opening 1176 but not through the secondary opening 1178 when in the mounting orientation. That is, as explained above, the primary opening 1176 is dimensioned to receive the stators 1154 and 1156 when in the mounting orientation, while the secondary opening 1178 is dimensioned to prevent the stators 1154 and 1156 from passing through when in the mounting orientation.

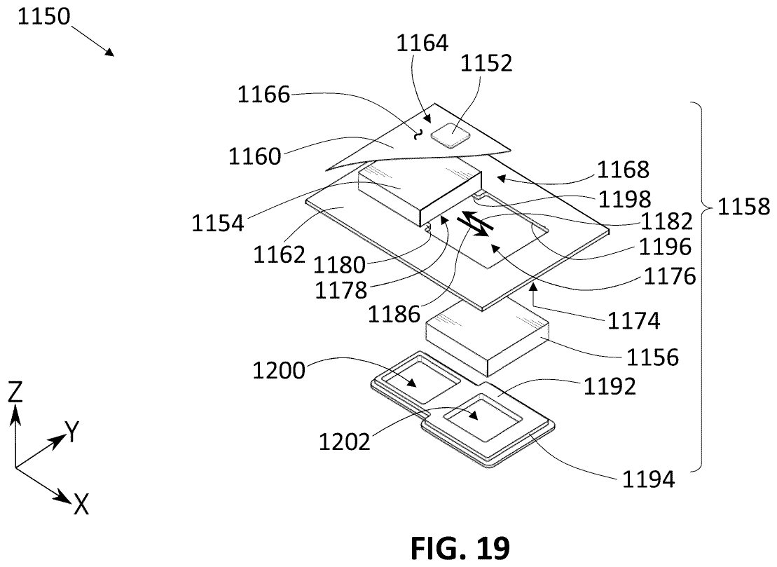

Referring to FIGS. 19, 22, and 23, in the embodiment shown, the stator mounting apparatus 1158 includes a stator support 1192 which is releasably attachable to the main support 1162 around at least the primary opening 1176 to support one or more of the stators 1154 and 1156 in the primary opening 1176. That is, the stator support 1192 may releasably secure the primary opening 1176 to prevent the stators 1154 and 1156 from passing through the primary opening 1176. Therefore, for example, the stators 1154 and 1156 may be inserted into the stator chamber 1168 through the primary opening 1176 from the external side 1174 of the main support 1162, and then the stator support 1192 may be attached to the main support 1162 to secure the primary opening 1176 and thus to secure the stators 1154 and 1156 inside the stator chamber 1168. As depicted in FIGS. 18 to 23, when the stator support 1192 is attached to the main support 1162 to secure the primary opening 1176, the stator support 1192 covers at least a portion of the primary opening 1176 and supports at least the stator 1154 in the primary opening 1176. Further, in the embodiment shown, when the stator support 1192 is attached to the main support 1162 to secure the primary opening 1176, the stator support 1192 also covers at least a portion of the secondary opening 1178. In the embodiment shown, the stator support 1192 has the form of a sub-mounting plate, but in alternative embodiments the stator support 1192 may have different shapes. The stator support 1192 may be releasably attachable to the main support 1162 by fasteners such as, for example, screws and/or bolts. Of course, the stator support 1192 of the embodiment shown is an example only, and alternative embodiments may differ. For example, some alternative embodiments may include a stator support that, when attached to the main support 1162 to secure the primary opening 1176, covers only portions of the primary opening 1176, and does not cover the secondary opening 1178 at all.

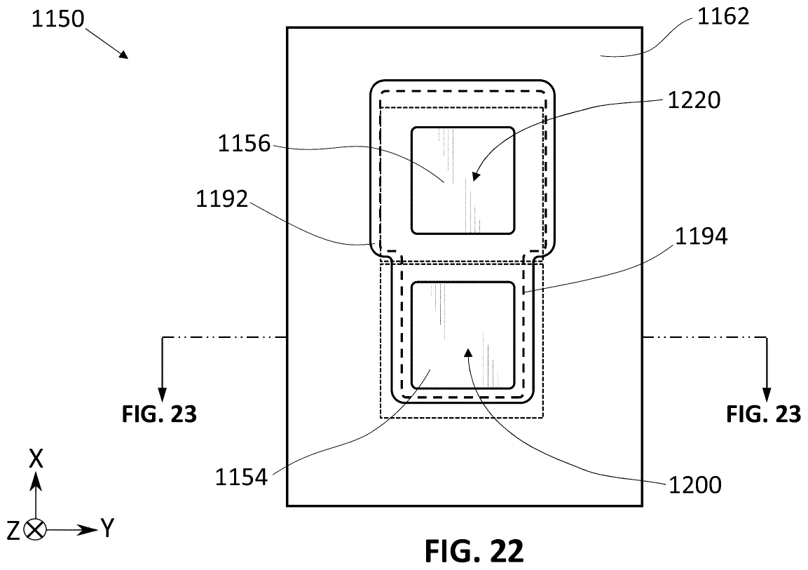

To facilitate alignment between the stator support 1192 and the main support 1162, the stator support 1192 may include alignment means for aligning the stator support 1192 with the main support 1162 when the stator support 1192 is attached to the main support 1162 and when attaching the stator support 1192 to the main support 1162. For example, as shown in FIGS. 19 and 22, the stator support 1192 has a shape which generally corresponds to a shape of the primary opening 1180 and the secondary opening 1184 (i.e., the stator support 1192 is complementary to the primary opening 1180 and the secondary opening 1184), and includes a marginal shoulder 1194 extending along a perimeter of the stator support 1192 and sized to engage with an edge 1196 of the primary opening 1180 and with an edge 1198 of the secondary opening 1184. As such, as the stator support 1192 is attached to the main support 1162, the marginal shoulder 1194 may engage the edges 1196 and 1198 and may thus serve as an alignment means for aligning the stator support 1192 with the main support 1162.

To facilitate alignment between the stators in the stator chamber 1168 and the stator support 1192, the main support 1162 may include stator alignment means for aligning, for example, the stator 1154 with the stator support 1192 at least when the stator support 1192 is attached to the main support 1162. For example, the structural members 1170 and 1172 may serve as such stator alignment means for aligning the stator 1154 with the stator support 1192.

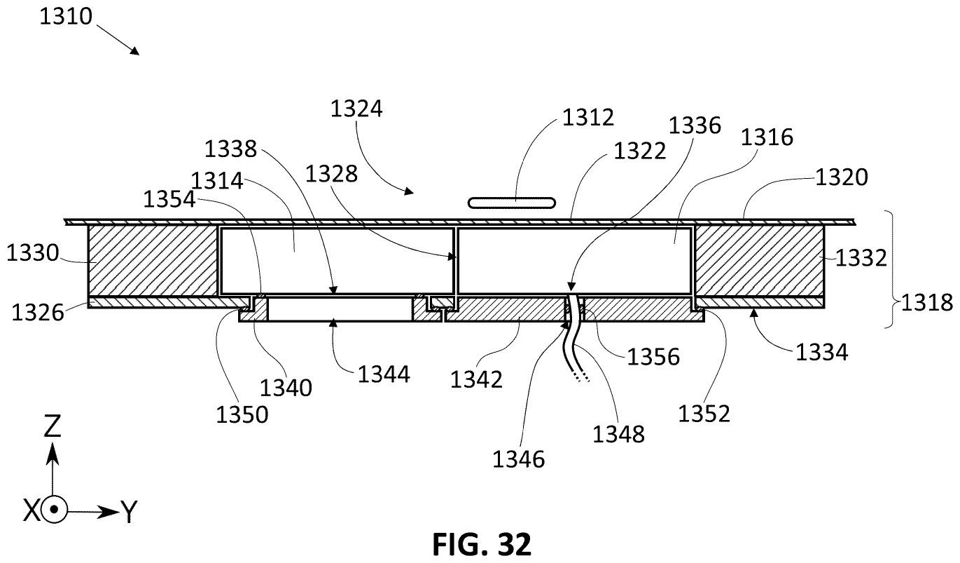

Still referring to FIGS. 19, 22, and 23, in the embodiment shown, the stator support 1192 includes stator support openings 1200 and 1202 which may provide access to the stator chamber 1168 and/or to the stators 1154 and 1156 inside the stator chamber 1168 even when the stator support 1192 is attached to the main support 1162 to secure the primary opening 1176. The stator support 1192 thus covers portions of the primary opening 1176 and of the secondary opening 1178. Each of the stator support openings 1200 and 1202 is dimensioned to prevent the stators 1154 and 1156 from passing therethrough. The stator support openings 1200 and 1202 may be used, for example, to pass wires, cables, and/or other conduits through from outside the stator chamber 1168 to inside the stator chamber 1168 to connect the stators 1154 and 1156 to one or more devices outside of the stator chamber 1168 (e.g., a power source, the controller). See FIG. 32 below for a more specific example. In the embodiment shown, each of the stator support openings 1200 and 1202 is fully enclosed (i.e., surrounded) by the stator support 1192 within a plane parallel to the working surface 1166. However, in alternative embodiments, the stator support 1192 may include at least one stator support opening which is not thus fully enclosed by the stator support 1192 and is instead open along at least a portion of its perimeter.

Referring to FIG. 23, in the embodiment shown, the stator mounting apparatus 1158 also includes seals 1204 and 1206 between the stator support 1192 and the main support 1162, and between the stator support 1192 and one or more of the stators 1154 and 1156. These seals provide one or more of an airtight seal and a liquid-tight seal between the stator support 1192 and either the main support 1162 or the stators 1154 and 1156 when the stator support 1192 is attached to the main support 1162. Each of the seals 1204 and 1206 may be or may include, for example, one or more of an O-ring, a gasket, and an adhesive. The seals 1204 and 1206 may, for example, mitigate any potential pathways for fluid exchange or cross-contamination between the stator chamber 1168 and external environments (e.g., the external side 1174 of the main support 1162). Of course, the embodiment shown is an example only, and alternative embodiments may differ. For example, some alternative embodiments may not include any seals between the stator support 1192 and the main support 1162, and/or between the stator support 1192 and the stators 1154 and 1156.

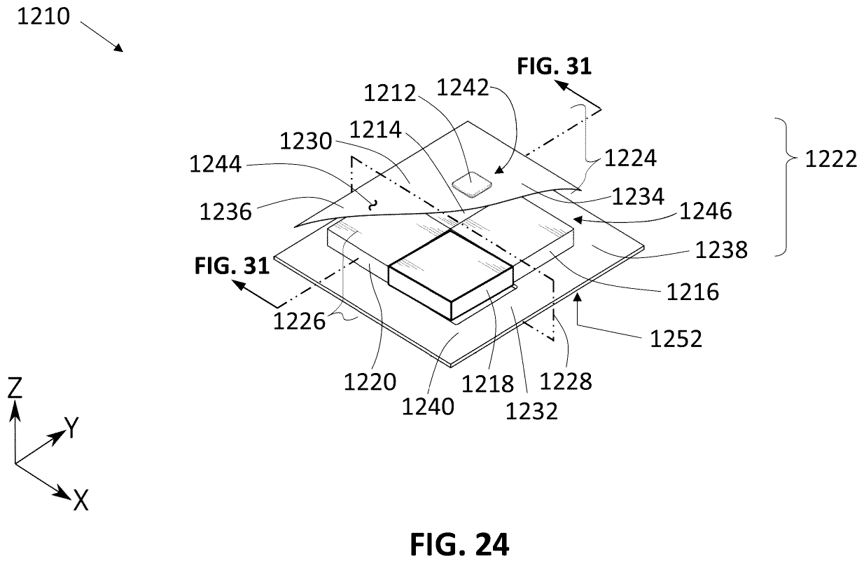

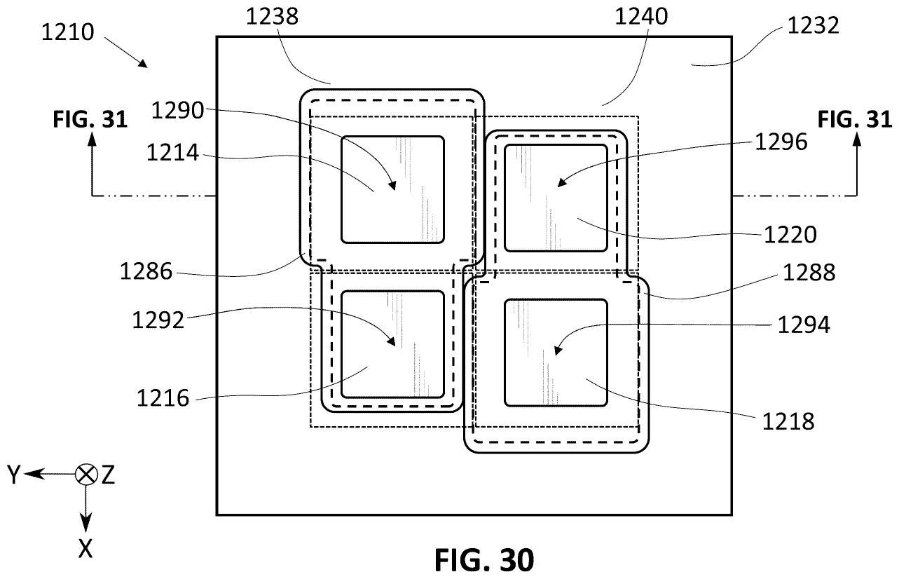

Referring now to FIGS. 24 to 31, a magnetic displacement system according to another embodiment is shown generally at 1210 and includes a mover 1212, stators 1214, 1216, 1218, and 1220, a stator mounting system 1222, and a controller (not shown). The mover 1212 includes one or more magnets (not shown) and may be similar to the mover 1102 of the embodiment of FIG. 17 and/or to the mover 1152 of the embodiment of FIGS. 18 to 23. Each of the stators 1214, 1216, 1218, and 1220 includes one or more electrical conductors (not shown) and an amplifier (not shown) and may be similar to the stator 1104 of the embodiment of FIG. 17 and/or to the stators 1154 and 1156 of the embodiment of FIGS. 18 to 23. Likewise, the controller of the embodiment of FIGS. 24 to 31 may be similar to the controller 1106 of the embodiment of FIG. 17.

The stator mounting system 1222 includes two stator mounting apparatuses 1224 and 1226 positioned in adjacent succession. That is, the stator mounting apparatuses 1224 and 1226 are arranged next to each other in an ordered sequence. More specifically, as shown in FIG. 24, the stator mounting apparatuses 1224 and 1226 are positioned on either side of a plane 1228. Each of the stator mounting apparatuses 1224 and 1226 is generally similar to the stator mounting apparatus 1158 of the embodiment of FIGS. 18 to 23. The stator mounting system 1222 also includes a single unitary cover 1230 and a single unitary main support 1232. The unitary cover 1230 includes a cover portion 1234, which provides a cover for the stator mounting apparatus 1224, and a cover portion 1236, which provides a cover for the stator mounting apparatus 1226. Similarly, the unitary main support 1232 includes a main support portion 1238, which provides a main support for the stator mounting apparatus 1224, and a main support portion 1240, which provides a main support for the stator mounting apparatus 1226. Of course, the stator mounting system 1222 of the embodiment shown is an example only, and alternative embodiments may differ. For example, some alternative embodiments may include a stator mounting system made up of more than two stator mounting apparatuses. In some alternative embodiments, the stator mounting system may not include a unitary main support and/or a unitary cover, and may instead have individual main supports and/or individual covers for each stator mounting apparatus.

The unitary cover 1230 of the embodiment shown is generally similar to the cover 1120 of the embodiment of FIG. 17 and to the cover 1160 of the embodiment of FIGS. 18 to 23. That is, the unitary cover 1230 overlays the stators 1214, 1216, 1218, and 1220 and functions as a barrier between the stators 1214, 1216, 1218, and 1220 and an operating environment of the mover 1212, shown generally at 1242. Further, like the covers 1120 and 1160 of the embodiments of FIG. 17 and of FIGS. 18 to 23, the unitary cover 1230 includes and thus supports a working surface 1244 for the mover 1212 to move upon and upon which the mover 1212 may be controlled by the stators 1214, 1216, 1218, and 1220.

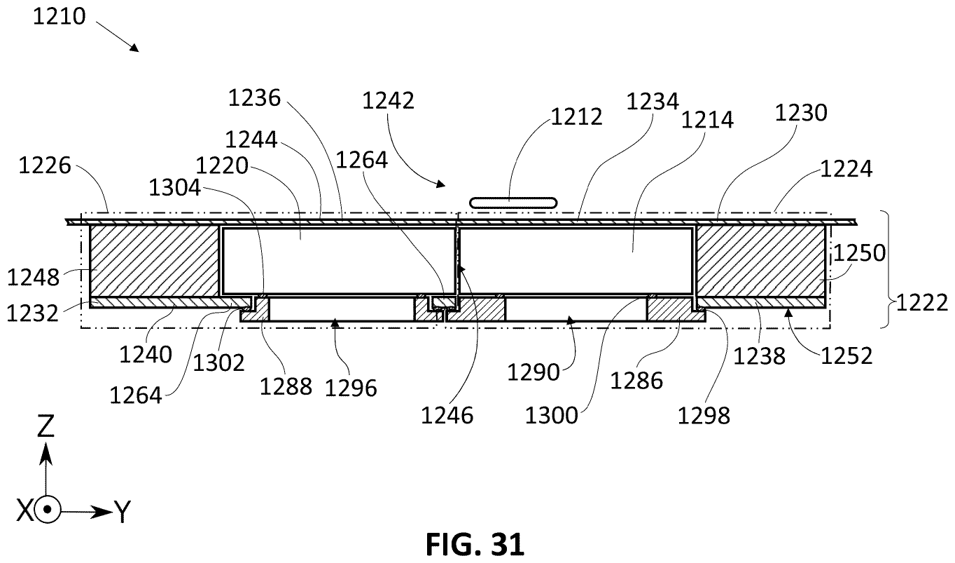

The unitary main support 1232 of the embodiment shown is generally similar to the main support 1162 of the embodiment of FIGS. 18 to 23. That is, the unitary main support 1232 provides a mounting platform for supporting the stators 1214, 1216, 1218, and 1220 relative to the unitary cover 1230 and thus the working surface 1244 at least during operation. As in the embodiment of FIGS. 18 to 23, the unitary main support 1232 is spaced apart from the unitary cover 1230 such that the unitary cover 1230 and the unitary main support 1232 define between them a stator chamber, shown generally at 1246, and the stator chamber 1246 is dimensioned to accommodate the stators 1214, 1216, 1218, and 1220 such that the stators 1214, 1216, 1218, and 1220 may be supported relative to the working surface 1244 in the stator chamber 1246. In the embodiment shown, the unitary cover 1230 and the unitary main support 1232 are supported to be spaced apart from each other by structural members 1248 and 1250 of the stator mounting system 1222 extending between the unitary cover 1230 and the unitary main support 1232 (see FIG. 31).

Also as in the embodiment of FIGS. 18 to 23, the unitary cover 1230 and the unitary main support 1232 may be sealed together, directly and/or indirectly. For example, the unitary cover 1230 may be sealed to the structural members 1248 and 1250, which may in turn be sealed to the unitary main support 1232. In such embodiments, sealing between the unitary cover 1230 and the unitary main support 1232 may provide one or more of an airtight seal and a liquid-tight seal between the unitary cover 1230 and the unitary main support 1232. Additionally, like the main support 1162 in the embodiment of FIGS. 18 to 23, the unitary main support 1232 in the embodiment shown in FIGS. 24 to 31 has the form of a mounting plate, but in alternative embodiments may have a different shape. In some embodiments, the unitary cover may also be sealed to one or more other structures to form a closed volume, for example, above the working surface 1244 and/or around the operating environment 1242.

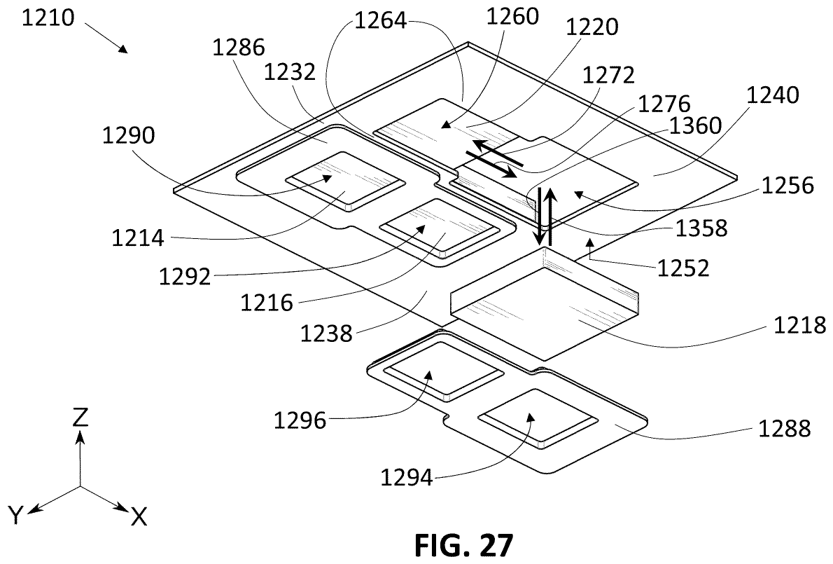

An external side 1252 of the unitary main support 1232 faces away from the stator chamber 1246 and thus away from the unitary cover 1230 and thus away from the working surface 1244. Referring to FIG. 27, the external side 1252 of the unitary main support 1232 is therefore accessible from a side of the stator mounting system 1222 which is away from the working surface 1244. The unitary main support 1232 defines primary openings 1254 and 1256 and secondary openings 1258 and 1260. More specifically, the main support portion 1238 defines the primary opening 1254 and the secondary opening 1258, while the main support portion 1240 defines the primary opening 1256 and the secondary opening 1260.

As in the embodiment of FIGS. 18 to 23, each of the primary openings 1254 and 1256 is dimensioned to receive therethrough one of the stators 1214, 1216, 1218, and 1220, thus allowing the stators 1214, 1216, 1218, and 1220 to be inserted into and removed from the stator chamber 1246 through the primary openings 1254 and 1256 from/to the external side 1252 of the unitary main support 1232. Likewise, each of the secondary openings 1258 and 1260 is generally dimensioned to prevent the stators 1214, 1216, 1218, and 1220 from passing therethrough, at least when the stators 1214, 1216, 1218, and 1220 are in the mounting orientation. Also as in the embodiment of FIGS. 18 to 23, the primary and secondary openings within each of the stator mounting apparatuses 1224 and 1226 are continuous with one another. That is, the secondary opening 1258 is continuous with the primary opening 1254, and the secondary opening 1260 is continuous with the primary opening 1256.

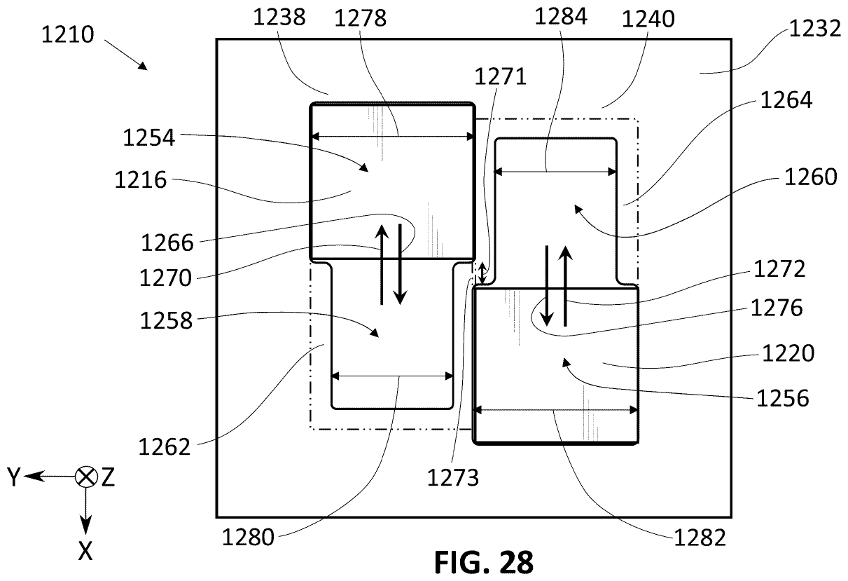

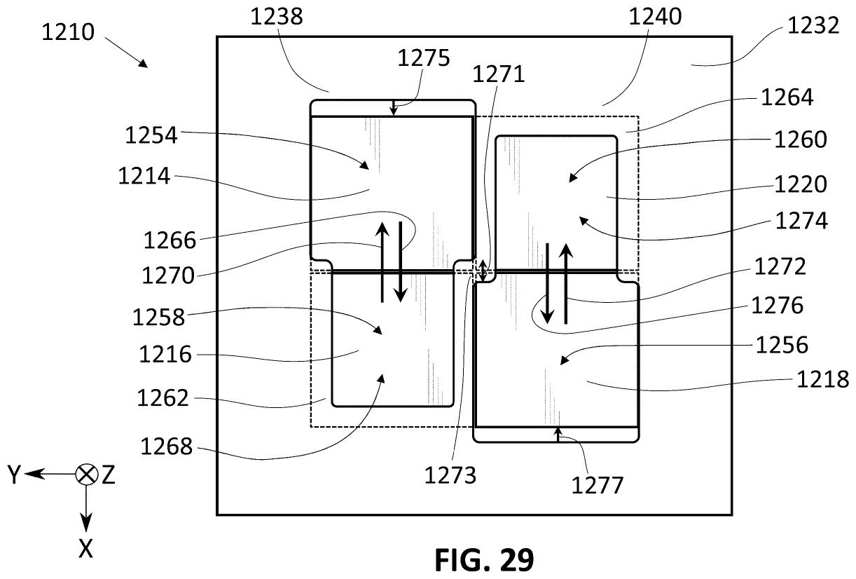

Referring to FIG. 28, the main support portion 1238 of the unitary main support 1232 includes a support portion 1262 adjacent the primary opening 1254 and the secondary opening 1258 (see FIG. 28). Similarly, the main support portion 1240 of the unitary main support 1232 includes a support portion 1264 adjacent the primary opening 1256 and the secondary opening 1260. Like the support portion 1180 in the embodiment of FIGS. 18 to 23, the support portions 1262 and 1264 serve to support one or more of the stators 1214, 1216, 1218, and 1220 inside the stator chamber 1246. In the embodiment shown, the support portion 1262 is depicted as supporting at least the stator 1216, and the support portion 1264 is depicted as supporting at least the stator 1220. Referring to FIGS. 28 and 29, when the stator 1216 has been inserted into the stator chamber 1246 through the primary opening 1254 from the external side 1252 of the unitary main support 1232, the stator 1216 may be moved in a mounting direction 1266 to a mounting position 1268 on the support portion 1262 in which the stator 1216 is supported by the support portion 1262. From the mounting position 1268, the stator 1216 may be moved, in a dismounting direction 1270 opposite to the mounting direction 1266, to the primary opening 1254 such that the stator 1216 may be removed from the stator chamber 1246 through the primary opening 1254 to the external side 1252 of the unitary main support 1232.

Likewise, when the stator 1220 has been inserted into the stator chamber 1246 through the primary opening 1256 from the external side 1252 of the unitary main support 1232, the stator 1220 may be moved in a mounting direction 1272 to a mounting position 1274 on the support portion 1264 in which the stator 1220 is supported by the support portion 1264. From the mounting position 1274, the stator 1220 may be moved, in a dismounting direction 1276 opposite to the mounting direction 1272, to the primary opening 1256 such that the stator 1220 may be removed from the stator chamber 1246 through the primary opening 1256 to the external side 1252 of the unitary main support 1232. As in the embodiment of FIGS. 18 to 23, each of the mounting directions 1266 and 1272 and the dismounting directions 1270 and 1276 is parallel to the working surface 1244.

Referring to FIGS. 27 to 29, in the embodiment shown, the stator mounting apparatus 1224 has an orientation opposite to an orientation of the adjacent stator mounting apparatus 1226. That is, for example, the mounting direction 1266 of the stator mounting apparatus 1224 is antiparallel to the mounting direction 1272 of the stator mounting apparatus 1226, and the dismounting direction 1270 of the stator mounting apparatus 1224 is antiparallel to the dismounting direction 1276 of the stator mounting apparatus 1226. However, alternative embodiments may vary. For example, in some alternative embodiments, adjacent stator mounting apparatuses may have the same orientation. In some alternative embodiments, adjacent stator mounting apparatuses may have orientations which are perpendicular to each other within a plane parallel to the working surface 1244. More generally, in some alternative embodiments, adjacent stator mounting apparatuses may have orientations which are non-parallel to each other within a plane parallel to the working surface 1244. In some alternative embodiments with more than two stator mounting apparatuses, adjacent stator mounting apparatuses may have orientations that alternate in a repeating sequential pattern within a plane parallel to the working surface 1244.

In general, in some embodiments which include more than one stator mounting apparatus, primary openings of adjacent stator mounting apparatuses may be non-adjacent, including non-diagonally adjacent. In the embodiment shown in FIGS. 24 to 31, the primary opening 1254 of the stator mounting apparatus 1224 is generally diagonally adjacent the primary opening 1256 of the stator mounting apparatus 1226. As shown, for example, in FIGS. 27 and 28, in order to avoid continuity between the primary opening 1254 and the primary opening 1256, the primary opening 1254 is offset from the primary opening 1256 by an offset distance 1271 in the X-direction. As such, the unitary main support 1232 includes a portion 1273 separating the primary opening 1254 from the primary opening 1256. Because of the offset between the primary opening 1254 and the primary opening 1256, when the stator 1214 is inserted through the primary opening 1254 into the stator chamber 1246, it must be moved an offset distance 1275 in the +X-direction in order to be aligned with the stator 1220 in the X-direction. Likewise, when the stator 1218 is inserted through the primary opening 1256 into the stator chamber 1246, it must be moved an offset distance 1277 in the −X-direction in order to be aligned with the stator 1220 in the X-direction. Such an offset between primary openings of adjacent stator mounting apparatuses may not be necessary in embodiments where the primary openings are non-adjacent. For example, in embodiments where adjacent stator mounting apparatuses have opposite orientations, as in the embodiment shown in FIGS. 24 to 31, such an offset may by avoided if each of the stator mounting apparatuses holds three or more stators, rather the two stators held by each of the stator mounting apparatuses 1224 and 1226 (i.e., the stators 1214 and 1216, and the stators 1218 and 1220, respectively).

As shown in FIG. 28, the primary opening 1254 has a primary width 1278 perpendicular to the mounting direction 1266 (and thus to the dismounting direction 1270), and the secondary opening 1258 has a secondary width 1280 perpendicular to the mounting direction 1266 (and thus to the dismounting direction 1270). Similarly, the primary opening 1256 has a primary width 1282 perpendicular to the mounting direction 1272 (and thus to the dismounting direction 1276), and the secondary opening 1260 has a secondary width 1284 perpendicular to the mounting direction 1272 (and thus to the dismounting direction 1276). As in the embodiment of FIGS. 18 to 23, the secondary width 1280 is less than the primary width 1278 and the secondary width 1284 is less than the primary width 1282, and, therefore, the stators 1214, 1216, 1218, and 1220 may be able to pass through the primary openings 1254 and 1256 but not through the secondary openings 1258 and 1260.

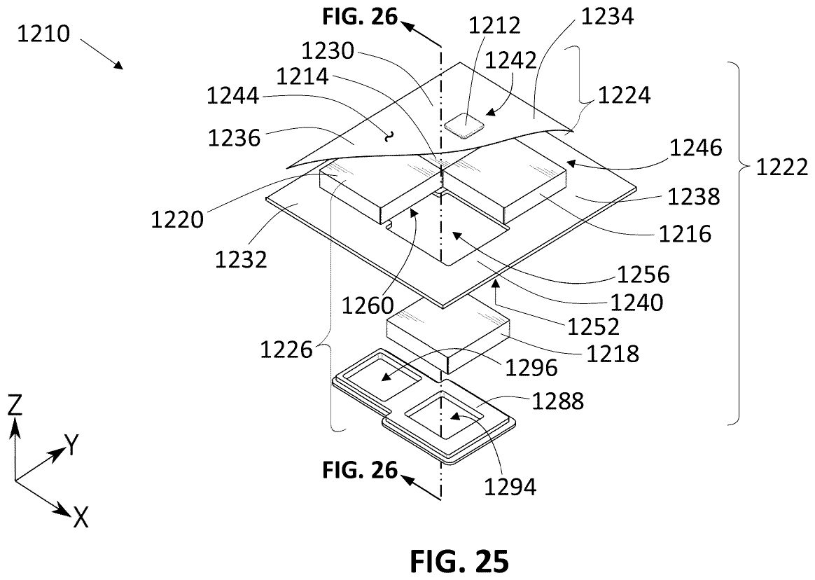

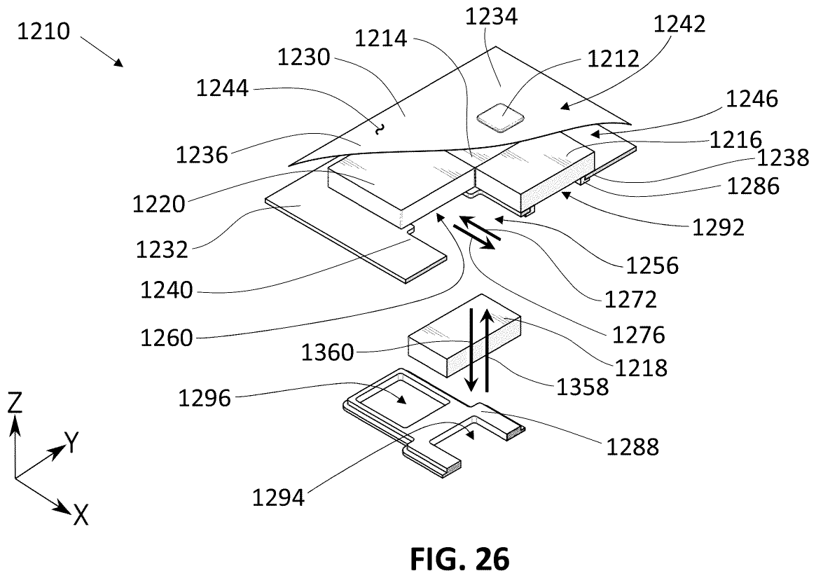

Like the stator mounting apparatus 1158 of the embodiment of FIGS. 18 to 23, referring to FIG. 25, each of the stator mounting apparatuses 1224 and 1226 of the stator mounting system 1222 includes a stator support which is releasably attachable to the unitary main support 1232. Referring to FIG. 26, more specifically, the stator mounting apparatus 1224 includes a stator support 1286, which is releasably attachable to the main support portion 1238 of the unitary main support 1232 around at least the primary opening 1254 to support one or more of the stators 1214, 1216, 1218, and 1220 in the primary opening 1254. Similarly, the stator mounting apparatus 1226 includes a stator support 1288 which is releasably attachable to the main support portion 1240 of the unitary main support 1232 around at least the primary opening 1256 to support one or more of the stators 1214, 1216, 1218, and 1220 in the primary opening 1256. In general, the stator supports 1286 and 1288 are similar to the stator support 1192 of the embodiment of FIGS. 18 to 23, and may be used to releasably secure the primary openings 1254 and 1256, respectively, to prevent any of the stators 1214, 1216, 1218, and 1220 from passing through the primary openings 1254 and 1256. As depicted in FIGS. 24 to 31, when the stator supports 1286 and 1288 are attached to the unitary main support 1232 to secure the primary openings 1254 and 1256, the stator support 1286 covers at least a portion of the primary opening 1254 and at least a portion of the secondary opening 1258 and supports at least the stator 1214 in the primary opening 1254, and the stator support 1288 covers at least a portion of the primary opening 1256 and at least a portion of the secondary opening 1260 and supports at least the stator 1218 in the primary opening 1256. Like the stator support 1192 of the embodiment of FIGS. 18 to 23, each of the stator supports 1286 and 1288 includes stator support openings which may provide access to the stator chamber 1246 and/or to the stators 1214, 1216, 1218, and 1220 inside the stator chamber 1246 even when the stator supports 1286 and 1288 are attached to the unitary main support 1232 to secure the primary openings 1254 and 1256. More specifically, the stator support 1286 includes stator support openings 1290 and 1292 which provide access to the stators 1214 and 1216, respectively, when the stator support 1286 is attached to the unitary main support 1232 to secure the primary opening 1254 and thus covers portions of the primary opening 1254 and the secondary opening 1258, and the stator support 1288 includes stator support openings 1294 and 1296 which provide access to the stators 1218 and 1220, respectively, when the stator support 1286 is attached to the unitary main support 1232 to secure the primary opening 1256 and thus covers portions of the primary opening 1256 and the secondary opening 1260. Each of the stator support openings 1290, 1292, 1294, and 1296 is dimensioned to prevent the stators 1214, 1216, 1218, and 1220 from passing therethrough.

Referring to FIG. 31, like the stator mounting apparatus 1158 of the embodiment of FIGS. 18 to 23, each of the stator mounting apparatuses 1224 and 1226 of the stator mounting system 1222 includes seals 1298, 1300, 1302, and 1304 for providing airtight and/or liquid-tight sealing between the stator supports 1286 and 1288 and the unitary main support 1232, and between the stator supports 1286 and 1288 and one or more of the stators 1214, 1216, 1218, and 1220. Each of the seals 1298, 1300, 1302, and 1304 may generally be similar to the seals 1204 and 1206 of the embodiment of FIGS. 18 to 23.

Referring now to FIG. 32, a magnetic displacement system according to another embodiment is shown generally at 1310 and includes a mover 1312, a plurality of stators including stators 1314 and 1316, a stator mounting system 1318, and a controller (not shown). The mover 1312 includes one or more magnets (not shown) and may be similar to the mover 1102 of the embodiment of FIG. 17, to the mover 1152 of the embodiment of FIGS. 18 to 23, and/or to the mover 1212 of the embodiment of FIGS. 24 to 31. Each of the plurality of stators, including the stators 1314 and 1316, includes one or more electrical conductors (not shown) and an amplifier (not shown) and may be similar to the stator 1104 of the embodiment of FIG. 17, to the stators 1154 and 1156 of the embodiment of FIGS. 18 to 23, and/or to the stators 1214, 1216, 1218, and 1220 of the embodiment of FIGS. 24 to 31. Likewise, the controller of the embodiment of FIGS. 24 to 31 may be similar to the controller 1106 of the embodiment of FIG. 17.

In general, the stator mounting system 1318 shown in FIG. 32 is similar to the stator mounting system 1222 of the embodiment of FIGS. 24 to 31. That is, the stator mounting system 1318 includes a unitary cover 1320 which includes and supports a working surface 1322 and which generally forms a barrier between the stators 1314 and 1316 and an operating environment of the mover 1312, shown generally at 1324. The stator mounting system 1318 also includes a unitary main support 1326 which provides a mounting platform for supporting the stators 1314 and 1316 relative to the unitary cover 1320 and which is spaced apart from the unitary cover 1320 to define a stator chamber, shown generally at 1328, which is dimensioned to accommodate the stators 1314 and 1316. The unitary cover 1320 and the unitary main support 1326 are spaced apart from each other by structural members 1330 and 1332. An external side 1334 of the unitary main support 1326 faces away from the stator chamber 1328 and thus away from the unitary cover 1320 and thus away from the working surface 1322, such that the external side 1334 is accessible from a side of the stator mounting system 1318 which is away from the working surface 1322.

As in the embodiment of FIGS. 24 to 31, the unitary main support 1326 shown in FIG. 32 defines primary openings and secondary openings between the stator chamber 1328 and the external side 1334 of the unitary main support 1326. For example, as shown in FIG. 32, the unitary main support 1326 defines a primary opening 1336, which is dimensioned to receive therethrough one of the plurality of stators, such as the stator 1316, and a secondary opening 1338, which is generally dimensioned to prevent the stators from passing therethrough.

Also as in the embodiment of FIGS. 24 to 31, the stator mounting system 1318 shown in FIG. 32 includes stator supports 1340 and 1342 which are releasably attachable to the unitary main support 1326. The stator support 1340 is generally similar to the stator supports 1286 and 1288 of the embodiment of FIGS. 24 to 31, and, in the embodiment shown in FIG. 32, covers at least a portion of the secondary opening 1338 when attached to the unitary main support 1326. The stator support 1340 also defines a stator support opening shown generally at 1344, which may provide access to the stator chamber 1328 and to the stator 1314 inside the stator chamber 1328 even when the stator support 1340 is attached to the unitary main support 1326. The stator support 1342 covers at least a portion of the primary opening 1336 and supports the stator 1316 in the primary opening 1336 when attached to the unitary main support 1326. The stator support 1342 defines a stator support opening 1346 which is dimensioned to receive therethrough a utility service conduit 1348 associated with at least the stator 1316. In some embodiments, the utility service conduit 1348 may be connectable to, for example, the stator 1316. In some embodiments, the utility service conduit 1348 may carry communications between the stator 1316 and a remote device, such as the controller. In some embodiments, the utility service conduit 1348 may carry electrical power to the stator 1316.

Like the stator mounting system 1222 of the embodiment of FIGS. 24 to 31, the stator mounting system 1318 shown in FIG. 32 includes seals for providing airtight and/or liquid-tight sealing when the stator supports 1340 and 1342 are attached to the unitary main support 1326. For example, as shown in FIG. 32, the stator mounting system 1318 includes a seal 1350 between the stator support 1340 and the unitary main support 1326, a seal 1352 between the stator support 1342 and the unitary main support 1326, and a seal 1354 between the stator support 1340 and the stator 1314. Additionally, the stator mounting system 1318 includes a seal 1356 for providing an airtight and/or liquid-tight seal between the stator support 1342 and the utility service conduit 1348 when the utility service conduit 1348 is received through the stator support opening 1346. Each of the seals 1350, 1352, 1345, and 1356 may generally be similar to the seals 1204 and 1206 of the embodiment of FIGS. 18 to 23 and/or to the seals 1298, 1300, 1302, and 1304 of the embodiment of FIGS. 24 to 31.

In general, a stator may be installed into or removed from the magnetic displacement system 1150, the magnetic displacement system 1210, or the magnetic displacement system 1310 by, at least, passing the stator through a primary opening in a main support of the respective magnetic displacement system. For example, with reference to the magnetic displacement system 1210 shown in FIGS. 24 to 31, the stators 1218 and 1220 may be installed onto the stator mounting apparatus 1226 by first inserting the stator 1220 into the stator chamber 1246 through the primary opening 1256 of the main support portion 1240 of the unitary main support 1232 from the external side 1252 of the unitary main support 1232, moving the stator 1220 in the mounting direction 1272 from the primary opening 1256 to the mounting position 1274 on the support portion 1264 of the main support portion 1240, and supporting the stator 1220 by the support portion 1264. As shown in FIGS. 26 and 27, the stator 1220 may be inserted into the stator chamber 1246 through the primary opening 1256 in an insertion direction 1358 perpendicular to the working surface 1244. The stator 1220 may be moved in the mounting direction 1272 from the primary opening 1256 to the mounting position 1274 by accessing the stator 1220, from the external side 1252, through the primary opening 1256 and/or the secondary opening 1260. Installation of the stator 1220 may further include orienting the stator 1220 in the mounting orientation prior to insertion through the primary opening 1256. Once the stator 1220 has been inserted into the stator chamber 1246 and moved to the mounting position 1274, the stator 1218 may also be inserted into the stator chamber 1246 (e.g., in the insertion direction 1258) through the primary opening 1256 from the external side 1252. The stator support 1288 may then be attached to the main support portion 1240 of the unitary main support 1232 to support the stator 1218 in the primary opening 1256. In some embodiments, attaching the stator support 1288 to the main support portion 1240 may involve sealing the stator support 1288 to the main support portion 1240 (e.g., using the seal 1302) to provide at least one of an airtight seal and a liquid-tight seal between the main support portion 1240 and the stator support 1288. In some embodiments which include one or more utility service conduits, such as the utility service conduit 1348 of the magnetic displacement system 1310 shown in FIG. 32, stator installation may also include inserting a utility service conduit through a stator support opening in a stator support and connecting the utility service conduit to the stator.

Similarly, the stators 1218 and 1220 may be removed from the stator mounting apparatus 1226 by first detaching the stator support 1288 from the main support portion 1240 of the unitary main support 1232. In some embodiments, detachment of the stator support 1288 may include breaking an airtight and/or liquid-tight seal between the main support portion 1240 and the stator support. Once the stator support 1288 has been detached, the stator 1218 may be accessed from the external side 1252 of the unitary main support 1232 to remove the stator 1218 from the stator chamber 1246 by passing the stator 1218 through the primary opening 1256 to the external side 1252. Once the stator 1218 has been removed, the stator 1220 may also be accessed from the external side 1252 of the unitary main support 1232 to move the stator 1220 in the dismounting direction 1276 from the mounting position 1274 to the primary opening 1256, and then to remove the stator 1220 from the stator chamber 1246 by passing the stator 1220 through the primary opening 1256 to the external side 1252. As shown in FIGS. 26 and 27, the stators 1218 and 1220 may be removed from the stator chamber 1246 through the primary opening 1256 in a removal direction 1360 opposite to the insertion direction 1358 and thus also perpendicular to the working surface 1244. The stators 1218 and 1220 may be accessed from the external side 1252 of the unitary main support 1232 through the primary opening 1256 and/or the secondary opening 1260. Removal of each of the stators 1218 (or 1220) may involve maintaining the stator 1218 (or 1220) in the mounting orientation when passing the stator 1218 (or 1220) through the primary opening 1256 to the external side 1252.

The magnetic displacement systems of the embodiments shown are examples only, and alternative embodiments may differ. For example, in the embodiments of FIGS. 18 to 31, each stator mounting apparatus (i.e., the stator mounting apparatuses 1158, 1224, and 1226) is shown supporting up to two stators (i.e., the stators 1154 and 1156, the stators 1214 and 1216, and the stators 1218 and 1220, respectively). However, some alternative embodiments may include stator mounting apparatuses which may support only a single stator, while other alternative embodiments may include stator mounting apparatuses which may support three or more stators.

Additionally, some alternative embodiments may include a main support having more than one support portion adjacent a given primary opening, such that stators may be inserted into the stator chamber through the primary opening and moved in more than one mounting direction. For example, in some such embodiments, the main support may include two support portions adjacent to and on opposing sides of a central primary opening, such that a stator may be inserted into the stator chamber through the central primary opening and moved in a first mounting direction onto a first support portion or in a second mounting direction opposite to the first mounting direction onto a second support portion. In other such embodiments, the main support may include four support portions adjacent to a central primary opening and arranged at 90° intervals around the central primary opening, such that there are four possible mounting directions for a stator inserted into the stator chamber through the central primary opening. In yet other such embodiments, the main support may include eight support portions adjacent to a central primary opening and arranged at 45° intervals around the central primary opening, such that there are eight possible mounting directions for a stator inserted into the stator chamber through the central primary opening.

In general, embodiments such as those described herein may be used in the automation of various processes where components need to be transported, sorted, weighed, or packaged, for example. Embodiments such as those described herein may also be used in the automation of processes where a permanent working surface is required in combination with serviceability. Therefore, displacement systems such as those described herein may function as assembly systems or as other systems for packaging, transferring, printing, inspecting, analyzing, or filling, for example.

### CLAUSES

This disclosure includes but is not limited to the following clauses, which may be combined with other subject matter in this specification.

1. A method of releasably attaching a cover to a stator of a displacement system, the stator comprising at least one conductor positioned to generate at least one external magnetic field operable to move at least one mover of the displacement system, the method comprising: causing a bonding layer to adhere to the stator; and causing the bonding layer to adhere to the cover.
2. The method of clause 1 wherein causing the bonding layer to adhere to the stator comprises causing the bonding layer to adhere to the stator with the bonding layer between the cover and the stator.
3. The method of clause 1 or 2 wherein causing the bonding layer to adhere to the cover comprises causing the bonding layer to adhere to the cover with the bonding layer between the cover and the stator.
4. The method of clause 1, 2, or 3 further comprising placing the cover on the stator with the bonding layer between the cover and the stator.
5. The method of any one of clauses 1 to 4 wherein the cover comprises a working surface, the working surface configured to be between the at least one mover and the stator when the cover is attached to the stator and when the at least one mover is moving in response to the at least one external magnetic field.
6. The method of any one of clauses 1 to 5 wherein causing the bonding layer to adhere to the stator comprises causing the bonding layer to adhere to a cover-facing surface of the stator, the cover-facing surface configured to be across the bonding layer from the cover when the cover is attached to the stator.
7. The method of clause 6 wherein causing the bonding layer to adhere to the stator comprises causing the bonding layer to adhere to at least 50 percent of the cover-facing surface of the stator.
8. The method of clause 6 or 7 wherein causing the bonding layer to adhere to the stator comprises causing the bonding layer to adhere to substantially all or all of the cover-facing surface of the stator.
9. The method of any one of clauses 1 to 8 wherein causing the bonding layer to adhere to the cover comprises causing the bonding layer to adhere to a stator-facing surface of the cover, the stator-facing surface configured to be across the bonding layer from the stator when the cover is attached to the stator.
10. The method of clause 9 wherein causing the bonding layer to adhere to the cover comprises causing the bonding layer to adhere to at least 50 percent of the stator-facing surface of the cover.
11. The method of clause 9 or 10 wherein causing the bonding layer to adhere to the cover comprises causing the bonding layer to adhere to substantially all or all of the stator-facing surface of the cover.
12. The method of any one of clauses 1 to 11 wherein at least a portion of the cover generally conforms to at least a portion of the stator.
13. The method of clause 12, when directly or indirectly dependent from clause 6 and clause 9, wherein at least a portion of the stator-facing surface of the cover generally conforms to at least a portion of the cover-facing surface of the stator.
14. The method of clause 13 wherein substantially all or all of the stator-facing surface of the cover generally conforms to substantially all or all of the cover-facing surface of the stator.
15. The method of any one of clauses 1 to 14 wherein the bonding layer is homogeneous.
16. The method of any one of clauses 1 to 14 wherein the bonding layer is heterogeneous.
17. The method of clause 16 wherein the bonding layer comprises a plurality of constituent layers.
18. The method of any one of clauses 1 to 17 wherein the bonding layer comprises a thermoplastic material having a melting temperature.
19. The method of clause 18 wherein the melting temperature of the thermoplastic material is at least 40° C.
20. The method of clause 18 or 19 wherein the melting temperature of the thermoplastic material is at least 60° C.
21. The method of clause 18, 19, or 20 wherein the melting temperature of the thermoplastic material is at least 80° C.
22. The method of any one of clauses 18 to 21 wherein the melting temperature of the thermoplastic material is at least 100° C.
23. The method of any one of clauses 18 to 21 wherein the melting temperature of the thermoplastic material is at most 100° C.
24. The method of clause 18, 19, or 20 wherein the melting temperature of the thermoplastic material is at most 80° C.
25. The method of clause 18 or 19 wherein the melting temperature of the thermoplastic material is at most 60° C.
26. The method of any one of clauses 18 to 25 wherein causing the bonding layer to adhere to the stator comprises heating the thermoplastic material to at least the melting temperature of the thermoplastic material.
27. The method of any one of clauses 18 to 26 wherein causing the bonding layer to adhere to the cover comprises heating the thermoplastic material to at least the melting temperature of the thermoplastic material.
28. The method of clause 26 or 27 wherein heating the thermoplastic material comprises driving current through the at least one conductor of the stator to generate heat for heating the thermoplastic material.
29. The method of clause 26, 27, or 28, when directly or indirectly dependent from clause 5, further comprising causing the at least one mover to move toward the stator and push against the working surface of the cover to force the cover toward the stator.
30. The method of any one of clauses 18 to 29 wherein the melting temperature of the thermoplastic material is higher than an operating temperature of the stator.
31. The method of any one of clauses 18 to 30 wherein the thermoplastic material comprises a hot-melt adhesive.
32. The method of clause 31 wherein the hot-melt adhesive comprises a low temperature hot glue.
33. The method of any one of clauses 18 to 32 wherein the thermoplastic material comprises a wax.
34. The method of clause 33 wherein the wax comprises a microcrystalline wax.
35. The method of clause 33 or 34 wherein the wax comprises a museum wax.
36. The method of any one of clauses 1 to 35 wherein the bonding layer comprises a lubricant.
37. The method of clause 36 wherein the lubricant comprises a grease.
38. The method of clause 37 wherein the grease comprises a silicone grease.
39. The method of any one of clauses 1 to 38 wherein the bonding layer comprises a solid film.
40. The method of clause 39 wherein the solid film comprises a polymer.
41. The method of clause 40 wherein the polymer comprises polyethylene terephthalate.
42. The method of clause 40 or 41 wherein the polymer comprises thermoplastic polyurethane.
43. The method of any one of clauses 39 to 42 wherein the solid film comprises a microsuction tape.
44. The method of clause 43 wherein causing the bonding layer to adhere to the stator comprises pressing the microsuction tape and the stator together.
45. The method of clause 43 or 44 wherein causing the bonding layer to adhere to the cover comprises pressing the microsuction tape and the cover together.
46. The method of any one of clauses 39 to 45 wherein causing the bonding layer to adhere to the stator comprises causing a first adhesive to adhere to the solid film and to the stator.
47. The method of clause 46 wherein the first adhesive comprises a silicone.
48. The method of any one of clauses 39 to 47 wherein causing the bonding layer to adhere to the cover comprises causing a second adhesive to adhere to the solid film and to the cover.
49. The method of clause 48 wherein the second adhesive comprises an epoxy.
50. The method of clause 48 or 49 wherein the second adhesive comprises a cyanoacrylate.
51. The method of clause 48, 49, or 50 when directly or indirectly dependent from clause 46, wherein adhesion between the second adhesive and the cover is stronger than adhesion between the first adhesive and the stator.
52. The method of clause 51, or of clause 48, 49, or 50 when directly or indirectly dependent from clause 46, wherein adhesion between the second adhesive and the solid film is stronger than adhesion between the first adhesive and the stator.
53. The method of clause 51 or 52, or of clause 48, 49, or 50 when directly or indirectly dependent from clause 46, wherein adhesion between the first adhesive and the solid film is stronger than adhesion between the first adhesive and the stator.
54. The method of any one of clauses 1 to 53 wherein the cover comprises a non-magnetic material.
55. The method of clause 54 wherein the non-magnetic material comprises a stainless steel.
56. The method of clause 55 wherein the non-magnetic material comprises an austenitic stainless steel.
57. The method of clause 54, 55, or 56 wherein the non-magnetic material comprises aluminum.
58. The method of any one of clauses 54 to 57 wherein the non-magnetic material comprises an aluminum alloy.
59. The method of any one of clauses 1 to 58 wherein the cover is at least 0.2 mm thick.
60. The method of any one of clauses 1 to 59 wherein the cover is at most 2 mm thick.
61. The method of any one of clauses 1 to 60 wherein the cover is about 0.5 mm thick.
62. The method of any one of clauses 1 to 61 wherein the stator defines a channel configured to receive a releasing body such that, when the channel receives the releasing body, the releasing body is positioned to detach the cover from the stator when withdrawn from the channel and drawn through the bonding layer.
63. The method of any one of clauses 1 to 61 further comprising, after attaching the cover to the stator, detaching the cover from the stator.
64. The method of clause 63 wherein detaching the cover from the stator comprises drawing a releasing body through the bonding layer.
65. A method of detaching a cover from a stator of a displacement system, the stator comprising at least one conductor positioned to generate at least one external magnetic field operable to move at least one mover of the displacement system, the cover attached to the stator by a bonding layer adhered to the stator and to the cover, the method comprising: drawing a releasing body through the bonding layer.
66. The method of clause 64 or 65 wherein the stator defines a channel configured to receive the releasing body.
67. The method of clause 66 wherein the channel releasably holds the releasing body when the cover is attached to the stator.
68. The method of clause 67 further comprising withdrawing the releasing body from the channel before drawing the releasing body through the bonding layer.
69. The method of any one of clauses 62 to 68 further comprising positioning the releasing body in the channel before drawing the releasing body through the bonding layer.
70. The method of clause 69, when directly or indirectly dependent from clause 63, wherein positioning the releasing body in the channel comprises positioning the releasing body in the channel before attaching the cover to the stator.
71. The method of clause 69, when directly or indirectly dependent from clause 63, wherein positioning the releasing body in the channel comprises positioning the releasing body in the channel after attaching the cover to the stator.
72. The method of clause 62 or of any one of clause 64 to 71 wherein the releasing body comprises a wire.
73. A stator device for a displacement system, the stator device comprising:
a stator comprising at least one conductor positioned to generate at least one external magnetic field operable to move at least one mover of the displacement system;
a cover; and
a bonding layer between the stator and the cover, the bonding layer adhered to the stator and to the cover.
   74. The stator device of clause 73 wherein the bonding layer is releasably adhered to the stator.
   75. The stator device of clause 73 or 74 wherein the bonding layer is releasably adhered to the cover.
   76. The stator device of clause 73, 74, or 75 wherein the cover comprises a working surface, the working surface configured to be between the at least one mover and the stator when the at least one mover is moving in response to the at least one external magnetic field.
   77. The stator device of any one of clauses 73 to 76 wherein the bonding layer is adhered to a cover-facing surface of the stator, the cover-facing surface across the bonding layer from the cover.
   78. The stator device of clause 77 wherein the bonding layer is adhered to at least 50 percent of the cover-facing surface of the stator.
   79. The stator device of clause 77 or 78 wherein the bonding layer is adhered to substantially all or all of the cover-facing surface of the stator.
   80. The stator device of any one of clauses 73 to 79 wherein the bonding layer is adhered to a stator-facing surface of the cover, the stator-facing surface across the bonding layer from the stator.
   81. The stator device of clause 80 wherein the bonding layer is adhered to at least 50 percent of the stator-facing surface of the cover.
   82. The stator device of clause 80 wherein the bonding layer is adhered to substantially all or all of the stator-facing surface of the cover.
   83. The stator device of any one of clauses 73 to 82 wherein at least a portion of the cover generally conforms to at least a portion of the stator.
   84. The stator device of clause 83, when directly or indirectly dependent from clause 77 and clause 80, wherein at least a portion of the stator-facing surface of the cover generally conforms to at least a portion of the cover-facing surface of the stator.
   85. The stator device of clause 84 wherein substantially all or all of the stator-facing surface of the cover generally conforms to substantially all or all of the cover-facing surface of the stator.
   86. A kit comprising:
a stator comprising at least one conductor positioned to generate at least one external magnetic field operable to move at least one mover of a displacement system;
a cover; and
a bonding layer adherable to the stator and to the cover when the bonding layer is between the stator and the cover.
   87. The kit of clause 86 wherein the bonding layer is releasably adherable to the stator.
   88. The kit of clause 86 or 87 wherein the bonding layer is releasably adherable to the cover.
   89. The kit of clause 86, 87, or 88 wherein the cover comprises a working surface, the working surface configured to be between the at least one mover and the stator when the cover is attached to the stator and when the at least one mover is moving in response to the at least one external magnetic field.
   90. The kit of any one of clauses 86 to 89 wherein at least a portion of the cover generally conforms to at least a portion of the stator.
   91. The kit of clause 90 wherein at least a portion of a stator-facing surface of the cover generally conforms to at least a portion of a cover-facing surface of the stator, the cover-facing surface configured to be across the bonding layer from the cover when the cover is attached to the stator, and the stator-facing surface configured to be across the bonding layer from the stator when the cover is attached to the stator.
   92. The kit of clause 91 wherein substantially all or all of the stator-facing surface of the cover generally conforms to substantially all or all of the cover-facing surface of the stator.
   93. The stator device of any one of clauses 73 to 85, or the kit of any one of clauses 86 to 92, wherein the bonding layer is homogeneous.
   94. The stator device of any one of clauses 73 to 85 or of clause 93, or the kit of any one of clauses 86 to 93, wherein the bonding layer is heterogeneous.
   95. The stator device or the kit of clause 94 wherein the bonding layer comprises a plurality of constituent layers.
   96. The stator device of any one of clauses 73 to 85 or of clause 93, 94, or 95, or the kit of any one of clauses 86 to 95, wherein the bonding layer comprises a thermoplastic material having a melting temperature.
   97. The stator device or the kit of clause 96 wherein the melting temperature of the thermoplastic material is at least 40° C.
   98. The stator device or the kit of clause 96 or 97 wherein the melting temperature of the thermoplastic material is at least 60° C.
   99. The stator device or the kit of clause 96, 97, or 98 wherein the melting temperature of the thermoplastic material is at least 80° C.
   100. The stator device or the kit of any one of clauses 96 to 99 wherein the melting temperature of the thermoplastic material is at least 100° C.
   101. The stator device or the kit of any one of clauses 96 to 99 wherein the melting temperature of the thermoplastic material is at most 100° C.
   102. The stator device or the kit of clause 96, 97, or 98 wherein the melting temperature of the thermoplastic material is at most 80° C.
   103. The stator device or the kit of clause 96 or 97 wherein the melting temperature of the thermoplastic material is at most 60° C.
   104. The stator device or the kit of any one of clauses 96 to 103 wherein the melting temperature of the thermoplastic material is higher than an operating temperature of the stator.
   105. The stator device or the kit of any one of clauses 96 to 104 wherein the thermoplastic material comprises a hot-melt adhesive.
   106. The stator device or the kit of clause 105 wherein the hot-melt adhesive comprises a low temperature hot glue.
   107. The stator device or the kit of any one of clauses 96 to 106 wherein the thermoplastic material comprises a wax.
   108. The stator device or the kit of clause 107 wherein the wax comprises a microcrystalline wax.
   109. The stator device or the kit of clause 107 or 108 wherein the wax comprises a museum wax.
   110. The stator device of any one of clauses 73 to 85 or of any one of clauses 93 to 109, or the kit of any one of clauses 86 to 109, wherein the bonding layer comprises a lubricant.
   111. The stator device or the kit of clause 110 wherein the lubricant comprises a grease.
   112. The stator device or the kit of clause 111 wherein the grease comprises a silicone grease.
   113. The stator device of any one of clauses 73 to 85 or of any one of clauses 93 to 112, or the kit of any one of clauses 86 to 112, wherein the bonding layer comprises a solid film.
   114. The stator device or the kit of clause 113 wherein the solid film comprises a polymer. 115. The stator device or the kit of clause 114 wherein the polymer comprises polyethylene terephthalate.
   116. The stator device or the kit of clause 114 or 115 wherein the polymer comprises thermoplastic polyurethane.
   117. The stator device or the kit of any one of clauses 113 to 116 wherein the solid film comprises a microsuction tape.
   118. The stator device of any one of clauses 113 to 117 wherein the bonding layer further comprises a first adhesive adhered to the solid film and to the stator.
   119. The stator device of clause 118 wherein the first adhesive comprises a silicone.
   120. The stator device of any one of clauses 113 to 119 wherein the bonding layer further comprises a second adhesive to adhered to the solid film and to the cover.
   121. The stator device of clause 120 wherein the second adhesive comprises an epoxy.
   122. The stator device of clause 120 or 121 wherein the second adhesive comprises a cyanoacrylate.
   123. The kit of any one of clauses 113 to 117 wherein the bonding layer further comprises a first adhesive adherable to the solid film and to the stator.
   124. The kit of clause 123 wherein the first adhesive comprises a silicone.
   125. The kit of any one of clauses 113 to 117 or of clause 123 or 124 wherein the bonding layer further comprises a second adhesive to adherable to the solid film and to the cover.
   126. The kit of clause 125 wherein the second adhesive comprises an epoxy.
   127. The kit of clause 125 or 126 wherein the second adhesive comprises a cyanoacrylate.
   128. The stator device of clause 120, 121, or 122 when directly or indirectly dependent from clause 118, or the kit of clause 125, 126, or 127 when directly or indirectly dependent from clause 123, wherein adhesion between the second adhesive and the cover is stronger than adhesion between the first adhesive and the stator.
   129. The stator device of clause 128 or of clause 120, 121, or 122 when directly or indirectly dependent from clause 118, or the kit of clause 128 or of clause 125, 126, or 127 when directly or indirectly dependent from clause 123, wherein adhesion between the second adhesive and the solid film is stronger than adhesion between the first adhesive and the stator.
   130. The stator device of clause 128 or 129 or of clause 120, 121, or 122 when directly or indirectly dependent from clause 118, or the kit of clause 128 or 129 or of clause 125, 126, or 127 when directly or indirectly dependent from clause 123, wherein adhesion between the first adhesive and the solid film is stronger than adhesion between the first adhesive and the stator.
   131. The stator device of any one of clauses 73 to 85 or 93 to 122, or of clause 128, 129 or 130, or the kit of any one of clauses 86 to 117 or 123 to 130, wherein the cover comprises a non-magnetic material.
   132. The stator device or the kit of clause 131 wherein the non-magnetic material comprises a stainless steel.
   133. The stator device or the kit of clause 132 wherein the non-magnetic material comprises an austenitic stainless steel.
   134. The stator device or the kit of clause 131, 132, or 133 wherein the non-magnetic material comprises aluminum.
   135. The stator device or the kit of any one of clauses 131 to 134 wherein the non-magnetic material comprises an aluminum alloy.
   136. The stator device of any one of clauses 73 to 85, 93 to 122, or 128 to 135, or the kit of any one of clauses 86 to 117 or 123 to 135, wherein the cover is at least 0.2 mm thick.
   137. The stator device of any one of clauses 73 to 85, 93 to 122, or 128 to 136, or the kit of any one of clauses 86 to 117 or 123 to 136, wherein the cover is at most 2 mm thick.
   138. The stator device of any one of clauses 73 to 85, 93 to 122, or 128 to 137, or the kit of any one of clauses 86 to 117 or 123 to 137, wherein the cover is about 0.5 mm thick.
   139. The stator device of any one of clauses 73 to 85, 93 to 122, or 128 to 138, or the kit of any one of clauses 86 to 117 or 123 to 138, wherein the stator defines a channel configured to receive a releasing body such that, when the channel receives the releasing body, the releasing body is positioned to detach the cover from the stator when withdrawn from the channel and drawn through the bonding layer.
   140. The stator device or the kit of clause 139 wherein the releasing body comprises a wire.
   141. A stator module comprising:
a first sub-assembly;
a second sub-assembly arranged to connect to the first during operation; and
a working surface supported relative to the stator body and extending in both a first and a second direction;
the second sub-assembly comprising a motor sub-module with a plurality of actuation coils operable to generate a magnetic field to facilitate moving, relative to the working surface, a magnetized mover in the magnetic field in response to electrical current through the electrical conductor;
a motor support structure to stiffen the motor and facilitate mounting;
a plurality of connectors to connect to the first sub-assembly and provide power to the motor; and
a working surface supported relative to the motor and extending in a first and second direction.
the first sub-assembly comprising a stator body;
a sensor sub-module containing one or more sensors to detect a position of the at least one movers on the stator; and
an amplifier sub-module regulating the current through the actuator coils;
wherein the first and second sub-assemblies are connected together during controlled motion of the mover and the first sub-assembly near the interface location with the second sub-assembly is narrower than the second sub-assembly.
   142. The system of clause X, wherein the system further comprises a stator support structure having members extending in X and Y with at least a portion of the support structure overlapping with the first sub-module or second sub-module along a third direction normal to the working surface.
   143. The system of clause X, wherein the first sub-module is insertable along the third direction through the stator support structure and thereby connecting to the second sub-module.
   144. The system of clause X, wherein at least a portion of the support structure overlaps with both the first and second sub-module along the third direction.
   145. The system of clause X, wherein a first sub-module mounting to the −Z surface of the support structure.
   146. The system of clause X, wherein a first sub-module having at least one overhanging feature overlapping with the stator support structure along the third direction and extending beyond the extent of the stator's motor.
   147. The system of clause X, wherein the arrangement of mounting locations for the adjacent stators is asymmetric.
   148. The system of clause X, wherein a first sub-module mounting to the side surface of the support structure.
   149. The system of clause X, wherein the second sub-module mounting to the +Z surface of the support structure.
   150. The system of clause X, wherein the second sub-module sealing against the +Z surface of the support structure.
   151. The system of clause X, wherein when two stators are installed next to each other their inter-stator position sensor spacing at the adjacent edge is significantly greater than the typical position sensor spacing for each of the stators.
   152. The system of clause X, wherein two stators are installed next to each other their inter-stator position sensor spacing at the adjacent edge is generally equal to the typical position sensor spacing for each of the stators.
   153. The system of clause X, wherein the first sub-module has an internal cooling path.
   154. The system of clause X, wherein the second sub-module has an internal cooling path.
   155. The system of clause X1 or X2, wherein the first and second sub-modules physically contacting each other to transfer heat during operation.
   156. The system of clause X, wherein both the first and second sub-modules have an internal cooling path and they are connected together.
   157. The system of clause X, wherein the system further comprises an isolation barrier separating the stators from the movers.
   158. The system of clause X, wherein the isolation barrier is made of metal.
   159. The system of clause X, wherein the isolation barrier is affixed to the top of a second sub-module.
   160. A stator structure for a displacement system, the stator structure comprising:
at least one conductor positioned to generate at least one external magnetic field operable to move at least one mover in a working environment of the displacement system; and
a support structure supporting the at least one conductor and defining a stator environment separated from the working environment, the stator environment for receiving at least one stator electronics sub-assembly operable to drive at least one electrical current in the at least one conductor to cause the at least one conductor to generate the at least one external magnetic field, the support structure configured to maintain separation between the stator environment and the working environment when one or more of the at least one stator electronics sub-assembly is inserted into or removed from the stator environment.
   161. The stator structure of clause 160 wherein the support structure separates the stator environment from the working environment.
   162. The stator structure of clause 160 or 161 wherein the support structure seals the stator environment from the working environment.
   163. The stator structure of clause 160, 161, or 162 further comprising a working surface positioned to be between the at least one conductor and the working environment when the at least one mover is moving in the working environment in response to the at least one external magnetic field.
   164. The stator structure of clause 163 further comprising an isolation barrier positioned to be between the at least one conductor and the working environment when the at least one mover is moving in the working environment in response to the at least one external magnetic field, the isolation barrier comprising the working surface.
   165. The stator structure of clause 164 further comprising a motor sub-module comprising the at least one conductor, wherein the isolation barrier is affixed to the motor sub-module.
   166. The stator structure of clause 164 or 165 wherein the isolation barrier comprises a metal.
   167. The stator structure of any one of clauses 163 to 166 wherein the working environment is adjacent to the working surface when the at least one mover is moving in the working environment in response to the at least one external magnetic field.
   168. The stator structure of any one of clauses 163 to 167 wherein the working environment is across at least the working surface from the stator environment when the at least one mover is moving in the working environment in response to the at least one external magnetic field.
   169. The stator structure of any one of clauses 160 to 168 wherein the working environment is across at least the at least one conductor from the stator environment when the at least one mover is moving in the working environment in response to the at least one external magnetic field.
   170. The stator structure of any one of clauses 160 to 169 further comprising at least one electrical connector electrically connected to the at least one conductor and electrically connectable to the at least one stator electronics sub-assembly when the at least one stator electronics sub-assembly is in the stator environment.
   171. The stator structure of any one of clauses 160 to 170 wherein the support structure comprises:
a motor support structure supporting the at least one conductor; and
a stator support structure supporting the motor support structure.
   172. The stator structure of clause 171 wherein the motor support structure is between the at least one conductor and the stator environment.
   173. The stator structure of clause 172 wherein the motor support structure defines at least one motor support structure cutout extending through the motor support structure along a thickness direction of the at least one motor support structure between the at least one conductor and the stator environment.
   174. The stator structure of clause 173 when directly or indirectly dependent from clause 170 wherein the at least one electrical connector extends through one or more of the at least one motor support structure cutout.
   175. The stator structure of any one of clauses 171 to 174 when directly or indirectly dependent from clause 165 wherein the motor support structure supports the motor sub-module.
   176. The stator structure of any one of clauses 171 to 175 wherein the motor support structure comprises a generally non-conductive material.
   177. The stator structure of any one of clauses 171 to 176 wherein the motor support structure comprises a laminated structure comprising conductive material and non-conductive material.
   178. The stator structure of any one of clauses 171 to 177 wherein the motor support structure is attached to the stator support structure.
   179. The stator structure of clause 178 wherein attachment between the motor support structure and the stator support structure seals the stator environment from the working environment.
   180. The stator structure of clause 178 or 179 further comprising a sealant sealing the motor support structure to the stator support structure.
   181. The stator structure of clause 178 or 179 further comprising at least one gasket between the motor support structure and the stator support structure, the at least one gasket sealing an interface between the motor support structure and the stator support structure.
   182. The stator structure of any one of clauses 171 to 181 wherein the stator support structure defines at least one opening between the stator environment and an outside environment, the at least one opening for receiving the at least one stator electronics sub-assembly into the stator environment, the support structure configured to maintain separation between the stator environment and the working environment when the one or more of the at least one electronics sub-assembly is inserted into or removed from the stator environment through the at least one opening.
   183. The stator structure of clause 182 wherein the stator support structure comprises at least one stator support structure member extending between the motor support structure and the at least one opening of the stator support structure.
   184. The stator structure of clause 183 when directly or indirectly dependent from clause 163 wherein the at least one stator support structure member extends between the motor support structure and the at least one opening of the stator support structure in an installation direction generally perpendicular to the working surface.
   185. The stator structure of clause 183 or 184 wherein the stator support structure further comprises at least one stiffener detachably mountable to one or more of the at least one stator support structure member across one or more of the at least one opening of the stator support structure.
   186. The stator structure of clause 183, 184, or 185 wherein the stator support structure further comprises at least one sealing plate operable to releasably seal one or more of the at least one opening of the stator support structure.
   187. The stator structure of clause 186 when directly or indirectly dependent from clause 185 wherein the at least one sealing plate comprises the at least one stiffener.
   188. The stator structure of any one of clauses 171 to 187 wherein the motor support structure defines a motor support structure cooling channel for conveying heat through the motor support structure.
   189. The stator structure of clause 188 wherein the stator support structure defines a stator support structure cooling channel for conveying heat through the stator support structure, the stator support structure cooling channel in communication with the motor support structure cooling channel to transfer heat between the stator support structure and the motor support structure.
   190. A stator for a displacement system, the stator comprising:
the stator structure of any one of clauses 160 to 189; and
at least one stator electronics sub-assembly inserted into the stator environment and operable to drive the at least one electrical current in the at least one conductor to cause the at least one conductor to generate the at least one external magnetic field.
   191. The stator of clause 190 wherein the at least one stator electronics sub-assembly is electrically connected to the at least one conductor.
   192. The stator of clause 191 when directly or indirectly dependent from clause 170 wherein the at least one stator electronics sub-assembly is electrically connected to the at least one electrical connector.
   193. The stator of any one of clauses 190, 191, or 192 wherein the at least one stator electronics sub-assembly comprises an amplifier operable to drive the at least one electrical current in the at least one conductor to cause the at least one conductor to generate the at least one external magnetic field.
   194. The stator of any one of clauses 190 to 193 when directly or indirectly dependent from clause 171 wherein the at least one stator electronics sub-assembly is in contact with the motor support structure.
   195. The stator of clause 194 wherein the at least one stator electronics sub-assembly supports the motor support structure.
   196. The stator of clause 194 or 195 wherein the at least one stator electronics sub-assembly is attached to the motor support structure.
   197. The stator of any one of clauses 190 to 196 when directly or indirectly dependent from clause 173 wherein the at least one stator electronics sub-assembly extends into one or more of the at least one motor support structure cutout.
   198. The stator of any one of clauses 190 to 197 wherein the at least one stator electronics sub-assembly defines at least one stator electronics cooling channel for conveying heat through the at least one stator electronics sub-assembly.
   199. The stator of clause 198 when directly or indirectly dependent from clause 188 wherein one or more of the at least one stator electronics cooling channel is in communication with the motor support structure cooling channel to transfer heat between the at least one stator electronics sub-assembly and the motor support structure.
   200. The stator of clause 199 wherein the one or more of the at least one stator electronics cooling channel is releasably connected to the motor support structure cooling channel.
   201. The stator of any one of clauses 190 to 200 when directly or indirectly dependent from clause 171 wherein the at least one stator electronics sub-assembly is attached to the stator support structure.
   202. The stator of clause 201 when directly or indirectly dependent from clause 182 wherein the at least one stator electronics sub-assembly is attached to the stator support structure at the at least one opening of the stator support structure.
   203. The stator of clause 201 or 202 when directly or indirectly dependent from clause 183 wherein the at least one stator electronics sub-assembly is attached to one or more of the at least one stator support structure member.
   204. The stator of clause 201, 202, or 203 when directly or indirectly dependent from clause 185 wherein the at least one stator electronics sub-assembly is attached to one or more of the at least one stiffener.
   205. The stator of any one of clauses 190 to 204 when directly or indirectly dependent from clause 184 wherein:
at least one of the at least one stator electronics sub-assembly comprises a sub-assembly body inserted into the stator environment and removable from the stator environment through a corresponding one of the at least one opening of the stator support structure;
the sub-assembly body has a body width in a width direction generally perpendicular to the installation direction, the body width generally constant along the installation direction; and
the corresponding one of the at least one opening of the stator support structure has an opening width in the width direction, the opening width greater than or equal to the body width.
   206. The stator of clause 205 wherein the at least one of the at least one stator electronics sub-assembly further comprises at least one overhanging feature protruding from the sub-assembly body in the width direction.
   207. The stator of clause 206 wherein:
the at least one overhanging feature protrudes a protrusion distance from the sub-assembly body; and
a sum of the protrusion distance and half of the body width is greater than half of the opening width.
   208. The stator of clause 206 or 207 wherein the at least one overhanging feature is attached to the stator support structure at the corresponding one of the at least one opening of the stator support structure.
   209. The stator of clause 206, 207, or 208 wherein:
the at least one overhanging feature comprises a plurality of overhanging features;
the at least one of the at least one stator electronics sub-assembly comprises a first plurality of the plurality of overhanging features; and
the first plurality of overhanging features is arranged asymmetrically around the at least one of the at least one stator electronics sub-assembly.
   210. The stator of any one of clauses 190 to 209 wherein the at least one stator electronics sub-assembly comprises at least one sensor positioned to measure a position of the at least one mover when the at least one mover is moving in the working environment in response to the at least one external magnetic field.
   211. The stator of clause 210 wherein:
the at least one stator electronics sub-assembly comprises a first stator electronics sub-assembly and a second stator electronics sub-assembly adjacent to the first stator electronics sub-assembly;
the at least one sensor comprises a first plurality of sensors and a second plurality of sensors;
the first stator electronics sub-assembly comprises the first plurality of sensors; and
the second stator electronics sub-assembly comprises the second plurality of sensors.
   212. The stator of clause 211 wherein sensors of the first plurality of sensors are generally arranged in a grid layout.
   213. The stator of clause 211 or 212 wherein sensors of the second plurality of sensors are generally arranged in a grid layout.
   214. The stator of clause 211, 212, or 213 wherein:
adjacent ones of the first plurality of sensors are spaced apart by a sub-assembly sensor spacing; and
adjacent ones of the second plurality of sensors are spaced apart by the sub-assembly sensor spacing.
   215. The stator of clause 214 wherein:
the first plurality of sensors comprises first edge sensors adjacent to the second stator electronics sub-assembly;
the second plurality of sensors comprises second edge sensors adjacent to the first stator electronics sub-assembly;
at least one of the first edge sensors is adjacent to a corresponding one of the second edge sensors; and
the at least one of the first edge sensors is spaced apart from the corresponding one of the second edge sensors by an inter-stator sensor spacing.
   216. The stator of clause 215 wherein the inter-stator sensor spacing is generally equal to the sub-assembly sensor spacing.
   217. The stator of clause 215 wherein the inter-stator sensor spacing is greater than the sub-assembly sensor spacing.
   218. The stator of clause 215, 216, or 217 wherein the inter-stator sensor spacing is an integer multiple of the sub-assembly sensor spacing.
   219. The stator of any one of clauses 190 to 218 wherein the at least one stator electronics sub-assembly comprises a plurality of stator electronics sub-assemblies.
   220. The stator of clause 219 when directly or indirectly dependent from clause 182 wherein the at least one opening comprises a plurality of openings, each of the plurality of stator electronics sub-assemblies removable from the stator environment through a corresponding one of the plurality of openings.
   221. The stator of clause 220 when directly or indirectly dependent from clause 206 wherein:
the plurality of stator electronics sub-assemblies comprises a third stator electronics sub-assembly and a fourth stator electronics sub-assembly adjacent to the third stator electronics sub-assembly;
the third stator electronics sub-assembly comprises at least one third overhanging feature of the at least one overhanging feature; and
the fourth stator electronics sub-assembly comprises at least one fourth overhanging feature of the at least one overhanging feature.
   222. The stator of clause 221 wherein:
the at least one third overhanging feature of the at least one overhanging feature comprises a third plurality of overhanging features, the third plurality of overhanging features protruding in respective third protrusion directions; and
the at least one fourth overhanging feature of the at least one overhanging feature comprises a fourth plurality of overhanging features, the fourth plurality of overhanging features protruding in respective fourth protrusion directions.
   223. The stator of clause 222 wherein the third protrusion directions are the same as the fourth protrusion directions.
   224. The stator of clause 222 wherein the third protrusion directions are different from the fourth protrusion directions.
   225. A method of installing a stator electronics sub-assembly in the stator structure of any one of clauses 160 to 189, the stator electronics sub-assembly operable to drive the at least one electrical current in the at least one conductor to cause the at least one conductor to generate the at least one external magnetic field, the method comprising:
inserting the stator electronics sub-assembly into the stator environment.
   226. The method of clause 225 further comprising electrically connecting the stator electronics sub-assembly to the at least one conductor.
   227. The method of clause 225 or 226 when directly or indirectly dependent from clause 182 wherein inserting the stator electronics sub-assembly into the stator environment comprises inserting the stator electronics sub-assembly into the stator environment through the at least one opening.
   228. The method of clause 227 when directly or indirectly dependent from clause 184 wherein inserting the stator electronics sub-assembly into the stator environment comprises inserting the stator electronics sub-assembly into the stator environment along the installation direction.
   229. A method of uninstalling one or more of the at least one stator electronics sub-assembly from the stator of any one of clauses 190 to 224, the method comprising:
removing the one or more of the at least one stator electronics sub-assembly from the stator environment.
   230. The method of clause 229 when directly or indirectly dependent from clause 182 wherein removing the stator electronics sub-assembly from the stator environment comprises removing the stator electronics sub-assembly from the stator environment through a corresponding one of the at least one opening.
   231. The method of clause 230 when directly or indirectly dependent from clause 184 wherein removing the stator electronics sub-assembly from the stator environment comprises removing the stator electronics sub-assembly from the stator environment along the installation direction.
   232. A stator mounting apparatus for a magnetic displacement system, the stator mounting apparatus comprising:
a main support defining a primary opening dimensioned to receive one or more stators therethrough, the main support comprising a support portion adjacent the primary opening, the support portion for supporting at least one of the one or more stators received through the primary opening, wherein:
   the at least one of the one or more stators is received through the primary opening from an external side of the main support and can be moved, in a mounting direction, to a mounting position on the support portion in which the at least one of the one or more stators is supported by the support portion, the external side of the main support facing away from a working surface of the displacement system upon which one or more movers of the displacement system are controllable, the mounting direction being parallel to the working surface; and
   from the mounting position, the at least one of the one or more stators can be moved, in a dismounting direction opposite to the mounting direction, to the primary opening for removal through the primary opening to the external side of the main support.
      233. The stator mounting apparatus of clause 232 wherein the main support is under the working surface.
      234. The stator mounting apparatus of clause 232 or 233 wherein the primary opening is dimensioned to receive therethrough the one or more stators in a mounting orientation.
      235. The stator mounting apparatus of clause 234 wherein the primary opening has a shape corresponding to a shape of each of the one or more stators in the mounting orientation.
      236. The stator mounting apparatus of any one of clauses 232 to 235 wherein:
the primary opening has a primary width perpendicular to the mounting direction; and
the main support further defines a secondary opening having a secondary width perpendicular to the mounting direction, the secondary width less than the primary width.
   237. The stator mounting apparatus of clause 236 wherein the secondary opening is continuous with the primary opening.
   238. The stator mounting apparatus of clause 236 or 237 when directly or indirectly dependent from clause 234 wherein the secondary opening is dimensioned to prevent the one or more stators from passing therethrough in the mounting orientation.
   239. The stator mounting apparatus of clause 236, 237, or 238 wherein the secondary opening is dimensioned to prevent the one or more stators from passing therethrough.
   240. The stator mounting apparatus of any one of clauses 236 to 239 wherein the secondary width is less than 75% of the primary width.
   241. The stator mounting apparatus of any one of clauses 232 to 240 wherein the main support comprises a mounting plate.
   242. The stator mounting apparatus of any one of clauses 232 to 241 further comprising guiding means for guiding the at least one of the one or more stators along the mounting direction and the dismounting direction between the mounting position and the primary opening.
   243. The stator mounting apparatus of clause 242 wherein the guiding means comprises at least one structural member extending from the main support.
   244. The stator mounting apparatus of any one of clauses 232 to 243 further comprising a stator support releasably attachable to the main support to support a stator in the primary opening.
   245. The stator mounting apparatus of clause 244 wherein the stator support comprises a sub-mounting plate.
   246. The stator mounting apparatus of clause 244 or 245 wherein the stator support has a stator support opening dimensioned to prevent the one or more stators from passing therethrough when the stator support is attached to the main support.
   247. The stator mounting apparatus of clause 246 wherein the stator support opening is dimensioned to receive therethrough one or more utility service conduits associated with the one or more stators.
   248. The stator mounting apparatus of clause 247 wherein at least one of the one or more utility service conduits is configured to carry communications between the one or more stators and a remote device.
   249. The stator mounting apparatus of clause 247 or 248 wherein at least one of the one or more utility service conduits is configured to carry electrical power to the one or more stators.
   250. The stator mounting apparatus of any one of clauses 244 to 249 wherein the stator support comprises alignment means for aligning the stator support with the main support when the stator support is attached to the main support.
   251. The stator mounting apparatus of clause 250 wherein:
at least a portion of the stator support has a shape corresponding to a shape of at least a portion of the primary opening; and
the alignment means comprises a marginal shoulder extending along a perimeter of the at least a portion of the stator support and sized to engage with at least one edge of the primary opening.
   252. The stator mounting apparatus of any one of clauses 244 to 251 further comprising stator alignment means for aligning the at least one of the one or more stators with the stator support at least when the stator support is attached to the main support.
   253. The stator mounting apparatus of clause 252 wherein the stator alignment means comprises at least one structural member extending from the main support.
   254. The stator mounting apparatus of any one of clauses 244 to 253 further comprising a seal between the main support and the stator support to provide at least one of an airtight seal and a liquid-tight seal between the main support and the stator support when the stator support is attached to the main support.
   255. The stator mounting apparatus of any one of clauses 232 to 254 further comprising a cover spaced apart from the main support, such that the cover and the main support define therebetween a stator chamber dimensioned to accommodate the one or more stators.
   256. The stator mounting apparatus of clause 255 wherein the cover supports the working surface.
   257. The stator mounting apparatus of clause 255 or 256 wherein the cover and the main support are sealed together to provide at least one of an airtight seal and a liquid-tight seal between the cover and the main support.
   258. A stator mounting system comprising one or more stator mounting apparatuses, each as recited in any one of clauses 232 to 254.
   259. A stator mounting system comprising one or more stator mounting apparatuses, each as recited in clause 255, 256, or 257.
   260. The stator mounting system of clause 259 wherein the cover of each of the one or more stator mounting apparatuses is provided by a unitary cover having one or more cover portions each providing a respective said cover for a respective one of the one or more stator mounting apparatuses.
   261. The stator mounting system of clause 258, 259, or 260 wherein the main support of each of the one or more stator mounting apparatuses is provided by a unitary main support having one or more main support portions each providing a respective said main support for a respective one of the one or more stator mounting apparatuses.
   262. The stator mounting system of any one of clauses 258 to 261 wherein the one or more stator mounting apparatuses comprises a plurality of stator mounting apparatuses positioned in adjacent succession.
   263. The stator mounting system of clause 262 wherein each stator mounting apparatus of said plurality of stator mounting apparatuses has an orientation opposite to an orientation of its adjacent stator mounting apparatus of said plurality of stator mounting apparatuses.
   264. The stator mounting system of clause 262 or 263 wherein primary openings of adjacent ones of said plurality of stator mounting apparatuses are non-adjacent.
   265. A stator kit for a magnetic displacement system, the stator kit comprising:
the stator mounting system of any one of clauses 258 to 265; and
one or more of said stators operable to generate magnetic fields operable to move the one or more movers of the displacement system.
   266. The stator kit of clause 265 wherein each of the one or more stators comprises one or more electrical conductors operable to generate the magnetic fields.
   267. The stator kit of clause 266 wherein each of the one or more stators further comprises a driving circuit operable to drive at least one electrical current in the one or more electrical conductors to cause the one or more electrical conductors to generate the magnetic fields.
   268. A method of installing a stator on a stator mounting apparatus of a magnetic displacement system, the method comprising:
inserting the stator through a primary opening in a main support of the stator mounting apparatus, the primary opening being accessed from an external side of the main support facing away from a working surface of the displacement system upon which one or more movers of the displacement system are controllable;
moving the stator, in a mounting direction, from the primary opening to a mounting position on a support portion of the main support, the mounting direction being parallel to the working surface; and
supporting the stator by the support portion.
   269. The method of clause 268 wherein the main support is under the working surface.
   270. The method of clause 268 or 269 further comprising orienting the stator in a mounting orientation prior to insertion through the primary opening.
   271. The method of clause 268, 269, or 270 wherein inserting the stator through the primary opening comprises inserting the stator through the primary opening in an insertion direction perpendicular to the working surface.
   272. The method of any one of clauses 268 to 271 wherein moving the stator in the mounting direction from the primary opening to the mounting position comprises accessing the stator through the primary opening.
   273. The method of any one of clauses 268 to 272 wherein:
moving the stator in the mounting direction from the primary opening to the mounting position comprises accessing the stator through a secondary opening in the main support;
the primary opening has a primary width perpendicular to the mounting direction; and
the secondary opening has a secondary width perpendicular to the mounting direction, the secondary width less than the primary width.
   274. The method of any one of clauses 268 to 273 further comprising attaching a stator support to the main support to support the stator in the primary opening.
   275. The method of clause 274 further comprising:
inserting one or more utility service conduits associated with the stator through a stator support opening in the stator support, the stator support opening being accessed from the external side of the main support; and
connecting the one or more utility service conduits to the stator.
   276. The method of clause 275 wherein at least one of the one or more utility service conduits is configured to carry communications between the stator and a remote device.
   277. The method of clause 275 or 276 wherein at least one of the one or more utility service conduits is configured to carry electrical power to the stator.
   278. The method of any one of clauses 274 to 277 further comprising sealing the main support to the stator support to provide at least one of an airtight seal and a liquid-tight seal between the main support and the stator support.
   279. A method of removing a stator from a stator mounting apparatus of a magnetic displacement system, the method comprising:
accessing the stator from an external side of a main support of the stator mounting apparatus to move the stator in a dismounting direction from a mounting position on the main support to a primary opening in the main support, the external side of the main support facing away from a working surface of the displacement system upon which one or more movers of the displacement system are controllable, the dismounting direction being parallel to the working surface; and
passing the stator through the primary opening to the external side of the main support.
   280. The method of clause 279 wherein the main support is under the working surface.
   281. The method of clause 279 or 280 further comprising maintaining the stator in a mounting orientation when passing the stator through the primary opening to the external side of the main support.
   282. The method of clause 279, 280, or 281 wherein passing the stator through the primary opening to the external side of the main support comprises passing the stator through the primary opening in a removal direction perpendicular to the working surface.
   283. The method of any one of clauses 279 to 282 wherein accessing the stator from the external side of the main support comprises accessing the stator through the primary opening.
   284. The method of any one of clauses 279 to 283 wherein:
accessing the stator from the external side of the main support comprises accessing the stator through a secondary opening in the main support;
the primary opening has a primary width perpendicular to the dismounting direction; and
the secondary opening has a secondary width perpendicular to the dismounting direction, the secondary width less than the primary width.
   285. The method of any one of clauses 279 to 284 further comprising detaching a stator support from the main support to allow the stator to pass through the primary opening.
   286. The method of clause 285 further comprising breaking at least one of an airtight seal and a liquid-tight seal between the main support and the stator support.

Although specific embodiments have been described and illustrated, such embodiments should be considered illustrative only and not as limiting the invention as construed according to the accompanying claims.

1. A stator mounting apparatus for a magnetic displacement system, the stator mounting apparatus comprising:
a main support defining a primary opening dimensioned to receive one or more stators therethrough, the main support comprising a support portion adjacent the primary opening, the support portion for supporting at least one of the one or more stators received through the primary opening, wherein:
the at least one of the one or more stators is received through the primary opening from an external side of the main support and can be moved, in a mounting direction, to a mounting position on the support portion in which the at least one of the one or more stators is supported by the support portion, the external side of the main support facing away from a working surface of the displacement system upon which one or more movers of the displacement system are controllable, the mounting direction being parallel to the working surface; and
from the mounting position, the at least one of the one or more stators can be moved, in a dismounting direction opposite to the mounting direction, to the primary opening for removal through the primary opening to the external side of the main support.

2. The stator mounting apparatus of claim 1 wherein the main support is under the working surface.

3. The stator mounting apparatus of claim 1 wherein the primary opening is dimensioned to receive therethrough the one or more stators in a mounting orientation.

4. The stator mounting apparatus of claim 3 wherein the primary opening has a shape corresponding to a shape of each of the one or more stators in the mounting orientation.

5. The stator mounting apparatus of claim 1 wherein:
the primary opening has a primary width perpendicular to the mounting direction; and
the main support further defines a secondary opening having a secondary width perpendicular to the mounting direction, the secondary width less than the primary width.

6. The stator mounting apparatus of claim 5 wherein the secondary opening is continuous with the primary opening.

7. The stator mounting apparatus of claim 5 wherein:
the primary opening is dimensioned to receive therethrough the one or more stators in a mounting orientation; and
the secondary opening is dimensioned to prevent the one or more stators from passing therethrough in the mounting orientation.

8. The stator mounting apparatus of claim 1 wherein the main support comprises a mounting plate.

9. The stator mounting apparatus of claim 1 further comprising a stator support releasably attachable to the main support to support a stator in the primary opening.

10. The stator mounting apparatus of claim 9 wherein the stator support comprises a sub-mounting plate.

11. The stator mounting apparatus of claim 9 wherein the stator support has a stator support opening dimensioned to prevent the one or more stators from passing therethrough when the stator support is attached to the main support.

12. The stator mounting apparatus of claim 11 wherein the stator support opening is dimensioned to receive therethrough one or more utility service conduits associated with the one or more stators.

13. The stator mounting apparatus of claim 9 wherein:
the stator support comprises alignment means for aligning the stator support with the main support when the stator support is attached to the main support;
at least a portion of the stator support has a shape corresponding to a shape of at least a portion of the primary opening; and
the alignment means comprises a marginal shoulder extending along a perimeter of the at least a portion of the stator support and sized to engage with at least one edge of the primary opening.

14. The stator mounting apparatus of claim 9 further comprising a seal between the main support and the stator support to provide at least one of an airtight seal and a liquid-tight seal between the main support and the stator support when the stator support is attached to the main support.

15. The stator mounting apparatus of claim 1 further comprising a cover spaced apart from the main support, such that the cover and the main support define therebetween a stator chamber dimensioned to accommodate the one or more stators.

16. The stator mounting apparatus of claim 15 wherein the cover and the main support are sealed together to provide at least one of an airtight seal and a liquid-tight seal between the cover and the main support.

17. A stator mounting system comprising one or more stator mounting apparatuses, each as recited in claim 15.

18. The stator mounting system of claim 17 wherein the cover of each of the one or more stator mounting apparatuses is provided by a unitary cover having one or more cover portions each providing a respective said cover for a respective one of the one or more stator mounting apparatuses.

19. The stator mounting system of claim 17 wherein the one or more stator mounting apparatuses comprises a plurality of stator mounting apparatuses positioned in adjacent succession.

20. The stator mounting system of claim 19 wherein each stator mounting apparatus of said plurality of stator mounting apparatuses has an orientation opposite to an orientation of its adjacent stator mounting apparatus of said plurality of stator mounting apparatuses.

21. The stator mounting system of claim 19 wherein primary openings of adjacent ones of said plurality of stator mounting apparatuses are non-adjacent.

22. A method of installing a stator on a stator mounting apparatus of a magnetic displacement system, the method comprising:
inserting the stator through a primary opening in a main support of the stator mounting apparatus, the primary opening being accessed from an external side of the main support facing away from a working surface of the displacement system upon which one or more movers of the displacement system are controllable;
moving the stator, in a mounting direction, from the primary opening to a mounting position on a support portion of the main support, the mounting direction being parallel to the working surface; and
supporting the stator by the support portion.

23. A method of removing a stator from a stator mounting apparatus of a magnetic displacement system, the method comprising:
accessing the stator from an external side of a main support of the stator mounting apparatus to move the stator in a dismounting direction from a mounting position on the main support to a primary opening in the main support, the external side of the main support facing away from a working surface of the displacement system upon which one or more movers of the displacement system are controllable, the dismounting direction being parallel to the working surface; and
passing the stator through the primary opening to the external side of the main support.
